(19) United States
(12) Patent Application Publication
(10) Pub. No.: US 2025/0111804 A1
(43) Pub. Date: Apr. 3, 2025

(54) LUGGAGE SMART DEVICES, SYSTEMS AND METHODS THEREOF

(71) Applicant: Package, Inc., San Francisco, CA (US)

(72) Inventors: Bryan Jonathan Davis, San Francisco, CA (US); Ronald Eugene Fisher, San Francisco, CA (US); James Mark Fisher, Walnut Creek, CA (US); Daniel Richard Johnson, Cumming, GA (US)

(73) Assignee: Package, Inc., San Francisco, CA (US)

(21) Appl. No.: 18/905,094

(22) Filed: Oct. 2, 2024

Related U.S. Application Data
(60) Provisional application No. 63/542,278, filed on Oct. 3, 2023.

(51) Int. Cl. G09F 3/16; G09F 3/02

(52) U.S. Cl. CPC G09F 3/16; G09F 3/02; G09F 2003/0254

(57) ABSTRACT

Luggage smart devices, systems and methods thereof are provided. One or a plurality of independent and/or interconnected and/or wirelessly paired or networked smart wireless tracking, monitoring, luggage logistics and security devices can be securely attached to one or more bags or other luggage items. The devices may enable continuous location tracking, real-time sensor monitoring, still image and audio-video capture, streaming and peer-to-peer communications, mobile alerts alarm and real-time on-luggage travel itinerary display and alert system.

### CROSS-REFERENCE TO RELATED APPLICATIONS

This application claims priority from U.S. Provisional Application No. 63/542,278, filed Oct. 3 2023, at the United States Patent & Trade Mark Office, the contents of which is incorporated by reference in its entirety.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### STATEMENT REGARDING FEDERAL SPONSORED RESEARCH OR DEVELOPMENT

Not Applicable.

### FIELD OF TECHNOLOGY

This disclosure relates generally to the technical fields of travel item security/logistics devices, and in particular, but not limited to smart travel item security/logistics devices. Additional or alternative embodiments relate to methods associated with such security devices. Additional or alternative embodiments relate to methods associated with travel item logistics devices. Additional or alternative embodiments relate to methods associated with such travel item logistic devices.

### BACKGROUND

### Summary

According to some aspects of the present technology, there is a provided a travel item smart device. The travel item smart device may comprise a plurality of devices incorporated in a housing. The plurality of devices may comprise at least one wireless connectivity device, at least one travel item security device and at least one power source.

In some aspects, the travel smart device may comprise a luggage smart device. In some aspects, the travel smart device may comprise a travel smart clip. The travel smart clip may comprise a luggage smart clip. The travel smart clip may comprise a housing and a plurality of devices incorporated into the housing. The housing may comprise a first clip section having a first distal end and a second clip section having a second distal end. The plurality of devices may comprise at least one wireless connectivity device, at least one travel item security device and at least one power source. The plurality of devices may be incorporated in at least one of said first clip section and said second clip section.

In some aspects, the travel item tag may be a travel item smart tag. The smart tag may be a smart device accessory device. The travel item smart tag may be integrated with or operably connected to the travel item smart device such as the smart clip.

In some embodiments, the smart tag is a smart clip accessory device. The smart tag may comprises luggage smart tag. In some embodiments, the luggage smart tag may comprise a display. In some embodiments, the smart tag may comprise a case comprising a frame section and an attachment system. The attachment system is configured to physically connect the luggage tag to a luggage smart clip. The display may be mounted or removably mounted in the frame section. The attachment system may include a locking section extending from the frame section for locating and locking between a distal end of the first clip section and a distal end of the second clip section of the luggage smart clip.

According some aspects of the present technology, there is provided at least one travel item smart device and at least one travel item smart device accessory device. The travel item smart device(s) and the travel item smart device accessory device(s) may be intereconnected, in any one or combination of, wirelessly, electrically and physically. The travel item smart device may be the smart clip or other smart device described herein such as the luggage smart clip. The smart device accessory device(s) may be any combination one or combination of the smart tag, smart zipper lock or other accessory device(s) described herein such as the luggage smart tag. The travel item smart devices(s) and travel item smart accessory device(S) may be integrated with one another or configured to physically, wirelessely, and/or electrically pair with one another.

A non-transitory, computer-readable medium comprising program instructions for at least one travel item smart device and/or at least one travel item smart device accessory device, the program instructions, when executed by one or more processors of a computer system, cause the one or more processors to perform any one more of the methods of the embodiments disclosed herein. The travel item smart device may be the smart clip or other smart device described herein such as the luggage smart clip. The smart device accessory device(s) may be any combination one or combination of the smart tag, smart zipper lock or other accessory device(s) described herein.

A system comprising: at least one computing device configured to provide one or more applications for at least one travel item smart device and/or at least one travel item smart device accessory device, the one or more applications comprising program instructions that, when executed by one or more processors, cause the one or more processors to perform any one more of the methods of the embodiments disclosed herein. The travel item smart device may be the smart clip or other smart device described herein such as the luggage smart clip. The smart device accessory device(s) may be any combination one or combination of the smart tag, smart zipper lock or other accessory device(s) described herein.

### BRIEF DESCRIPTION OF THE VIEW OF DRAWINGS

Example embodiments are described by way of illustrations and are not limited by the figures of the accompanying drawings, wherein:

FIG. 1A is a front perspective view of a smart clip in an open configuration according to some embodiments;

FIG. 1B is a front perspective view of the smart clip of FIG. 1A in a closed configuration according to some embodiments;

FIG. 1C is a rear perspective view of the smart clip of FIG. 1A in an open configuration according to some embodiments;

FIG. 1D is a rear perspective view of the smart clip of FIG. 1A in a closed configuration according to some embodiments;

FIG. 2A is a rear perspective view of a smart clip according to some embodiments in a partially open configuration;

FIG. 2B is a rear perspective view of the smart clip of FIG. 2B in a partially closed configuration according to some embodiments;

FIG. 3A is a rear perspective view of the smart clip according to some embodiments in a partially open configuration to some embodiments;

FIG. 3B is a rear perspective view of the smart clip of FIG. 3A according to some embodiments in a partially closed configuration;

FIG. 4A is a rear perspective view of the smart clip according to some embodiments in a partially closed configuration;

FIG. 4B is a rear perspective view of the smart clip of FIG. 4A according to some embodiments in a partially closed configuration;

FIG. 4C is a front perspective view of a smart clip of FIG. 4A an open configuration according to some embodiments;

FIG. 4D is a front perspective view of the smart clip of FIG. 4Ain a closed configuration according to some embodiments;

FIG. 4E is a rear perspective view of the smart clip of FIG. 4A in an open configuration according to some embodiments;

FIG. 4F is a rear perspective view of the smart clip of FIG. 4A in a closed configuration according to some embodiments;

FIG. 5A is a front perspective view of a smart clip in an open configuration according to some embodiments;

FIG. 5B is a front perspective view of the smart clip of FIG. 5A in a closed configuration according to some embodiments;

FIG. 5C is a rear perspective view of the smart clip of FIG. 5A in an open configuration according to some embodiments;

FIG. 5D is a rear perspective view of the smart clip of FIG. 5A in a closed configuration according to some embodiments;

FIG. 6A is a rear side perspective view of a smart clip in an open configuration and a locking unit; the locking unit being shown preparatory to mounting on a distal end of a second clips section of the luggage smart clip.

FIG. 6B is a rear side perspective view of the smart clip and locking unit of FIG. 6A, the locking unit beings shown removably mounted on the distal end of the second clip section of the luggage smart clip.

FIG. 6C is a bottom perspective view of the smart clip of FIG. 6A in an open configuration according to some embodiments, the locking unit beings shown removably mounted on the distal end of the second clip section of the luggage smart clip.

FIG. 7A is a perspective view of a smart tag display, the smart tag display including a plurality of devices (intelligent version) according to some embodiments;

FIG. 7B is a perspective view of a smart clip accessory device according to some aspects, the smart clip accessory device comprising a smart tag according to some embodiments, the smart tag comprising the smart tag display of FIG. 7A and a smart tag case a, the smart tag display being shown preparatory to being removably inserted into the smart tag case;

FIG. 7C is a perspective view of the smart tag of FIG. 7B according to some embodiments, the smart tag display being shown removeably inserted into the smart tag case;

FIG. 8A is a perspective view of the smart tag of FIG. 7C and the smart clip of FIG. 1A (basic version), the smart tag being shown preparatory to attaching to the smart clip using a swivel attachment system of the smart tag according to some embodiments;

FIG. 8B is a perspective view of the smart tag of FIG. 7C removeably mounted to the smart clip of FIG. 1A in a partially closed configuration according to some embodiments, a slot of the swivel attachment system being shown removeably mounted on and aligned with a port in the distal end of the second clip section of the smart clip and a tongue of the first clip section being partially received through the slot and inserted into the port.

FIG. 8C is a perspective view of the smart tag and smart clip shown in FIG. 8B, the smart clip being shown in a closed configuration and the slot of the attachment system being shown sandwiched between the distal end of the first clip section and the distal end of the second clip section, the tongue of the smart clip being fully inserted through the slot inserted to the locking position in the port.

FIG. 8D is a perspective view of a smart clip accessory device according to some aspects, the smart clip accessory device comprising a smart tag according to some embodiments and the smart clip of FIG. 5A, the smart tag comprising a smart tag display (basic version) and a smart case, the smart tag being shown preparatory to attaching to the smart clip using a swivel attachment system of the smart tag case according to some embodiments,

FIG. 8E is a perspective view of a smart tag according to some aspects, the smart tag comprising a smart tag display (intelligent version) and a smart tag attachment strap according to some embodiments, the smart tag display including a plurality of devices and being removeably attached to one end of the smart tag attachment strap, the other end of the attachment strap having a slot for removeably mounting between the distal ends of the first and second sections respectively of the smart clip;

FIG. 8F is a perspective view of a smart tag according to some aspects, the smart tag comprising a smart tag display (basic version) and a smart tag attachment strap according to some embodiments, the smart tag display including a plurality of devices and being removeably attached to one end of the smart tag attachment strap, the other end of the attachment strap having a slot for removeably mounting between the distal ends of the first and second sections respectively of the smart clip;

FIG. 9A is a perspective view of a smart clip accessory according to some aspects, the smart clip accessory comprising a Smart Luggage Zipper Lock Device & System; the Smart Luggage Zipper Lock Device & System according to some embodiments comprising a mechanical combination zipper lock and TSA lock and a swivel attachment system having a slot for removeably mounting on the distal end of the second clip section of the smart clip;

FIG. 9B is a perspective view of the Smart Luggage Zipper Lock Device & System and the smart clip of FIG. 5A in an open configuration; the Smart Luggage Zipper Lock Device being shown preparatory to removeably mounting the slot of the swivel attachment system on the distal end of the second clip section of the smart clip;

FIG. 9C is a perspective view of the Smart Luggage Zipper Lock Device & System and the smart clip shown in FIG. 9A; the slot of the swivel attachment system of the Smart Luggage Zipper Lock Device being shown removeably mounted on the distal end of the second clip section of the smart clip;

FIG. 9D is a perspective view of the smart tag and smart clip shown in FIG. 9B, the smart clip being shown in a closed configuration and the slot of the swivel attachment system being shown sandwiched between the distal end of the first clip section and the distal end of the second clip section, the tongue of the smart clip being fully inserted through the slot to the locking position in the port;

FIG. 10A is a plan view of the smart tag of any of FIG. 7 or FIG. 8 displaying information about a non-limiting example travel itinerary according to some embodiments; the travel itinerary is associated with a user account which is associated with a smart clip and the travel itinerary may be received by the smart tag wirelessly or electrically via the smart clip to which the smart tag is physically attached and paired;

FIG. 10B is a plan view of the smart tag of any of FIG. 7 or FIG. 8 displaying a non-limiting example ID authentication password/passcode user interface device according to some embodiments; the ID authentication password/passcode device interfaces with a processing device wirelessly, or electrically via the smart clip to which the smart tag is physically attached and paired; the processing device is configured to verify the user ID password/passcode and in response trigger alerts/devices such as the smart clip lock and/or allow user access to the smart clip/tag.

FIG. 10C is a plan view of the smart tag of any of FIG. 7 or FIG. 8 displaying a non-limiting example location tracking of a plurality of smart clips/tags that have been paired together and/or associated to the same user account according to some embodiments; the smart clip/tags are represented by identifiers such as numbers or the profile picture of the users associated with the respective smart clips/tags;

FIGS. 10D and 10E are plan views of the smart tag of any of FIG. 7 or FIG. 8 according to some embodiments displaying non-limiting examples of alerts triggered in response to device(s) of the smart clip/tag sensing the bag has been opened, or the smart clip or smart clip accessory device such as the smart zipper lock has been activated, and determining the bag opening is authorized or unauthorized, respectively;

FIG. 10F is a plan view of the smart tag of any of FIG. 7 or FIG. 8 according to some embodiments displaying non-limiting examples of an alert triggered in response to a travel itinerary update being received; the alert including instructions based on the travel itinerary update;

FIG. 11A exploded view is a perspective view of any of the smart clip of the FIGS. clipped and locked around a handle of a piece of luggage according to some embodiments, the smart clip is in a closed configuration and the handle extends laterally through the hole formed by the substantially C shaped first clip section and second clip section;

FIG. 11A is a perspective view of any of the smart clip of the FIGS. clipped and locked around a handle of a piece of luggage as shown in FIG. 11 exploded view and a smart zipper lock attached to and locking the zippers of the luggage according to some embodiments; the smart zipper lock and smart clip may be paired wirelessly;

FIG. 11B is an exploded view is a perspective view of any of the smart clip of the FIGS. clipped and locked around a handle of a piece of luggage according to some embodiments and the smart tag attached and locked together with the smart clip;

FIG. 11B is a perspective view of any of the smart clip and smart tag of the FIGS. clipped and locked around a handle of a piece of luggage as shown in FIG. 11B exploded view and a smart zipper lock attached to and locking the zippers of the luggage according to some embodiments; the smart zipper lock and smart clip/tag may be paired wirelessly;

FIG. 11C is an exploded perspective view of any of the smart clip the FIGS. clipped and locked around a handle of a piece of luggage and a smart zipper lock attached to and locked to the smart clip and the zippers of the luggage according to some embodiments; the smart zipper lock and smart clip may be paired wirelessly and/or physically;

FIG. 11C is a perspective view of any of the smart clip of the FIGS. clipped and locked around a handle of a piece of luggage as shown in FIG. 11C exploded view and a smart zipper lock attached to and locked to the smart clip and the zippers of the luggage according to some embodiments; and another smart zipper lock attached to the luggage for locking the zippers of the luggage according to some embodiments; one or both of the smart zipper locks and smart clip may be paired wirelessly;

FIG. 11D is a perspective view of any of the smart clip and smart tag of the FIGS. clipped and locked around a handle of a piece of luggage as shown in FIG. 11D and a perspective view of the smart clip and smart zipper lock attached and locked to the smart attached and locked to a handle of the same piece of luggage as shown in FIG. 11D. according to some embodiments; the smart zipper lock/clip and smart clip/tag may be wirelessly networked and paired and/or grouped

FIG. 12A is a perspective view of a kiosk including a user interface for setting up user accounts and associating user accounts/users with smart clips delivered via the kiosk according to some embodiments;

FIG. 12B is a perspective view of a user associating their mobile smart phone with a group of smart clips associated with their user accounts by pairing their mobile smart phone and smart clips and/or smart tags and/or smart locks and/or paired smartclip/tag and/or paired smartclip/lock and/or any combination of individual paired or grouped devices attached to respective luggage according to some embodiments; The smart clips, smart tags and smart locks may be verified and/or paired and or wirelessly network and/or wirelessly group with each other directly and/or via the user's associated mobile smart phone and/or via the kiosk according to some embodiments.

FIG. 12C is a perspective view of a user associating their mobile smart phone with a smart clip associated with their user account by pairing their mobile smart phone and smart clip and attaching it to a piece of luggage according to some embodiments; FIG. 12C is a perspective view of a user using the fingerprint reader on some embodiments of the Smart Clip to verify their identity and lock or unlock and operate the Smart Clip device. In other embodiments the user may lock or unlock and operate the smart clip using a passcode or biometric identification on their mobile smart phone wirelessly paired and/or networked and or grouped with one or more smart clips.

FIG. 13 is a perspective view of the plurality of smart clips, smart tags and smart locks set up in FIGS. 12B and 12C wirelessly paired and wireless communicating with one another and with the Internet and user accounts on a cloud platform server via a personal, local or wide area network according to some embodiments; FIG. 13 illustrates a group of two or more smart clips, smart tags and smart locks wirelessly on one or a plurality of bags that may belong to the same user, family or travel group or may be on the same vehicle, flight or other form of travel, living or storage facility, being wirelessly grouped and geofenced together and they may track and monitor each other for location and spatial positioning, logistics, handling, storage, security and other group functions.

FIG. 14 is a perspective view of the plurality of smart clips, smart tags and smart locks attached to one or a plurality of bags that may wireless connect with airline, airport, ship, hotel or other computer consoles for identification and automatic luggage check-in service. FIG. 14 illustrates luggage being weighed on a scale that may wirelessly network with one or more smart clips, smart tags and/or smart locks attached to verify the weight of each piece of luggage and upload that data to one or a plurality of smart clips, smart tags and smart locks attached to the luggage and/or wirelessly network with a user smart phone and/or upload the data to a user's account and/or to the Internet and enterprise cloud platform. The weight and other measured data may be stored on one or more smart clips, tags or locks so that baggage weight temperature, motion, orientation, and other data may be wirelessly verified at other check points along the journey and wirelessly networked with the user either directly or via a device Internet or direct wireless network with a cloud platform server.

FIG. 15 is a perspective view of an authorized security agent opening and inspecting a piece of luggage and its contents. Authorized personnel may be assigned a unique password identifier to their user account than enables their smart phone, tablet or other computing device to wirelessly network with one or more smart clips, smart tags or smart locks attached to one or more bags or other luggage to inform the smart luggage device that the person inspecting their luggage is an authorized agent and enable the agent to unlock the smart clip, smart tag or smart zipper locking device using a TSA key, passcode, fingerprint reader, face identification (ID), voice ID or other biometric identifier to unlock and open a piece of luggage and deactivate the alarm that may exist in some embodiments of the smart clip, smart tag or smart lock. The authorized agent may be identified wirelessly via a networked device or may manually identify themselves by entering a passcode or using the fingerprint reader, face ID, voice ID or other biometric identifier using a finger print reader, camera and/or microphone on some embodiments of the smart clip, smart tag or smart lock devices attached to the luggage. FIG. 15 also illustrates an authorized agent wearing an RFID tag. An authorized agent may be recognized by an RFID tag or other active or passive RF or RFID enabled device which may be recognized by one or more active or passive RFID enabled smart clips, smart tags or smart locks or other smart devices attached and/or assigned to one or more bags or other luggage.

FIG. 15 illustrates that when an authorized agent is wirelessly or manually identified by one or more smart clips, smart tags, smart locks or other smart luggage devices attached and/or assigned to one or more bags or other pieces of luggage, a wireless alert may be sent out to one or more authorized users via SMS text message, a direct wireless call or network connection and/or via the Internet and enterprise platform server with real-time sensor and other data uploaded to one or more user accounts and then wirelessly updated to the mobile application software running on one or more smartphones or other networked computing devices. In some embodiments an alert may require an action such as two-way or multi-feed voice communications and/or real-time voice and video communications to visually verify and/or monitor an authorized agent or agents while they open and inspect the luggage. A wireless alert sent to one or more authorized users may also require one or more users to remotely deactivate the alarm or remotely unlock the smart clip, smart tag, smart lock or other smart luggage device using one or more manual input or automated user identification and security verification processes such as password, fingerprint, face ID, voice ID or other biometric identifier using the authorized users phone or other networked computing device running the mobile application software to remotely unlock, open, deactivate the alarm, turn on/off, activate/deactivate and remotely operate one or more cameras, lights, microphones, speakers in some embodiments of the smart clip, smart tag, smart lock or other remotely operated sensors, controls and functions on one or a plurality of smart clips, smart tags, smart locks or other networked smart luggage devises assigned to a user or users.

FIG. 16 is a perspective view of a traveler walking up to an airline agent and both the traveler and the agent receive a real-time geofenced baggage location status alert confirming that the traveler's bag is on a baggage transport vehicle and preparing to be loaded onto the travelers assigned flight. One or a plurality of smart clips, smart tags, smart locks or other smart networked luggage tracking, monitoring and/or security devices attached or assigned to the traveler's checked-in luggage may send out alerts when they network with and/or identify their location and relational position to an assigned or authorized vehicle, airplane or other transportation system with an onboard location, networking and/or RF or RFID system enabling one or a plurality of smart clips, smart tags or smart locks to identify their location, position and status in relation to an assigned flight or other travel itinerary or assigned process such as baggage loading, unloading, baggage security, baggage claim and other processes. FIG. 16 also illustrates a smart clip attached to the traveler's carry-on bag which may be wirelessly paired and/or networked with the traveler's smart phone or may be connected via a wireless Internet connection or a virtual private network connection to the enterprise cloud server with real-time tracking, status updates and alerts on the traveler's phone via the mobile application software or via direct SMS text message alerts or a direct call or peer-to-peer network alert from the smart clip. The traveler's smart phone may be authorized for location tracking, geofencing, networking, security and/or other functions on the user's account enabling the location of the smart phone and traveler to be tracked in relation to one or more smart clips, smart tags or smart locks assigned to the user. When the traveler is within a geofenced area such as the boarding area for the traveler's assigned flight or when the traveler is outside of an assigned geofenced area or is separated from one or a plurality of smart clips, smart tags or smart locks attached and/or assigned to one or more bags or luggage owned or assigned to the traveler, an alert may be sent to the traveler's smart phone or one or more other networking and computing devices and may be wirelessly updated on the travelers cloud platform server account and then wirelessly updated on all of the travelers assigned networked devices. Some or all traveler, traveler smart phone and/or assigned smart clip, smart tag, smart lock or other attached and/or assigned smart luggage device data and alerts may be visible to authorized personnel via the enterprise platform server and/or on an authorized networked device.

In some embodiments, one or a plurality of the smart clips, smart tags, smart locks or other smart luggage devices may be leased and/or temporarily assigned to one or more travelers or other users by an airline, airport, shipping and/or cruise line, bus, train, car rental, hotel or other company or government agency for one or multiple flights, trips or for a specified time, distance, event or process and authorized agents may have direct access and control of one or a plurality of smart clips, smart tags or smart locks attached and/or assigned to the traveler's luggage throughout the duration of their assignment to the Traveler. In other embodiments, one or a plurality of smart clips, smart tags, smart locks or other smart networked luggage devices may be owned and operated by a traveler or travel group who may assign temporary access and control or limited access and control to one or more companies or agencies for example assigning access to one or a plurality of smart clips, smart tags, smart locks and other smart luggage devices to one or more airlines, airports and authorized airline, airport and security personnel throughout the duration of one or more flights and/or while the assigned one or a plurality of smart clips, smart tags, smart locks or other smart networked luggage devices are within one or more a geofenced areas including the departing and arriving airports and assigned aircraft, vehicles and transportation systems.

FIG. 17 is a network diagram illustrating a plurality of tracked and monitored luggage via one or a plurality of smart clips or smart tags or smart locks and other smart luggage devices attached and assigned to one or a plurality of luggage on a flight and two travelers assigned to the one or plurality of smart clips, smart tags, smart locks attached to one or a plurality of luggage owned or assigned to the travelers. The luggage and travelers are traveling on an assigned aircraft. The location and relational position of the luggage may be tracked using satellite positioning on some embodiments of the smart clip or smart tag or smart lock or other smart networked luggage device or in other embodiments, may be tracked using local area networking, peer-to-peer networking and positioning and/or onboard Wi-Fi or other authorized wide area network or uplink to the Internet, public or private wireless network and cloud platform server or servers.

Travelers may be identified and their location and relational position may be tracked via their smart phones or other mobile computing and networking devices using one or more available personal, local and wide area wireless networks, peer-to-peer networks and positioning systems, radio frequency (RF) and RFID systems and/or satellite location tracking systems. When one or more travelers and/or their luggage are assigned to one or more flights and departing and arriving airports or other authorized vehicle or transportation system

FIGS. 18A and 18B are overhead and perspective views illustrating real-time flight and travel itinerary data assigned to the user account based on real-time data from the Aircraft Situation Display to Industry (ASDI) and/or Flight Information Display Systems (FIDS) and/or real time flight and travel itinerary data from the airline and/or airport server networked and/or uploaded to the provider platform server, with user specific real-time flight, travel and luggage itinerary data and alerts updated on each user account and then in embodiments, wirelessly sent out to all networked smart clips, smart tags, smart locks or other smart luggage devices and in some embodiments displayed on the smart clip or smart tag screen and user interface and wirelessly sent out to all authorized and assigned smart phones or other networked computing devices via the mobile application running on authorized users devices and/or via a text alert, direct call and/or available on the cloud platform via a secure user account accessed via the Internet or other public or private network.

FIG. 19 is a network diagram illustrating how the provider platform is able to collect and assign all relevant real-time flight, travel, luggage, location, security and other relevant data and assign it to each users account and each networked smart clip, smart tag, smart lock or other smart luggage device and in some embodiments generate relevant real-time on-luggage itinerary alerts and instructions displayed on the screen of one or a plurality of smart clips, smart tags, smart locks or other smart luggage devices with instructions for travelers and/or baggage handlers and other airline, airport, security and other authorized personnel and real-time flight, travel and luggage itinerary alerts and instructions to travelers via their smart phones or other networked computing devices such as informing them of their relational position and distance to their assigned gate and alerting travelers of flight or gate changes with real-time instructions on how to get to the new gate based on the travelers current location. This may be accomplished using a database, analysis engine, artificial intelligence platform, platform server, website and mobile user interface, mobile applications and application programming interface (API) for securely exchanging data, applications, functionality, networking, communications, tracking and interfacing in real-time between a plurality of computer programs, software and software applications, servers, programs and services and other platforms such as airlines, airports, shipping, cruise lines and travel booking services, TSA and other government agency software and servers and real-time flight itinerary and logistics systems such as the Aircraft Situation Display to Industry (ASDI) and/or the Flight Information Display Systems (FIDS).

Real-time and other collected, stored, managed, networked data may include but is not limited to flight, aircraft, airport, ships, cruise lines, trains, buses, taxis, cars and other vehicles and transportation systems, airports, shipping ports, train, bus and other stations, hotels and luggage tracking, identification and location data, smart clips, smart tags, smart locks and other smart luggage devices, sensors, location, events, logs and alerts, user identification data, handler identification data, security data image, audio-video and other stored, streamed or real-time communications data, user, passenger, traveler, authorized personnel, enterprise, travel and government agencies and other device, network, user or entity identification, fingerprint, face ID and other secure biometric identification data, travel, location, security and other data and user and enterprise devices including but not limited to smart phones, tablets, PC's and other wired or wireless networking and computing systems, sensors, routers, RF, RFID and other tracking and security devises, systems and databases as well as real-time weather, traffic, local event, news, security and other data for predictive analytics and accurate real-time travel and luggage logistics, monitoring, security and other services.

The platform is also able to provide real-time information and status of luggage and confirm if the luggage is being loaded onto the correct flight. The platform is able to provide real-time traveler and baggage location, sensor, security and other data with airlines, airports and other transportation, travel, security and other authorized enterprises and agencies enabling them to better manage passengers, luggage, and flight logistics and security.

FIG. 20A is a perspective view of an unauthorized person picking up a bag at an airport baggage carousel at an assigned baggage claim area with one or more smart clip, smart tag and/or smart lock (smart luggage device(s)) attached and assigned to the bag. Using a personal, local or wide area network, RF or RFID positioning or satellite positioning system, one or plurality of smart clip, smart tag or smart lock devices are able to identify that the tracked luggage is located in the baggage claim area. The baggage claim area may in some embodiments and situations be geofenced as a high security area and the device may be pre-programed or receive real-time instructions to generate a light and/or audio alert when the bag is picked up and require any person who picks up the bag to verify their identity either wirelessly using a passcode, password, fingerprint, face ID, voice ID or other biometric identification using their smart phone other wireless computing device or in some embodiments, enter a passcode or password, or use face ID or fingerprint ID on the smart clip, smart tag or smart lock device. In some embodiments, the smart clip, smart tag, smart lock or other smart luggage device may recognize when it is picked up using its motion and orientation sensors or in some embodiments its camera and imaging sensors. In some embodiments, the smart clip, smart tag, smart lock or other smart luggage device or devices may then be pre-programmed to automatically turn on the camera to capture and/or stream audio and/or video of the event to one or more authorized user's phone or their via their user account, cloud platform server and/or their mobile application software downloaded and/or installed on their smart phone or other networked computing device and in some embodiments may be able to use the camera to identify whether the person picking up the luggage is an authorized person using a biometric face ID log stored on the device or stored on the cloud platform server. In embodiments where face ID is not available, the bag may be pre-programmed to play a pre-recorded audio alert which may be an alarm or a spoken audio alert such as “Please verify that you are the authorized owner of this bag” requesting that the user identify themselves as an authorized person assigned to the smart clip, smart tag, smart lock or other smart luggage device or devices and an owner or an authorized handler of the bag. The person may then wirelessly identify themselves using a smart phone or other wireless computing device to pair and/or network with the smart clip, smart tag, smart lock or other smart luggage device and enter a stored passcode or password or use biometric identification such as fingerprint or face ID on the smart phone. In some embodiments the person may enter a passcode or use a fingerprint reader on the smart clip, smart tag, smart lock or other smart luggage device to verify user identity and confirm they are an authorized person to pick up, handle or take the bag out of the geofenced area. Varying levels of authorization may be assigned to different people or groups of people for example airline personnel may be authorized to pick up the bag and move it to a secure baggage claim location but may not be authorized to open the bag or take the bag and assigned one or plurality of smart clips, smart tags, smart locks and other smart luggage devices out of the airport without authorization from the bag owner or account manager.

FIG. 20B is a perspective view of an unauthorized person picking up a bag at an airport baggage carousel at an assigned baggage claim area with one or a plurality of smart clips, smart tags, smart locks or other smart luggage devices attached and assigned to one or more bags in close proximity on the baggage carousel. In some embodiments the bags and attached smart clip, smart tag or smart lock devices may be part of a pre-assigned group of bags belonging to one person, one family or one travel group or the bags and attached/assigned smart clips, smart tags and smart locks (smart luggage devices) may be dynamically assigned to a group based on their being part of the same flight or assigned to the same baggage carousel and baggage claim area. In some embodiments, when one smart clip or smart tag or smart lock in a device group is alerted and begins video recording and/or video stream an event, it may alert surrounding networked smart devices with cameras to also record and stream an event. If the surrounding networked devices belong to different authorized people, owners, companies or agencies or entities, the video captured by all networked bags during a shared event may be tagged with ID code of surrounding networked devices and their assigned luggage so that when the video is uploaded to the cloud platform it may be accessible by authorities or by the other owners in case of an event such as the unauthorized opening and/or theft of a bag and/or belongings/content or damage of a bag due to being picked up, dropped, opened or taken by an unauthorized person.

In some embodiments, in the event that a motion, orientation, camera, imaging or other sensor of one or more smart clips, smart tags, smart locks or other smart luggage devices, recognizes that a bag is picked up, one or more alerts may be automatically generated. Alerts may include on-bag alerts such as light, audio or visual alerts such as different color lights flashing and different light flashing sequences may represent different types of events or alerts.

In some embodiments an on-bag alert may be an audio alert such as an alarm, siren, chirp or other sound, with different sounds representing different types of alerts. In some embodiments an audio alert may be pre-recorded messages such as “Please verify your identity” or “This is not your bag” or when the bag is picked up by an authorized handler an audio alert may state “Please handle this bag with care”. In some embodiments a real-time audio alert may be sent out by an airline, airport or other authorized transportation, travel or other enterprise or agency with real-time information and instructions for example if one or more bags miss their scheduled transfer flight or a flight is canceled, or the gate and/or aircraft assigned to a flight changes an audio alert may be sent out to one or a plurality of smart clips, smart tags smart locks or other smart luggage devices with real-time instructions as to where the luggage needs to be delivered.

In some embodiments of a smart clip or a smart tag with a screen or touch screen display, a real-time alert may displayed on a screen or screens such as request for user identification or real-time instructions on who and/or where the bag should be delivered to and when available, the location of one or more authorized people to pick up the bag in relation to the bags current position. In some embodiments a smart clip or smart tag camera may capture and/or stream real-time video of the person picking up the luggage. In some embodiments an image or video of the person picking up the luggage may be displayed in real-time on a smart clip or smart tag screen or display with an alert informing the person that they are on camera “You are being video recorded” and when face ID is available, if the person picking up the bag is a pre-programed alert and request for action may be displayed such as “Face ID not recognized, please enter your passcode to verify your ID”. In some embodiments video may be streamed in real-time to one or more authorized smart phones or other mobile devices assigned to one or more authorized person, enterprise or agency either via a direct local area or wide area network audio-video call or via the Internet and cloud platform server and the mobile app on one or more smart phones or other networked computing devices of an authorized user or users. In some embodiments an authorized agent from an airline, airport, company and/or service provider may be given access to monitor, manage and control one or a plurality of smart clips, smart tags, smart locks or other smart luggage devices attached and assigned to one or more bags. In embodiments where a smart clip, smart tag or other smart luggage device has a camera and is wirelessly connected to the Internet and/or connected to the cloud platform server via a private or public network or is in a direct peer-to-peer wireless call with one or more authorized users, one or more users may directly speak with the authorized or unauthorized person handling the bag and with real-time two-way or multi-feed audio communications and in some embodiments two-way or multi-feed video communications.

In some embodiments, when an alert is sent out by one or a plurality of smart clips, smart tags, smart locks or other smart luggage device(s) to one or more assigned and authorized users, a primary agent or manager may be assigned permanently or for the duration of a flight or for the duration of an entire trip or other event. When a primary agent is assigned to monitor, manage and secure one or more bags or pieces of luggage assigned to one or a group of users such as all bags on a flight, they may be given direct access to respond to an alert and/or event in case the owners or authorized users assigned to the smart clip, smart tag, smart lock or other smart luggage device or devices are in flight or are otherwise inaccessible may be authorized to respond on behalf of one or more authorized users.

In embodiments wireless alerts may be sent to one or more authorized users via one or more networks and/or networking methods, protocols and services such as an SMS text message or a direct peer-to-peer wireless call over a local or wide area network to one or more pre-programed and authorized smart phones or other networked computing devices owned and operated by one or more authorized users assigned to one or a plurality of smart clips, smart tags, smart locks and/or other smart luggage devices. The alert may also be wirelessly uploaded and/or streamed to one or more user accounts on the cloud platform server and viewed and or viewable in real-time on the mobile application downloaded or installed on one or more authorized user smart phones or other networked computing devices and/or accessible on the Internet or via a public or private network.

FIGS. 20C and 20D are both overhead and perspective views of an airport map with real-time location tags for two authorized users assigned to a group of bags and a plurality of smart clips, smart tags, smart locks or other smart luggage devices assigned to one or a plurality of bags assigned to the two users. In embodiments, two or more smart clips, smart tags, smart locks or other smart luggage devices attached and/or assigned to one or more bags or other luggage may be grouped together at the beginning of a trip or pre-flight or may be grouped together or re-assigned to a different group in real-time by an airline or other authorized enterprise, agency or account manager if there is a change in flight, gate change, baggage carousel change or other alteration to the original flight or travel itinerary. When one or a plurality of smart clips, smart tags, smart locks or other smart luggage devices assigned to one or a plurality of bags assigned to a group is separated from the group beyond a specified distance, for example 100 feet, then an on bag and/or wireless alert may be generated and sent out to one or more authorized users. When a bag that is a part of a group is separated from the rest of the group all bags that are part of the group may be pre-programmed to activate on-bag alerts and/or wireless alerts. In FIGS. 20C and 20D one of the bags that is assigned to the two authorized users shown with real-time location tags has been picked up and taken away by an unauthorized user. A geofence may be assigned to a specific area such as an airport baggage carousel or other baggage claim area. When a person picks up a bag from a baggage carousel or other baggage claim area, they may be required to verify their identity either directly on a smart clip, smart tag, smart lock or other smart luggage device or via a paired or networked smart phone or other authorized networked computing device. If the person picking up the bag fails to verify themselves as an authorized user assigned to one or a plurality of smart clips, smart tags, smart locks or other smart luggage devices attached or assigned to one or more bags either within a specific amount of time or within a designated area, then an alarm may be set off and/or other on-bag and/or grouped bag and/or wireless security alerts may be generated and security processes may be initiated such as capturing and/or streaming real-time video of the event to one or more authorized users. If an unauthorized user attempts to take a bag outside of an assigned area, pre-programmed light, audio and visual alerts such as blinking red lights or an audio alert message such as “Please stop and verify that you are the authorized owner of this bag” may be played to warn the unauthorized person that they may have taken the wrong bag or that they may be approaching the edge of a geofenced area and that an alarm will go off if they leave the area without verifying their identity. In the event of a theft, damage or other unauthorized access to a bag or an emergency event such as a fire is detected by one or a plurality of smart clips, smart tags, smart locks or other smart luggage devices assigned to one or a plurality of bags or other luggage. local airline, airport, security, emergency response or other authorized personnel may also be contacted based on location and/or pre-programmed event parameters.

FIGS. 21A, 21B are both overhead and perspective views of an airline passenger standing in front of baggage carousel 3 at a baggage claim area in an airport. In embodiments, the passenger (Authorized User) receives real-time luggage location and status updates on his smart phone via the mobile application software connected to the cloud platform server which is wirelessly connected to a plurality of smart clip, smart tag, smart lock and other smart luggage devices and/or the passenger's smart phone may be directly wirelessly connected to one or a plurality of smart clips, smart tags, smart locks or other smart luggage devices attached and/or assigned to one or plurality of bags or other pieces of luggage assigned to the passenger (authorised user) via a personal, local or wide area network. A plurality of the smart luggage devices assigned to the authorized user may be physically or wirelessly paired, and/or wirelessly grouped and may monitor each other's relational position using one or a plurality of wireless networks and/or wireless location and positioning systems and methods.

In embodiments, one or a plurality of smart clips, smart tags, smart locks and other smart luggage devices may optimize their power by selecting the most power efficient method for networking and/or continuously tracking location until an alert is triggered in one or a plurality of the smart luggage devices that requires a higher level of data connectivity and/or a more precise location and position identification and verification for example if one or a plurality of smart luggage devices are in a pre-assigned or real-time assigned high security geofenced area such as a baggage claim area, In some embodiments, one or a plurality of smart luggage devices may be required to identify themselves to their owners using one or more on-luggage and/or wireless alert methods including, lights, sounds, recorded messages, audio and/or video streaming and ultra-precise location tracking, spatial and relational positioning. In these and other scenarios the smart luggage device may select one or a plurality of available networks and location positioning systems to provide authorized users with precise real-time location and relational positioning data and bag identification.

FIG. 21C is an overhead view of an airline passenger standing in a baggage claim area near two baggage carousels. The passenger is identified by a dotted circle around the figure with dotted lines to fixed airport Wi-Fi routers and/or Bluetooth wireless hubs and/or radio frequency (RF) and/or active RFID hubs for tracking luggage and dotted lines to one of the users bags on the baggage carousel tracked using one or a plurality of smart clips, smart tags, smart locks or other smart luggage devices attached and/or assigned to one or plurality of bags or other pieces of luggage assigned to the passenger (authorised user) via the cloud platform and mobile app and/or via a personal, local or wide area network. A plurality of the smart luggage devices assigned to the authorized user may be physically or wirelessly paired and/or wirelessly grouped and may monitor each other's relational position using one or a plurality of wireless networks and/or one or a plurality location and positioning systems. In embodiments the wireless networks and wireless location positioning system may include but are not limited to satellite positioning system, cellular networks and cellular positioning system including but not limited to cell tower and signal strength positioning and/or triangulation, Wi-Fi router and/or Wi-Fi peer-to-peer signal strength positioning, ultra-wideband networking and directional signal strength positioning, Zigbee peer-to-peer mesh networking, Bluetooth and/or low power Bluetooth (LPB) peer-to-peer and Bluetooth hub directional signal strength positioning, Near Field Communication (NFC), radio frequency (RF) and active and/or passive RFID tracking systems.

FIG. 21D is a perspective view of an authorized user verifying their identity to one or a plurality of smart clips, smart tags, smart locks or other smart luggage devices using one or a plurality of security and/or biometric identification methods including but not limited to face identification (Face ID), eye and/or iris identification, voice and/or voice password identification, RF or RFID enabled tag or device identification and manual user security identification such as a passcode or password. User Identification may occur by pairing and/or networking one or a plurality of smart clips, smart tags, smart locks or other smart luggage devices to a user's smart phone or other authorized networking and computing device or in some embodiments may be performed on a camera enabled and/or touchscreen enabled and/or fingerprint reader enabled smart luggage device. User Identification and verification may be required by one or a plurality of smart clips, smart tags, smart locks or other smart luggage devices at specified check points or geofenced areas such as an airport baggage claim area.

FIGS. 21E, 21F are overhead and perspective views of an authorized user being alerted by one or a plurality of smart clips, smart tags, smart locks or other smart luggage devices assigned one or a plurality of bags or other luggage items owned and/or assigned to the authorized user, to return the devices to an assigned drop-of location. In some embodiments one or more smart luggage devices may be assigned to an authorized user for a single flight, multiple flights to a final destination or for two or more round trip flights and/or the duration of a trip or other specified time period, event flight, trip or other process.

FIG. 21G is a perspective view of a smart clip, smart tag, smart lock or other smart luggage device return kiosk and a authorized user returning one or a plurality of smart luggage devices to the return kiosk.

FIG. 22 is a perspective view of an authorized user in a parking lot with one or a plurality of smart clips, smart tags, smart locks or other smart luggage devices assigned one or a plurality of bags or other luggage items owned and/or assigned to the authorized user and assigned and wirelessly pairing, networking and/or grouping with a a rental car or other vehicle.

FIG. 23 is a perspective view of an authorized user in a hotel with one or a plurality of smart clips, smart tags, smart locks or other smart luggage devices assigned one or a plurality of bags or other luggage items owned and/or assigned to the authorized user and assigned and wirelessly pairing, networking and/or grouping with a a hotel, hotel room or other assigned living area, storage area or other assigned area. In embodiments one or a plurality of smart luggage devices may also wirelessly pair and/or be assigned to a wireless hotel key card for real-time hotel location and security.

FIGS. 24A-E are perspective views of smart clip embodiment that attaches over the full handle of a luggage

FIGS. 25A-E are perspective views of smart clip and removable smart tag and smart lock embodiment that attaches over the full handle of a luggage

FIGS. 26A-D are perspective views of smart clip and removable smart tag and smart lock embodiment that attaches over the full handle of a luggage

FIG. 27 is a system block diagram of a smart clip, smart tag, smart lock or other smart device sensors and systems according to some embodiments

FIG. 28 is a system block diagram of a smart clip, smart tag, smart lock or other smart device sensors and systems according to some embodiments

FIG. 29 is a system block diagram of a smart clip or other smart device according to some embodiments. In some embodiments the smart clip is a luggage smart clip.

FIG. 30 is a system block diagram of the wireless connectivity devices of the system FIG. 29 according to some embodiments. In some embodiments the smart clip is a luggage smart clip, smart tag or other clip accessory device described herein and/or shown in the accompany figures.

FIG. 31 is a system block diagram of the sensors according to some embodiments of the system of FIG. 29.

FIG. 32 is a system block diagram of the alert signalling devices according to some embodiments of the system of FIG. 29.

FIG. 33 is a system block diagram of the security devices according to some embodiments of the system of FIG. 29.

FIG. 34 is a system block diagram of the location/positioning systems according to some embodiments of the system of FIG. 29.

FIG. 35 is a system block diagram of the power devices according to some embodiments of the system of FIG. 29.

FIG. 36 is a software components diagram according to some embodiments which may be executed by and/or stored on one or more processing devices/memory of the system of FIG. 29 and/or on a remote device.

FIG. 37 is a set up/device control user interface of software according to some embodiments for use with the smart clip or other smart device. The user interface may be a non-limiting example of a user interface of the software of FIG. 29.

FIG. 38 is a set up/device control user interface of software according to some embodiments for use with the smart clip or other smart device. The user interface may be a non-limiting example of a user interface of the software of FIG. 29.

FIG. 39 is a User Interface-Alert Notification Settings user interface of software according to some embodiments for use with the smart clip or other smart device. The user interface may be a non-limiting example of a user interface of the software of FIG. 29.

FIGS. 41 to 51 illustrate various methods of operation according to some aspects and embodiments for at least one luggage smart clip, at least one luggage smart tag, and/or at least one other luggage smart clip accessory device. It is envisaged that these methods may be implemented in other types of smart devices or systems disclosed herein other than the luggage smart clips. One or more of the steps in each figure may be omitted or the sequence of the steps may be rearranged as appropriate.

FIGS. 52A and 52B illustrate respective embodiments of a Smart Tag with incorporated Smart Clip with secure luggage handle attachment and locking system (In these embodiments the SmartTag is the device with its own built in luggage attachment and locking system)

FIG. 53 is an example computing environment suitable for implementing aspects of the present technology.

The drawings referred to in this description should be understood as not being drawn to scale, except if specifically noted, in order to show more clearly the details of the present disclosure. Same reference numbers in the drawings indicate like elements throughout the several views. Other features and advantages of the present disclosure will be apparent from accompanying drawings and from the detailed description that follows.

### LuggageCam Patent Numbering

100—Smart Clip
100a—Smart Clip with full sensor array, cameras and on-device display with digital lock only
100b—Smart Clip with combination lock and digital lock
100c—Smart Clip with flash light
100d—Smart Clip with digital lock only and no cameras (basic Smart Clip)
101—Top Section of Smart Clip
102—Bottom Section of Smart Clip
103—Rear Hinge and Electrical/Data Conduit
104—Interior of Smart Clip with Inductive Power surface
106—Power and Data Port
107—Power and Data Port for Locked/Paired Smart Clip Accessory Devices
108—Tongue with locking slots
110—Adjustable Tongue Locking Port
112—Release button
114—Finger Print Scanner
120—Camera
122—LED Light
124—IR Light
126—IR Projector
128—IR Sensor
130—Multi-colored Light Strip
140—Speaker
142—Microphone
150—Display
152—Flash Light
160—Combination Lock
170—TSA Key Lock
200—Smart Clip Power and Data Wire Transfer System
202—Smart Clip Power and Data Wire Transfer Wire Hub
206—Smart Clip Power and Data Wire Transfer SmartClip Port
208—Smart Clip Power and Data Wire Transfer System Plate
210—Smart Clip Power and Data Wire Transfer System Plate Locking Slot
216—Smart Clip Power and Data Wire Transfer System Wire
300—Smart Luggage Tag
300a—Smart Luggage Tag Removable Device and Case
300b—Smart Luggage Tag Single Unit (No Separate Case) with Camera, Lights & IR Sensors
300c—Smart Luggage Tag Single Unit (No Separate Case) No Cameras, Lights & IR Sensors
300d—Smart Luggage Tag Single Unit with flexible tether and Cameras, Lights & IR Sensors
300e—Smart Luggage Tag Single Unit with Flexible Tether and no Cameras, Lights & IR Sensors
301—Smart Luggage Tag Removable Device
302—Smart Luggage Tag Case
306—Smart Luggage Tag Power and Data Port
308—Smart Luggage Tag Case Porting Plate with Inductive Power/Data Port
310—Smart Luggage Tag Case Porting Plate Locking Slot
311—Smart Luggage Tag Case Removable Device Insert Slot
312—Smart Luggage Tag Case Release Buttons
315—Smart Luggage Tag Case Screen Protector
318—Smart Luggage Tag Case Smart Clip Attachment System
320—Camera
322—LED Light
326—IR Projector
328—IR Sensor
330—Smart Luggage Tag Power Button
332—Smart Luggage Tag Case Power Button
338—Smart Luggage Tag Locking Port
340—Speaker
342—Microphone
350—Smart Luggage Tag Screen
360—Flexible Smart Luggage Tag Tether
400—Smart Luggage Zipper Lock Device & System
408—Smart Luggage Zipper Lock Device Porting Plate (with optional inductive power and data)
410—Smart Luggage Zipper Lock Device Porting Plate Locking Slot
412—Smart Luggage Zipper Lock Device Release Button
414—Smart Luggage Zipper Lock Device Finger Print Scanner
418—Smart Luggage Zipper Lock Device Smart Clip Attachment System
422—Smart Luggage Zipper Lock Device LED Light
440—Smart Luggage Zipper Lock Device Speaker
460—Smart Luggage Zipper Lock Device Combination Lock
470—Smart Luggage Zipper Lock Device TSA Key Lock
500—Airline Baggage Owned by Male Traveler
500a—Large Roller Luggage
500b—Carry-on Roller Luggage
500c—Travel Luggage Bag
501—Luggage Handle—Top
502—Luggage Handle—Side
503—Luggage Handle—Retractable
504—Luggage Zipper Pull
505—Luggage Zipper
510—Luggage Factory Installed Zipper Lock
550—Airline Baggage Not owned by Male Traveler
600—Smart Vending Machine
610—Smart Clip and Accessory Return Kiosk
612—Credit Card Payment & User ID System
613—Numeric Key Pad
614—Palm and Finger Print Scanner
615—Credit Card Terminal
616—Smart Vending Machine Buttons
618—Smart Vending Machine Device Dispenser
620—Smart Vending Machine Camera
620a—Smart Vending Machine Camera Array—Face and body Imaging and User Identification
620b—Smart Vending Machine Camera Array—Luggage, Smart Clip and Accessory Device Imaging and Identification
622—Smart Vending Machine Light
624—Smart Vending Machine IR Light
626—Smart Vending Machine IR Projector
628—Smart Vending Machine IR Sensor
650—Smart Vending Machine Touch Screen Interface
700—Male Traveler—Luggage Owner and Primary Smart Clip and Accessory Contact
710—Female Traveler—Luggage Owner and Authorized Smart Clip and Accessory Contact
720—Female Contact—Authorized Smart Clip and Accessory Contact
730—Authorized Airline Security Personnel
740—Airline Personnel
750—Luggage Thief
760—Provider Security Agent
770—Airport Security Agent
800—Phone—Male Traveler and Primary Luggage Contact
801—Phone—Female Authorized Luggage Contact
802—Phone—Female Traveler and Authorized Luggage Contact
810—Phone Interface
830—Phone—Airline Security Personnel
840—ID Tag—Airline Security Personnel (RFID Enabled)
842—ID Tag—Airline Personnel (RFID Enabled)
900—Wireless Network
910—Provider Platform Server
912—Analysis Engine
914—Artificial Intelligence System
916—APIs for Airline, Airport, Flight, Traveler, Luggage, Luggage Tracking Devices, and Personnel Logistics, Tracking, Security and other Data, Applications, Alerts and Services.
918—Database
920—Web and Mobile Interface
922—Software Applications
950—Provider Platform
960—Provider Computer
1000—Airline Check-in Computer Kiosk
1002—Luggage Scale
1010—Airline Server
1010a—Airline Server for Initial Flight
1010b—Airline Server for Transfer Flight
1020—Airport Baggage Transport Vehicle
1030—Airplane
1030a—Airplane—First Flight
1030b—Airplane—Initial Transfer Flight
1030c—Airplane—Replacement Transfer Flight
1050—Airline Platform
1100—Airport
1110—Airport Server
1110a—Airport Server for Initial Flight
1110b—Airport Server for Transfer Flight
1160—Airport Security Computer
1200—Luggage Carousel
1200a—Luggage Carousel 1
1200b—Luggage Carousel 2
1200c—Luggage Carousel 3
1210—Luggage Carousel Wireless Router/Hot Spot/Fixed Wireless Location Beacon
1250—Airport Escalator
1300—Geofenced Airport Level 2
1310—Geofenced Airport Luggage Carrousel
1320—Geofenced Airport Level 1
1380—GPS
1381—Cellular
1382—Wi-Fi
1383—Bluetooth
1384—Near-Field Communication (NFC)
1385—Peer-to-peer Network
1400—User and Device Identification, Biometric Identification & Security
1401—Face ID
1402—Iris ID
1403—Voice ID
1404—RFID
1405—Password and Passcode Security
1406—Geometric Passcode
1407—Fingerprint ID
1500—Parking Garage
1510—Automobile(s)
1520—Rented or Owned and Geofenced Automobile
1600—Hotel
1610—Assigned Hotel Room
1620—Hotel Room Electronic Key Entry Lock
1630—Hotel Elevator
1700—Smart Handle
1700a—Smart Handle with Cameras, Imaging Sensors & Adjustable Tongue Locking System
1700b—Smart Handle with Cameras, Imaging Sensors & Adjustable Cable Locking System
1700c—Smart Handle with No Cameras or Imaging Sensors
1702—Top of Smart Handle
1706—Power and Data Port
1707—Smart Handle Tongue Locking Port
1708—Adjustable Tongue to wrap and attach around Luggage Handle
1710—Locking Port for Accessory Devices
1712—Release Button
1716—Adjustable Locking Cable
1718—Cable Locking Port
1720—Smart Handle Camera
1722—Smart Handle Light
1724—Smart Handle IR Light
1726—Smart Handle IR Projector
1728—Smart Handle IR Sensor
1730—Smart Handle Light Strip
1800—Device Sensor, Processor, Power & Security Systems
1900—Device Networking, Location & Positioning Systems

### DETAILED DESCRIPTION

In the following description of the best mode of implementation, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

According to some approaches, one or more travel smart devices are configured to be affixable to or carried by a travel object or item such as luggage or other travel object as a security device for the travel object during travel. As will be explained in more detail below, the travel smart device housing has different configurations according different aspects and embodiments of the present technology.

According to some approaches of the present technology, the travel smart device comprises a luggage smart device. According to some aspects of the luggage smart device, the luggage smart device is a luggage smart clip and/or luggage smart clip accessory device which is configured to be operably connected to the luggage smart clip. In some approaches, the luggage smart clip has a housing configured to clip around handles, shafts, rods, straps etc. of suitcases, pet carriers, travel bags or other luggage items.

Electrical and/or mechanical hardware is incorporated into a housing of the luggage smart clip and/or luggage smart clip accessory device. In some aspects, the luggage smart clip includes one or more wireless connectivity devices, one or more luggage security devices, and one or more power devices. In some aspects, one of the luggage security devices comprises a lock configured to lock/unlock the luggage smart clip to the luggage. In some embodiments, the luggage smart clip accessory device comprises a luggage smart display tag or a luggage smart lock accessory. The luggage smart clip accessory device is configured to be physically and/or wirelessly operably connected to the luggage smart clip. In some embodiments, the luggage smart clip lock is configured to lock both the luggage smart clip and luggage smart clip accessory device to the luggage.

The luggage smart clip sensors are configured to detect different luggage status of the luggage to which the smart luggage clip is attached and the environment in which the luggage is located. The luggage smart clip sensors are configured to activate in response to receiving signal(s) from any one or combination of: one or more other sensors, wireless connectivity device(s), luggage security devices, alert signalling devices, location/positioning systems, power device(s) and processing device(s) or other signals received locally and/or wirelessly. The luggage smart clip sensors are configured to send one or more signals corresponding to the sensed status of the luggage and/or environment to any one or more other sensors, wireless connectivity device(s), luggage security devices, alert signalling devices, location/positioning systems, power device(s) and processing device(s) or other signals received locally and/or wirelessly.

The luggage alert signalling device(s) are configured to activate audio, visual, mechanical or other signalling incorporated in the smart luggage device in response to receiving the activation signals. The activation signals may be generated and sent to the luggage signalling device(s) based on predetermined signalling activation conditions being met. The predetermined activation conditions may correspond to predetermined luggage status, such as approved location, position, user ID and authentication of a luggage handler etc. or other conditions associated with the luggage to which the smart luggage device is assigned and attached. The predetermined activation conditions may be set in a user account of a software application associated with the owner or authorized handler of the luggage and control signals sent to the luggage signalling device(s) by the processing device based on the detected luggage status corresponding to the predetermined signalling activation conditions.

The luggage status sensors(s) may be configured to trigger to sense luggage status in response to predetermined conditions. The trigger signals may be generated and sent to the luggage status sensor(s) based on predetermined trigger activation conditions being met. The predetermined activation conditions may correspond to predetermined luggage status, such as approved location, position, user ID and authentication of a luggage handler etc. or other conditions associated with the luggage to which the smart luggage device is assigned and attached. The predetermined trigger conditions may be pre-programmed in the clip or set in a user account of a software application associated with the owner or authorized handler of the luggage and control signals sent to the luggage status senso(s).

The lock(s) is mechanical or electronic and configured to lock the housing of the smart luggage device to the luggage to which it is attached. The electronic lock(s) is configured to activate in response to receiving signal(s) from any one or combination of: the luggage security devices, wireless connectivity device(s), power device(s) and processing device(s) or other signals associated with the luggage and received locally and/or wirelessly via the wireless connectivity device or physically via electrical connectors. The electronic housing lock(s) may be configured to activate lock the luggage smart device to the luggage and to unlock the luggage smart device from the luggage in response to predetermined lock/unlock activation conditions being met. Lock/unlock signals may be generated and sent to the electronic housing lock based on predetermined lock/unlock activation conditions being met. The predetermined activation conditions may correspond to predetermined luggage status, such as approved location, position, user ID and authentication of a luggage handler etc. or other conditions associated with the luggage to which the smart luggage device is assigned and attached. The predetermined lock/unlock activation conditions may be set in a user account of a software application associated with the owner or authorized handler of the luggage and lock/unlock signals sent to the electronic lock by the processing device according to which predetermined lock/unlock activation conditions have been met.

The power devices comprise power sources and/or power connectors. Power sources themselves, such as batteries, are operably connected to the luggage security device(s), electronic lock, digital display and wireless connectivity device(s) and processing device(s). Power connectors are configured to interconnect external power source(s) with the battery and/or other devices incorporated in the smart luggage device so as to power the battery and/or device(s).

Wireless connectivity device(s), luggage sensor devices, luggage alert signalling devices, luggage security systems(s), power device(s), location/positioning system, and processing device(s) and associated memory are operably interconnected electrically. In some other embodiments, part or all of the processing device(s) and/or memory are located in or distributed among any one or combination of: one or more other smart luggage devices, one or more other external local devices, and one or more external remote devices. Parts or all of the processing device(s) and/or memory located in external device(s) in some embodiments are operably connected to the luggage smart clip devices wirelessly and/or electrically (if the luggage smart clip is electrically connected to the external device(s)). It will be appreciated that in some embodiments any one or combination of the wireless connectivity device(s), luggage clip sensor devices, luggage clip security device(s), location/positioning system(s), power device(s) are individual devices whilst in some other embodiments any one or combination of the devices is integrated at least partially with one another. It will be appreciated that in some embodiments, at least part of the functionally of any one or more of the devices may be performed or assisted by one or more other smart luggage devices and/or external device(s) which are operably connected wirelessly and/or physically to the smart luggage device. By way of example, in some embodiments, at least part of the location/position system may be located remotely or locally in another clip or accessory and operably connected to the location/position sensors in the luggage smart clip wirelessly or electrically.

One or more processing devices and associated memory are configured to control the luggage smart clip according to preconfigured alert/device triggers and preconfigured alert notification settings. The processing device(s) and associated memory may be located in locally in the luggage smart clip or distributed among any one or combination of: one or more of the luggage smart clips, one or more the luggage smart clip accessory devices, one or more external local devices and one or more external remote devices. The alert/device triggers correspond to any one or combination of sensed status of the luggage to which the luggage smart clip is attached, sensed status of one or more handler(s) of the luggage, and travel itinerary updates associated with the luggage. The alert/device triggers may be preconfigured locally in the luggage smart clip and/or remotely in a user account of a software application associated with users assigned to the luggage smart clip. Alert/device notifications settings may be preconfigured locally in the luggage smart clip and/or remotely in a user account of a software application associated with users assigned to the luggage smart clip. Alert/device notifications settings may preconfigured to send triggered alerts to electronic contact details of selected recipients and/or selected devices of the luggage smart clip according to which alerts are triggered.

According to some approaches, a luggage smart digital display tag is operably connectable to the luggage smart clip. A housing of the digital display tag is configured to be any one or combination of: mechanically, electrically or wirelessly connected to the housing of the luggage smart clip.

In some approaches, a plurality of the smart luggage clips and any associated luggage smart clip accessory devices may be interconnected wirelessly and/or physically to operate as a luggage smart system. The plurality of luggage smart clips and any smart associated clip accessory devices may be grouped together and paired together wirelessly.

Reference will now be made to the accompany drawings to describe some aspects of the luggage smart device and luggage smart device accessory devices in more detail.

As mentioned above, in some aspects the luggage smart device is a luggage smart clip. Whilst the figures illustrate particular forms of the clip, it will be understood that in some other aspects, clip housings or clip configurations other than those shown and described herein with reference to the accompanying figures are envisaged. For example, it will be understood that in some other aspects, the smart luggage clip may be implemented in the form of but not limited to a pad lock, cable lock, or the like. Yet furthermore, it would be understood that in some aspects, the luggage smart device may be implemented in housing configurations other than a clip but may still achieve at least one or more of the technical advantages of the luggage smart clip embodiments described herein. By way of example, in some embodiments, the luggage smart device may be a body which is attachable to a piece of luggage by a strap or other retaining accessory or which is insertable and retained inside the luggage such as inside a pocket or compartment of the luggage. By way of further example, in some aspects, the luggage smart device is integrated into the handle or other part of the luggage itself. It would be understood that luggage smart device integrated into the handle or other part of the luggage itself may, according to some embodiments, have the same functionality and plurality of devices and configurations as those of any one or combination of the smart clip, smart tag and smart clip accessory devices of the embodiments described and/or shown herein.

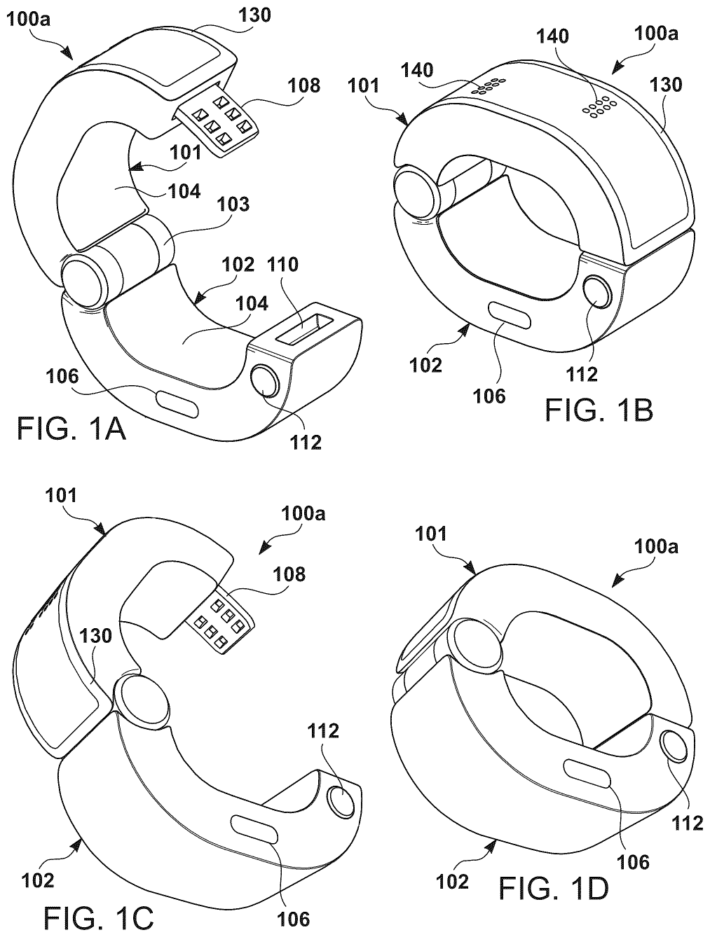

Referring to FIGS. 1 to 6 which illustrate luggage smart clips according to some embodiments, the luggage smart clip housing comprises a pair of clip sections one or both of which are configured to be movable relative to each other for engaging around the handle, shaft, rod, strap etc. of a piece of luggage such as a suitcase, pet carrier, travel bag or the like. As will be explained below, one or both of the housing clip sections of the luggage smart clip serving the hybrid function of both housing the electrical and mechanical hardware and providing the mechanical clipping functionality of the clip.

In the figures, the clip first section is a top section 101 and the corresponding second clip section is a bottom section 102. In some other embodiments, first clip section may be a bottom section and second clip section may be a top section. The electrical and mechanical hardware are incorporated into both the first clip section 101 and the second clip section 102. In some other embodiments, the wireless connectivity device(s), luggage security devices, digital display and power devices(s) are incorporated either in the clip first section 101 or the clip second section 102.

Top section 101 is configured to be movable relative to bottom section 102 such that the smart luggage clip is configurable between an open configuration and a closed configuration. In the open configuration, the top section and bottom section are open relative to each other such that they are configuration placeable around the handle, strap etc of a piece of luggage. The first section is configured to then be movable relative to the second section to close the top section and bottom section together around the handle, strap etc. and securely hold the smart luggage clip in the closed configuration to the piece of luggage.

Each of the smart clip top section 101 and smart clip bottom section 102 are substantially C shaped lengthwise and have a rectangular cross section. A distal first end of top section 101 opposes a second end of top section 101.

Top section 101 includes a middle region extending substantially straight longitudinally between the top section distal first end and top section second end.

Left and right sidewalls extending lengthwise along the top section have flat faces.

A distal first end of bottom section 101 opposes a second end of bottom section 102. Bottom section 102 includes a middle region extending substantially straight longitudinally between bottom section distal first end and bottom section second end.

Left and right sidewalls extending lengthwise along the bottom section have flat faces.

Second end of top section 101 is pivotally interconnected to corresponding second end of bottom section 102 by a hinge 103. In some other embodiments, the corresponding first ends of the top and bottom sections are pivotally interconnected instead of the corresponding second ends of the top and bottom sections and the second ends are distal second ends.

In the closed configuration of the smart luggage clip, a substantially O shaped pass-through opening is formed by the top section and bottom section being orientated and aligned opposing one another. The distal first end of top section 101 opposes and is substantially aligned and contiguous with a corresponding distal first end of bottom section 102. Distal first end of top section 101 has a flat end face portion which rests substantially flush with a corresponding flat face portion of the first end of the bottom section. Second end of top section 101 interconnecting corresponding second end of bottom section 102 is substantially aligned, opposing and contiguous with the corresponding second end of bottom section 102. The middle region of top section 101 is opposing and substantially aligned with corresponding middle region of bottom section 102.

In the open configuration of the smart luggage clip, the top section 101 and bottom section 102 are spaced apart sufficiently to allow the top section and bottom section to be placed around the handle, shaft, strap etc. of the luggage, pet carrier or like travel object and then clipped in place by closing the top section and bottom section together so that the smart luggage clip is in a closed configuration.

In the closed configuration, the handle, shaft, strap etc. of the luggage, pet carrier or like travel object is disposed in the substantially closed pass through opening defined by the top section and the second section.

Top section and bottom section are pivotably relative to each other in a vertical Y plane about hinge X. Top section and bottom section are configured to be movable between open and closed configurations by swinging one or both of the top and bottom sections about hinge X. In some other embodiments, top and bottom sections are pivotable relative a laterally plane Z or other plane about hinge X.

In some embodiments, hinge X is a living hinge integrated into the second ends of the top and bottom sections effectively forming substantially U shaped clip.

In yet some other embodiments, the top section and bottom section are movable between the open and closed position without being pivotally interconnected. By way of example, in some other embodiments the first ends and the second ends of both the top section and the bottom section are distal ends. The distal first end of the top section is configured to removeably fit together with the corresponding distal first end of the bottom section and/or the distal second end of the top is configured to removably fit together with the distal second end of the bottom section. In this manner the top section and bottom section are configured to be movable between the open and closed configurations.

In some other embodiments, mechanisms other than hinges are incorporated into the smart luggage device to move the top section and bottom section between the open and closed configurations. By way of example, in some embodiments, a fastener is configured to enable the first ends of the top and bottom sections to be realeasbly fastened together and a second fastener is configured to enable a top and bottom second ends to be releasably fastened. In some other embodiments, a slider system is configured to allow the top section and bottom section to be moved relative to each other between the open and closed configurations.

In some other embodiments, any other shaped top sections and bottom sections capable of serving as a clip are envisaged. By way of non-limiting example, any one or both of the top section and bottom section may be: a clip section with a different C shape, a clip section curved differently or with curved and/or other linear regions to form the substantially C shape.

In some embodiments, one of the top section and bottom section may be shorter and the other longer than the other but shaped so that when the top and sections are in the closed configuration they still form pass through opening and in the open configuration still allow the smart luggage clip to be placed around the handle of the luggage. By way of non-limiting example, one of the top and bottom sections may be a U-shaped section and the other of the top and bottom sections is section attachable to free ends of the U-shaped section. In the open configuration, the U-shaped section is attachable around the handle, shaft, strap of the luggage, pet carrier or other trave object. In the closed configuration, the free ends of the U-shaped section are fastened to the second section to define the pass-through opening. In some other embodiments, bottom section and/or top section may be shapes other than U or C shape. In some other embodiments, the top section and bottom section may be any shape that enable the smart luggage device to be clipped to the luggage and the luggage security devices to be incorporated into the top and/or bottom section.

It will be appreciated that the top and bottom sections are moved between open and closed configurations manually but that in some other embodiments they may be moved by an automated mechanism,

The housing of luggage smart clip 100a has an electronic lock which is configurable to allow the top section and bottom section to be securely retained and locked together in the closed configuration. The lock is incorporated in the distal first ends of the respective top and bottom sections.

The lock is configured to activate electronically and lock the top section and bottom section in the closed configuration together in response to receiving lock signals. In some situations, the lock is configured to self-actuate in response to the top and bottom sections being closed together. The lock is configured to activate electronically and unlock the top section from the bottom section in response to receiving unlock signals.

Unlock/lock signals are sent to the lock when predetermined unlock/lock conditions being meant. The unlock/lock signals can for example be sent according to any one or combination of the following conditions: a particular detected luggage status, a user ID/authentication, a particular status of one of the devices of the smart luggage device (such as a device failure), particular travel information associated with the luggage, actuation of the quick release button.

In some embodiments, the processing devices are configured to control the electronic lock according to the predetermined unlock/lock condition settings. The predetermined unlock/lock condition settings are retrievable from one or more user application accounts associated with the luggage to which the luggage smart clip is attached. In some embodiments, these predetermined unlock/lock condition settings are accessed wirelessly and sent to the smart luggage clip where a local processing device sends unlock/lock signals to the electronic lock based on the received predetermined control settings. Additionally or alternatively, in some embodiments, the unlock/signals are generated remotely based on the predetermined control settings and received wirelessly by the luggage smart clip and sent to the electronic lock.

The electronic lock is an electro mechanical lock. In some other embodiments, other types of electronic locks may be employed. The electro mechanical lock comprises a bolt system and tongue and port system. In some other embodiments, other types of electro mechanical locks may be employed. The bolt system is configured to lock the top section with the bottom section by engaging tongue slots of the tongue of the tongue and port system. The bolt system is configured to release the top section from the bottom section by disengaging from the tongue slots. The bolt system is configured to activate electronically and engage with the tongue slots in response to receiving a lock signal. The bolt system is configured to deactivate electronically and disengage from the tongue slots in response to receiving unlock signals.

The slotted tongue system comprises a tongue extending from the distal first end of the top section and a corresponding tongue port disposed on the corresponding distal end of the bottom section and configured to receive the tongue. An electronically activated bolt system inside the port is configured to engage slots and lock the tongue to the port when the tongue is inserted to the desired position in the port and the bolt system is activated by the lock/unlock signals. The bolt system in the port has rods or tabs that are configured to engage corresponding tongue slots and secure the tongue to the port in position. In some embodiments, the tongue extends from the distal first end of the bottom section and the port is incorporated into the distal first end of the top section. The lock then retains the tongue in place at the desired position.

The bolt system is configured to activate electronically and engage the slots in response to receiving the lock signals. The bolt system is configured to activate electronically and disengage from the slots in response to receiving the unlock signals to thereby release the top section from the bottom section. The release button is configured to be actuated manually. The release button is located on the exterior of the left and right sidewalls of the bottom section distal first end but in other embodiments may be arranged in other locations on the housing. The release button is configured to be actuated manually and permits the bolt system to lock/unlock the top and bottom section upon actuation provided predetermined lock/unlock conditions are met. The processing devices are configured to control the bolt system according to the predetermined unlock/lock condition settings.

The release button is located on the exterior of the left and right sidewalls of the bottom section distal first end but in other embodiments may be arranged in other locations on the housing.

The lock also serves as an adjustable clip mechanism that allows the size of the luggage smart clip to be adjusted. The slotted tongue and port system is configured such that the position in which the top and bottom sections fit and retain together in the closed configuration can be adjusted. The size of the pass-through hole formed by the top and bottom section in the closed configuration can be widened or narrowed by adjusting the top and bottom section retaining position accordingly. In this manner, the tongue and port system enables the smart luggage clip to be adjusted so that clip can fit around different size handles.

The tongue has multiple slots spaced lengthwise. The bolt system upon activation is configured to selectively engage the slots at a particular position along the length of the tongue according to where the tongue is positioned in the port. The bolt system can be activated manually and/or be self actuating to engage the slots in response to the tongue being received in the port and assuming the unlock/lock predetermined lock/unlock conditions have been meant, if any. The activated bolt system then retains the tongue in place at the desired position.

It will be appreciated that in some embodiments, the lock mechanism may not serve as an adjustable clip mechanism (be non-adjustable) but still serve to secure the top section and bottom section together in the closed configuration.

Yet furthermore, it will be appreciated that the bolt system and tongue and port may serve as a fastener mechanism that serves to fasten and release the top and bottom sections but which is not “locked” that is, the top and bottom sections may be secured together in the closed configuration but may be freely opened or closed manually without user authentication or meeting other predetermined unlock/lock conditions.

In some other embodiments, adjustable clip mechanism other than the tongue and port lock may be used. For example, such adjustable clip mechanism may be but not limited to adjustable fastener mechanisms, expandible hinge mechanisms, or telescopic top and/or bottom section mechanisms.

Reference will now be made in more detail to the other devices incorporated in the clip sections of the clips of FIGS. 1 to 6C. It would be appreciated that in some embodiments any one or combination of the devices described may be incorporated in any one or combination of the other smart clips/tags or other clip accessory devices disclosed herein. As indicated in the schematic of FIG. 29, devices incorporated in the movable clip sections are but not limited to luggage sensor(s) luggage security device(s), power device(s), wireless connectivity devices, location/positioning systems and any of the processing device(s) and associated memory. In the embodiment of the smart clips shown in the accompany the devices are distributed among both the moveable sections. However, as already explained above, some other embodiments, the electrical and/or mechanical hardware may be incorporated in only one of the clip sections.

As indicated in the device system diagram of FIG. 29, the wireless connectivity devices, luggage sensors, luggage alert signalling devices, and luggage security systems, are operably connected via electrical and/or wireless connections to power devices, processing device(s) and memory.

Referring to the sensor system block diagram of FIG. 30, the wireless connectivity devices comprise cellular, Wi-Fi, wireless personal area network (WPAN), RF & RFID, near field (NFC), and ultra-wide band (UWB). WPAN is a PAN carried over a low-powered, short-distance wireless network technology such as IrDA, Wireless USB, Bluetooth or Zigbee.

The luggage smart clip sensors are configured to detect different luggage status of the luggage to which the smart luggage clip is attached and the environment in which the luggage is located. Referring to the sensor system block diagram of FIG. 31, the luggage sensors may comprise camera, location & positioning sensors, orientation, motion, Shock (Accelerometer), infra-red altitude/pressure, temperature humidity, and microphone. Examples of these sensors according to some embodiments comprise a Multi Lens Camera (Day and Night Vision) camera 120, a Motion/Orientation/Shock (Accelerometer), Gyroscope, Magnetometer/Compass, Altitude/Pressure, Temperature & Humidity, Microphone 142 (Two-way communications and audio-video recording/streaming).

The alert signalling devices incorporated in the smart luggage device and configured to activate audio, visual, mechanical or other signalling in response to signalling device triggers. As indicted in the signalling device system diagram of FIG. 32, the alert signal signalling devices comprise lights, flash light, infra-red light, visual assistant, display and speaker. Examples of these signalling devices according to some embodiments comprise Lights (IR lights, Flash light and Multi-Color LED lights), and speakers 140 (Alarm & Audio Alerts). The visual assistant and/or display in some embodiments is configured to provide instructions to the luggage handler on how to manage the bag according to the triggered alerts, alert notifications, itinerary updates and so forth.

As indicated in the luggage security system diagram of FIG. 33, the luggage security systems may comprise an electric lock, ID/Authentication devices and communication security. The electric lock comprises an electromechanical lock described above in conjunction with wireless connective devices controlling the lock. The ID authentication devices comprise Passcode and/or Password authentication devices and/or one or more biometric devices. The communication security system comprises end-to-end wireless data encryption. The luggage security systems are configured to operate in conjunction with the other devices including the luggage alert signalling devices. Examples of these luggage security devices according to some embodiments comprise Electro-mechanical wireless Locking System (tongue with locking slots 108, adjustable tongue locking port 110 in conjunction with wireless electric lock), On-Device Fingerprint Reader, Passcode and/or Password and/or Fingerprint and/or Face ID (via a connected device), and End-to-end wireless data encryption

Power sources themselves, such as batteries, are operably connected to the luggage security device(s), electronic lock, digital display and wireless connectivity device(s) and processing device(s). Power connectors are configured to interconnect external power source(s) with the battery and/or other devices incorporated in the smart clip so as to power the battery and/or device(s). As shown in the power device systems diagram of FIG. 35, the power devices comprise rechargeable battery, solid state battery, power & data ports, wireless inductive power device(s), and power management devices. Examples of these power devices according to some embodiments comprise Batteries (Rechargeable and/or Solid state Replaceable, Inductive Power Charging, USB/Micro USB or other wired data networking and power charging port.

As shown in the location/position system diagram of FIG. 34 the location/positioning systems comprise satellite-based radio navigation, peer-to-peer positioning, Wi-Fi positioning, in-door positioning, directional signal strength, beacon positioning, networking, location and relational positioning systems. In some other embodiments, one or more of these the location/positioning systems maybe omitted and/or one more other types of location/positioning systems may be adopted. Examples of these location/position systems according to some embodiments comprise Cellular (4G & 5G Broadband Wireless Wide Area Networking & Cell Tower Positioning), Wi-Fi-Wi-Fi Peer to Peer, Wi-Fi hot spot and Wi-Fi Internet Uplink, Bluetooth/Low-Power Bluetooth (LPB)—(low power indoor & outdoor Peer to Peer, Networking, location and Relational Positioning and data transfer, alerts, ID & Security, NFC-Near Field Communication for rapid device pairing, Identification & User Verification, UWB-Ultra-wideband-Ultra low energy-time of flight location positioning), RFID (Active & Passive Radio-frequency Identification), GPS (Global Positioning System) outdoor location tracking and satellite positioning.

The smart clip is configured to be pre-programmable with software prior to use to enable the SmartClip to perform basic functionality without requiring remote control, that is, access to remote memory to store instructions/data and/or processors to execute the software instructions. Such basic functionality may be but not limited to tracking, monitoring, networking, controls and security functionality and applications using limited direct wide area networking and Internet uplink capabilities such as Bluetooth technology or other low power technologies prior to use. By way of example, in some embodiments, the clip is configured to be pre-programmed, for example by the smart clip provider platform and/or airline platform. Such provider platform and/or airline or other third-party platform may be interfaced via a mobile app prior to flight or travels, to perform desired functionality configurations.

The pre-programmed configurations are stored on the SmartClip for execution by the processing device. Such pre-programming and storing of the functionality configurations locally on the SmartClip enables the clip to perform tasks assigned autonomously with limited direct remote control or commands by the user. The smart clip is configured to perform some tasks like User ID and Security verification via wireless connection such as but not limited to Bluetooth pairing for example upon receipt of luggage at the end of the flight.

Pre-programming of the smart clip is achieved by configuring the clip memory to store software instructions and data which when executed by the clip processing device(s) cause the processing device to control the luggage smart clip devices to perform the desired clip functionality.

In some embodiments of the smart clip, in addition to software being executed and stored locally for autonomous local control of one or more of the clip devices, the smart clip is configured to receive software instructions and data remotely which are stored in remote memory and/or executed remotely to enable the SmartClip to perform advanced processing. Such advanced processing may be related to real time location positioning, encryption, authentication and real time image processing etc. In some embodiments, some processing and/or data may be performed via the luggage cam user app and/or a third party application such as but not limited to an airline logistics software application.

FIG. 36 illustrates a components of the software according to some embodiments for use with any one or more of the embodiments of the smart clip/tags and/or associated remote systems described herein. The software can be stored in memory and in one or more processing devices of the smart clip/tags and/or servers or other remote devices. It will be understood that in some other embodiments, additional components other than those shown may be employed and/or that any one or more of the components may be omitted.

One component of the software is an alert notification generator component which is configured to generate notification alerts in response to alert notification triggers. An alert notification trigger component defines the alert notification triggers that trigger the alert notification generator. Examples of sensor triggers are but not limited to triggers corresponding to predetermined luggage status, such as unapproved or approved location, position, user ID and authentication of a luggage handler etc., other conditions associated with the luggage to which the luggage smart clip is assigned and attached, or the associated environment, travel itinerary updates associated with the luggage. The alert notification triggers may comprise output signal(s) from any one or combination of: one or more other sensors, wireless connectivity device(s), luggage security devices, alert signalling devices, location/positioning systems, power device(s) and processing device(s) or other signals received locally and/or wirelessly.

Alert notification triggers may be output signal(s) from any one or combination of: one or more other sensors, wireless connectivity device(s), luggage security devices, alert signalling devices, location/positioning systems, power device(s) and processing device(s) or other signals received locally and/or wirelessly.

The Alert notifications generator component of the software is configured to send triggered alerts to electronic contact details of mobile or other electronic devices associated with assigned users and/or other recipients. The Alert notifications generator component can be configured to send triggered alerts to specific devices of the clip. The alert notifications generator can be configured to selectively send triggered alerts to particular assigned users and/or clip devices according to the particular alerts triggered.

A luggage alert signalling device trigger component of the software is configured to activate audio, visual, mechanical or other signalling incorporated in the smart luggage device in response to signalling device triggers. Examples of alert signalling device triggers are but not limited to triggers corresponding to luggage status, such as unapproved or approved location, position, luggage open, luggage closed, user ID and authentication of a luggage handler etc., other conditions associated with the luggage to which the luggage smart clip is assigned and attached, or the associated environment, travel itinerary updates associated with the luggage. The luggage alert signalling triggers may be configured to selectively trigger particular luggage alert signalling devices and/or functions thereof according to the particular triggers. The alert signalling device triggers may comprise output signal(s) from any one or combination of: one or more of the sensors, wireless connectivity device(s), luggage security devices, other alert signalling devices, location/positioning systems, power device(s) and processing device(s) or other signals received locally and/or wirelessly.

A sensor trigger component of the software is configured to trigger the luggage smart clip sensors according to sensor triggers to sense different luggage status of the luggage to which the smart luggage clip is attached and the environment in which the luggage is located.

Examples of sensor triggers are but not limited to triggers corresponding to luggage status, such as unapproved or approved location, position, luggage open, luggage closed, user ID and authentication of a luggage handler etc., other conditions associated with the luggage to which the luggage smart clip is assigned and attached, or the associated environment, travel itinerary updates associated with the luggage. The sensor triggers may be configured to selectively trigger particular sensors and/or sensor functions according to the particular triggers. The sensor triggers may comprise output signal(s) from any one or combination of: one or more other sensors, wireless connectivity device(s), luggage security devices, alert signalling devices, location/positioning systems, power device(s) and processing device(s) or other signals received locally and/or wirelessly.

An authentication trigger component of the software is configured to trigger the clip authentication device(s) according to particular authentication triggers and rules. Examples of authentication triggers are but not limited to triggers corresponding to luggage status, such as unapproved or approved location, position, luggage open, luggage closed, user ID and authentication of a luggage handler etc., other conditions associated with the luggage to which the luggage smart clip is assigned and attached, or the associated environment, travel itinerary updates associated with the luggage. The authentication triggers may be configured to selectively trigger particular authentication device and/or authentication functions according to the particular triggers. The authentication triggers may comprise output signal(s) from any one or combination of: one or more of the sensors, wireless connectivity device(s), the luggage security devices, the alert signalling devices, location/positioning systems, power device(s) and processing device(s) or other signals received locally and/or wirelessly.

A locks trigger component of the software is configured to trigger the electric clip housing lock to lock the housing to or unlock the housing from the luggage according to particular lock triggers and rules. Examples of electric lock triggers are but not limited to triggers corresponding to luggage status, such as unapproved or approved location, position, luggage open, luggage closed, user ID and authentication of a luggage handler etc., other conditions associated with the luggage to which the luggage smart clip is assigned and attached, or the associated environment, travel itinerary updates associated with the luggage. The lock triggers may be configured to selectively trigger particular locks and/or lock functions according to the particular triggers. The lock triggers may comprise output signal(s) from any one or combination of: one or more of the sensors, wireless connectivity device(s), the luggage security devices, the alert signalling devices, location/positioning systems, power device(s) and processing device(s) or other signals received locally and/or wirelessly.

A power operation component of the software comprises control instructions and triggers for controlling and triggering power sources and/or power connectors. Examples of power operation triggers are but not limited to triggers corresponding to luggage status, such as unapproved or approved location, position, luggage open, luggage closed, user ID and authentication of a luggage handler etc., other conditions associated with the luggage to which the luggage smart clip is assigned and attached, or the associated environment, travel itinerary updates associated with the luggage. The power triggers may be configured to selectively trigger particular power devices and/or functions thereof according to the particular triggers. The power operation triggers may comprise output signal(s) from any one or combination of: one or more of the sensors, wireless connectivity device(s), the luggage security devices, the alert signalling devices, location/positioning systems, power device(s) and processing device(s) or other signals received locally and/or wirelessly.

A location/positioning component of the software comprises location/positioning control instructions and triggers for controlling the location/position sensors and part or all of the associated location/position system. Examples of location/position system operation triggers are but not limited to triggers corresponding to luggage status, such as unapproved or approved location, position, luggage open, luggage closed, user ID and authentication of a luggage handler etc., other conditions associated with the luggage to which the luggage smart clip is assigned and attached, or the associated environment, travel itinerary updates associated with the luggage. The location/positioning component triggers may be configured to selectively trigger particular location/positioning systems and/or functions thereof according to the particular triggers. The location/position triggers may comprise output signal(s) from any one or combination of: one or more of the sensors, wireless connectivity device(s), the luggage security devices, the alert signalling devices, location/positioning systems, power device(s) and processing device(s) or other signals received locally and/or wirelessly.

A geo fence component of the software comprises geo fence control instructions, data and triggers for controlling geo fencing of the clip. Examples of geofence triggers are but not limited to triggers corresponding to luggage status, such as unapproved or approved location, position, luggage open, luggage closed, user ID and authentication of a luggage handler etc., other conditions associated with the luggage to which the luggage smart clip is assigned and attached, or the associated environment, travel itinerary updates associated with the luggage. The geo fence component triggers may be configured to selectively trigger particular geofences according to the particular triggers. The geofences triggers may comprise output signal(s) from any one or combination of: one or more of the sensors, wireless connectivity device(s), the luggage security devices, the alert signalling devices, location/positioning systems, power device(s) and processing device(s) or other signals received locally and/or wirelessly. The particular geofence data and parameters may comprise geo fence data and parameters retrievable or indexable according to location (coordinates), the place (name of place on a map) and or some other location parameter.

A wireless connectivity component of the software comprises wireless connectivity control instructions and triggers for controlling the clip wireless connectivity. Examples of wireless operation triggers are but not limited to triggers corresponding to luggage status, such as unapproved or approved location, position, luggage open, luggage closed, user ID and authentication of a luggage handler etc., other conditions associated with the luggage to which the luggage smart clip is assigned and attached, or the associated environment, travel itinerary updates associated with the luggage. The lock triggers may be configured to selectively trigger particular locks and/or lock functions according to the particular triggers. The wireless connectivity triggers may be configured to selectively trigger particular wireless connectivity functions according to the particular triggers. The wireless operation triggers may comprise output signal(s) from any one or combination of: one or more of the sensors, wireless connectivity device(s), the luggage security devices, the alert signalling devices, location/positioning systems, power device(s) and processing device(s) or other signals received locally and/or wirelessly.

In some embodiments, software may be stored and executed locally in the clip itself for preforming at least some operations on the devices on the clip when the clip is not capable of remote control by accessing remote memory and/or executing instructions on one or more remote processing device(s) resulting in at least some remote control of the clip (wireless and/or electrically). In some embodiments, a user may set particular operations, triggers, data of the software via a user account of a software application associated with the owner, the luggage smart clip provider and/or authorized handler of the luggage. By way of example, in some embodiments some or all of the software may be stored and/or executed via a provider platform 950 (luggage smart clip system provider platform) as shown in FIG. 19. The provider platform 950 software comprises an analysis engine 912, API 916, database 918, AI module 914, web and mobile interface 920 and apps 922 (for example smart clip/smart tag web app accessible via mobile devices 801-803). The provider platform hardware comprises a computer server 910 or other suitable computing system. The AI module is configured to learn how to optimise smart clip/tag devices to perform specific tasks. It will be appreciated that the provider platform is not limited to the implementation shown in FIG. 19 in which the provider platform interacts with mobile phones, airport servers and aircraft.

The software, when executed on the processing device(s) causes the smart clip and/or provider platform to send authorized user or users assigned to a SmartClip via mobile devices, or other electronic devices associated with the users, updates and alerts as to the luggage status. For example, in some embodiments, luggage status may be location and sensor status throughout the flight or other travel means. The smart clip and/or provider platform may be configured by the software to send authorised or assigned users via their associated mobile or other electronic devices real-time tracking data and real-time alerts regarding location, sensor and security status, such as for example when an alarm is triggered or a bag is outside of its assigned flight path, travel area or was picked up. When multiple people are given access to a single clip, they will all receive real time updates via the mobile app.

In yet other embodiments, instead of the smart luggage clip housing for the luggage security devices itself serving as the clip, the smart luggage clip is attachable to the luggage by means of a clip or other releasable attachment that is instead connected to or integrated with the housing incorporating the luggage security devices.

FIG. 53 is a diagrammatic representation of a machine in the form of a computer system which is an example suitable computing or processing device environment within which to implement aspects of the present technology. A set of instructions for causing the machine to perform any one or more of the methodologies discussed herein may be executed within the computer system. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment or any other configuration as described herein with reference to any of the embodiments. The machine may any type of device described and/or shown herein in any of the accompany drawings or a robotic construction marking device, a base station, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The embodiment of the computer system 1 includes a processor or multiple processors 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processors 5 during execution thereof by the computer system 1. The main memory 10 and the processors 5 may also constitute machine-readable media.

The instructions 55 may further be transmitted or received over a network via the network interface device 45 utilizing any one of a number of well-known transfer protocols (e.g., Hyper Text Transfer Protocol (HTTP) etc.). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Not all components of the computer system 1 are required and thus portions of the computer system 1 can be removed if not needed, such as Input/Output (I/O) devices (e.g., input device(s) 30). One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

According to some aspects, the methods of operating the smart clip/tags or other smart devices described herein will now be described in more detail with reference to the figures.

FIGS. 41 to 51 illustrate various methods of operation according to some aspects and embodiments for at least one luggage smart clip, at least one luggage smart tag, and/or at least one other luggage smart clip accessory device. It is envisaged that these methods may be implemented in other types of smart devices or systems disclosed herein other than the luggage smart clips. One or more of the steps in each figure may be omitted or the sequence of the steps may be rearranged as appropriate.

### Example Implementations

The following is a description of some embodiments with respect to the luggage smart clip of FIGS. 1A-6C and their various uses and clip accessory devices shown in the accompanying figures. However, it will be understood that anyone or combination of components and functionalities described with reference to these embodiments may be adopted in any one of the embodiments of the smart clip, smart tag accessory (which may be a smart tag, smart zip lock or other device designed to fit and lock with the smart clip/tag) or other smart device described herein and/or in the other accompanying figures.

### 5 SmartClip Embodiments

1. Embodiment 1 Basic Clip (No Cameras) (Low Power Bluetooth-LPB, UWB & RFID)
2. Embodiment 2 Single Lens Camera with Finger Print Reader (Embodiment 1+Wi-Fi)
3. Embodiment 3 Multi Lens Camera with Combo Lock (Embodiment 2+Cellular & GPS)
4. Embodiment 4 Multi Lens Camera with Display (Same as Embodiment 3)
5. Embodiment 5 Multi Lens Camera with Display & Combo Lock (Same as Embodiment 3)

### 5 SmartTag Embodiments

1. Embodiment 1 Removable SmartTag w/Camera & Case (Wi-Fi, Bluetooth & RFID)
2. Embodiment 2 SmartTag incorporated into Case with Camera (Wi-Fi, Bluetooth & RFID)
3. Embodiment 3 SmartTag Incorporated into Case No Camera (Wi-Fi, Bluetooth & RFID)
4. Embodiment 4 SmartTag No Case with Camera (Wi-Fi, Bluetooth & RFID)
5. Embodiment 5 SmartTag No Case with No Camera (Bluetooth Only & RFID)

### 1 SmartLock Embodiment

1. Embodiment 1 SmartLock with Digital Lock, Combo Lock & TSA key (Bluetooth Only)

### Smartclip Embodiment 1—Basic Smartclip—Page 1 (FIGS. 1A, 1B, 1C & 1D)

### Networks

Bluetooth and/or Low Power Bluetooth (LPB)
UWB (Ultra-wideband)
RFID (Radio-frequency Identification) (Active and Passive)

### Sensors

Motion/Orientation/Shock (Accelerometer)
Gyroscope
Magnetometer/Compass
Altitude/Pressure
Lights
Speakers (Alarm & Audio Alerts)

### Power

Batteries (Rechargeable and/or Solid state Replaceable
Inductive Power Charging
USB/Micro USB or other wired data networking and power charging port

### Security

Electro-mechanical wireless Locking System
Passcode and/or Password and/or Fingerprint and/or Face ID (via a connected device)
End-to-end wireless data encryption
Light & Audio Alarm and Alerts

### Networking, Location Tracking & Positioning

The basic Smart Clip may be tracked using one or more of the following wireless tracking protocols, methods and systems.

Bluetooth/Low-Power Bluetooth (LPB)—(low power indoor & outdoor Peer to Peer Networking, location and Relational Positioning and data transfer, alerts, ID & Security. UWB-Ultra-wideband-Ultra low energy-time of flight location positioning) RFID (Active & Passive Radio-frequency Identification)

The clip uses Ultra-wideband low energy time of flight positioning for most of its location and positioning and also incorporates active and passive RFID to work with existing airline and airport RFID baggage tracking systems. The SmartClip incorporates both Active and Passive RFID in case of complete loss of internal power from its primary rechargeable and back up solid-state replaceable batteries.

The Basic SmartClip also incorporates Bluetooth tracking and positioning systems including Bluetooth Radio Transmitter Location System (RTLS) using directional signal strength positioning In which each SmartClip transmits its current location and received directional signal strength from other Bluetooth enabled Clips, Tags and devices and fixed location Bluetooth Beacons and Received Signal Strength Indicator (RSSI) positioning where Bluetooth beacons assigned to fixed locations in an airport, hotel or other mapped space have been incorporated into the SmartClip network and can report back to the mobile app the precise location and relational position of one or more Smart Clips in a mapped area. When fixed Bluetooth Beacons are not available, Each Smart Clip may also identify its location by networking with one or more surrounding Smart Clips and other mobile Bluetooth enabled devices that may also incorporate location data from additional wide, local and satellite positioning systems and protocols such as cellular, Wi-Fi and GPS.

The SmartClip is designed to use the most power efficient networking and location tracking method (UWB and RFID) at all times except when more accurate methods or data transmission is required such as a travel, sensor or security alert. Bluetooth is used primarily for specified tasks such as peer-to-peer networking and pairing with other devices, locking/unlocking the SmartClip, user ID/Security, mobile alerts, alarm, and other peer-to-peer wireless transactions and for location identification and peer-to-peer positioning.

Bluetooth Peer-to-peer positioning may be used when two or more Smart Clips are paired, networked and grouped together for example if a family or sports team is traveling with two or more bags going to the same location, the Smart Clips on all of the bags may be geofenced together so that if a SmartClip on one of the bags in the group is moved for than a set distance such as 50 or 100 feet from the other grouped devices a mobile alert or alarm may be triggered.

### Sensors & Functionality

The Basic SmartClip Incorporates an accelerometer, gyroscope, altimeter, magnetometer and compass, muti-color lights/light strips and a speaker.

NOTE: Because the basic SmartClip has more limited direct wide area networking and Internet uplink capabilities than the other SmartClip device embodiments, many of the desired SmartClip tracking, monitoring, networking, controls and security functionality and applications must be pre-programmed by the user via the mobile app prior to flight or travels and stored on the SmartClip. The SmartClip will then be expected to perform the tasks assigned autonomously with limited direct remote control or commands by the user with the exception of User ID and Security verification via Bluetooth pairing upon receipt of luggage at the end of the flight. The authorized user or users assigned to a SmartClip will receive updates and alerts as to the bags location and sensor status throughout the flight or other travels and will receive real-time tracking data and alerts regarding location, sensor and security status such as when an alarm is triggered or a bag is outside of its assigned flight path, travel area or was picked up. When multiple people are given access to a single clip, they will all receive real time updates via the mobile app.

In the basic SmartClip embodiment remote device controls are limited to Bluetooth and are primarily focused on in-person local device networking User ID and Verification, Device Locking and unlocking and lights, audio alarm and alerts activation, de-activation, settings and controls.

In addition to continuously tracking location, the basic model also incorporates security features such as geofencing, motion, shock and tamper monitoring, audio and light alerts and alarm.

For example, when the SmartClip identifies (on its own) that it is located in an authorized baggage pick up area using pre-programmed flight and travel itinerary maps of airports and real-time location data. Or via Bluetooth notification when a SmartClip connects with a fixed Bluetooth beacon in an airport baggage area. The Smart Clip may be programmed to flash its lights in a specific color and flashing sequence to identify itself to the owner.

Light and Audio alerts may also be pre-programmed by the owner, airline or company in charge of shipping the bags so that when a bag is picked-up in an authorized baggage claim area. A SmartClip may be programmed to flash red lights if it is in the wrong baggage claim area or there has been a change in the baggage and traveller flight itinerary to alert airline personnel that the bag should be picked up and moved to the correct location or delivered to the traveller. An airline may have direct access to both the bag location and traveller location data and may be alerted if they are separated or outside of a defined geofenced area.

Audio alerts may also be programmed such as the SmartClip may state the name of the owner and/or request that person picking up the bag with the SmartClip identify themselves as the correct owner of the bag. If the owner fails to identify themselves within a specified amount of time and/or after a specified number of requests or the person who picked up the bag attempts to walk away with the luggage without identifying and verifying themselves to the SmartClip via the mobile app, then an audio alarm will go off and the lights will flash brightly to alert authorities that a theft may be in progress.

All of these tasks and actions may be performed by the basic embodiment of the SmartClip without direct wireless networking or real-time input and control by a user or users. Although one or more assigned users may receive real-time alerts via the mobile app.

A mobile alert may also be sent wirelessly with UWB using a basic code system attached to the location data to identify the different events such arrived at Baggage Carousel 3, Bag Picked-up, Alarm on etc. or the alert or may be sent via Bluetooth with real-time sensor data to the authorized device or devices assigned to the SmartClip through the mobile app. When an authorized user's device is connected with the SmartClip, and the user ID is verified, then the user may gain complete access (or limited access based on type of user) to control the Smart Clip and turn off the alarm and identify that they have received the alert or retrieved the bag.

### Power & Power Management

Smart Clip Embodiment 1 (All embodiments of the Smart Clip have both a rechargeable battery and a solid-state replaceable battery. The rechargeable battery is assigned to all Bluetooth peer-to-peer networking and higher power use tasks while the solid-state battery is assigned entirely to location tracking using Ultra-wideband and active RFID so that if the primary rechargeable battery runs out of power the Smart Clip location may always be tracked. In case of the solid-state battery running out of power, the rechargeable battery will take over powering the location tracking networking processes. When on flights, the Smart Clip may be required to go into flight mode and shut down its rechargeable battery networking services entirely and then re-start when the plane has landed and/or when the Smart Clip has been unloaded from the plane. The Smart Clip Embodiment 1 identifies that it is on the plane or in the vicinity of the plane using location tracking and pre-programmed geofenced gate and real-time location data and or real-time RFID and or Bluetooth alerts in the airport or on the plane. The Smart Clip embodiment 1 will also use its altitude and pressure sensor to identify that it is on the plane and/or in flight. In case of a complete power depletion or failure of the rechargeable battery, the solid-state battery may be used to power unlocking the device. In case of both battery failure, the device may be unlocked using a wired connection via the power and data port, pairing the Smart Clip with an authorized device such as a Smart phone, tablet, PC or other networked computing device running the mobile app and then performing user ID and security verification via the paired device and then once verified powering the Smart Clip lock via the paired device and unlocking the Smart Clip.

### Security & Locking System

SmartClip Embodiment 1 (Basic) incorporates a digital electronic Locking system which is controlled using a paired smartphone running the SmartClip mobile application once the SmartClip is wired or wirelessly paired with an authorized app enabled smart phone, tablet, computer or other Bluetooth enabled device using a Passcode and/or password ID and/or Fingerprint and/or Face ID phone unlock) or multi-layer user verification using smartphone and/or cloud system verification re-set code to Smart Clip via Bluetooth connection with a recognized smartphone). The SmartClip may also be physically connected to an external device in case of complete power failure using the SmartClip data/networking port.

The Security features listed below are standard for all of the SmartClip devices. The Basic Embodiment security features are limited to below.

All tracking and networking data is end-to-end encrypted with key encryption assigned to each user assigned and each Smart Clip. More than one user may be assigned to a single clip, although only one manager is assigned to each SmartClip to control the account. Each user assigned to a Smart Clip by a manager, may be given varying levels of access to SmartClip controls, functionality or settings on the Smartclip or may be assigned temporary access by the manager of the account with the key and access ending after a specified amount of time. For example, an airline may lease a SmartClip to one of their passengers. A passenger may pay to lease a SmartClip for a single flight or a purchase a longer lease for an entire vacation including round-trip air travel and may have complete access and control of the Smartclip for the entire duration of the trip and lease. When the lease ends and the clip is returned, the key is cancelled and the passenger or passengers assigned to the clip will no-longer have access the SmartClip. Once a key has been setup for each user and each SmartClip, each user may create a passcode to access one or more SmartClip devices and SmartClip accessory devices assigned to the user. Although each device requires a unique key for each user, a user may assign a passcode, password and/or one or more biometric Identification methods (fingerprint, Face ID, etc.) to more than one key and two or more devices in order to wirelessly track, monitor, manage and control multiple SmartClip devices and accessory devices at the same time on the mobile app.

When the Smart Clip is setup and is paired with a smartphone, the two or more SmartClip devices pair using the LuggageCam app and the user sets up a passcode and face ID, so if the user forgets their passcode they can have two or three layers of backup identification to unlock the SmartClip.

In case of forgotten password, a Reset program includes a key encryption code on both the SmartClip device and updated via the LuggageCam mobile app on the users phone which is paired via Bluetooth with the SmartClip. This process must be verified using multi-layer user ID such as email ID link and password reset and/or biometric ID on your smartphone which then authorizes a password re-set on the SmartClip via a real-time Bluetooth connection with an authorized mobile app enabled phone, tablet, PC or other wired or wireless computing device. This process may also be performed using the SmartClip data port to connect the SmartClip to a mobile app enabled phone, tablet, PC or other authorized computing device in case of complete battery failure. The same user ID and security authorization are required for a wired or wireless connection with a SmartClip.

### Grouping & Geofencing

Note: The below grouping functions are standard for all embodiments of the SmartClip device. In order to set up the system, the following set up procedure may be employed according to some embodiments to set up one or more of the smart clips/tags.

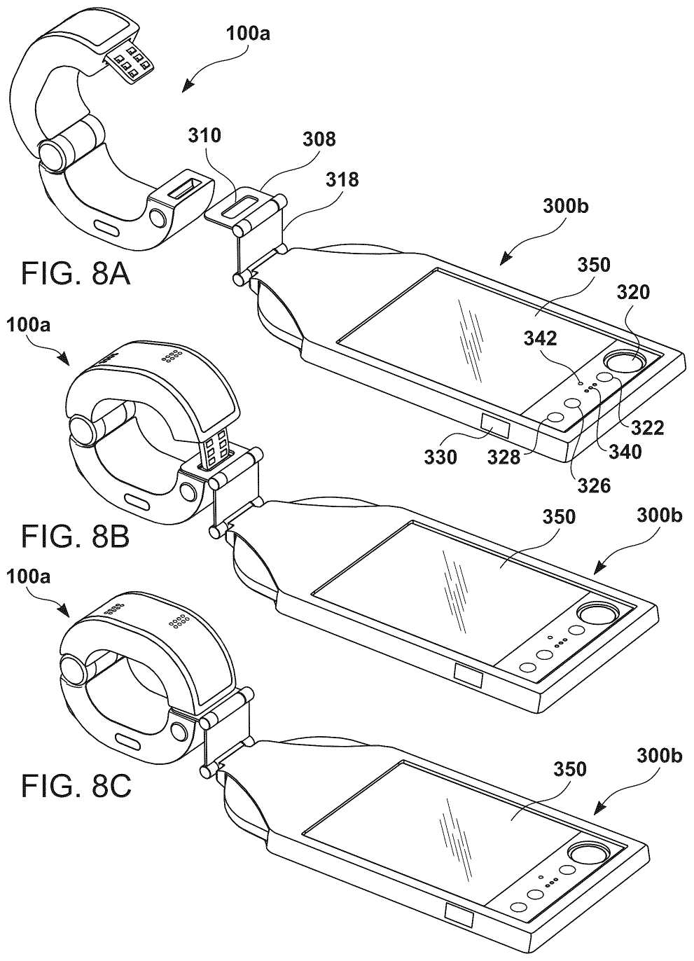

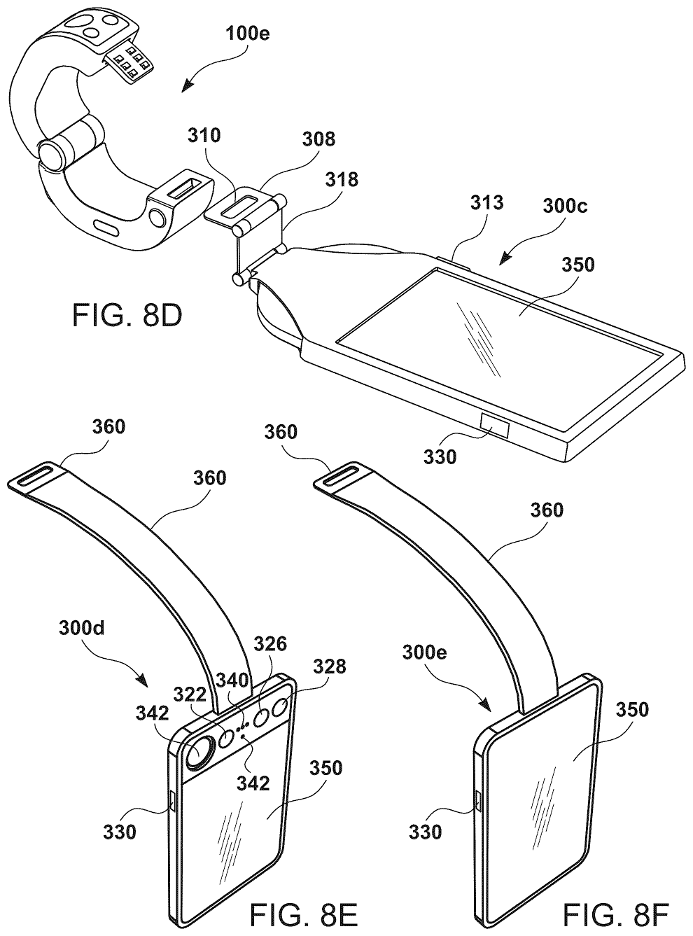

According to some embodiments, the smart device (smart clip, smart tag or other clip accessory device) can be set up as follows: 1. Set up user account on mobile app, 2. Activate the smart devices and associate the user account wirelessly or physically with smart devices. 3. Set up the authentication on the app to access the user account and smart devices, can assign different biometric authentication, 4. Assign different levels of authentication, different levels of management, where you can set up the alerts etc. 5. Assign different levels of control based on who is permitted to change the alerts or alert triggers, alert notifications etc. 6. Pair two or more devices by physically attaching and/or wirelessly connect them together. 7. Processing device in smart clip or tag etc. can make decisions on how to best optimize functionality among group of devices. (most power efficient to perform tasks etc.) eg in FIG. 8 smart clip is using lower power communications and starts doing that instead of the display tag that is going to use the same power to do the same thing. 1) smart clip does same funcitionality that display tag would do (hub) 2) clip is always the manger so if it cant do a function itself it will then go to the display tag to do it.

Just as multiple users may be securely assigned to track, access and control a single SmartClip, multiple Smart Clips may be assigned to a wired or wireless device group by an authorised user. This group may be a consist of a Single Smart Clip and a paired/attached accessory device such as the Smart Tag digital luggage tag and travel itinerary display and alert system accessory device and/or the Smart Lock zipper locking and security system accessory device. When a Smart Clip accessory device is physically attached and locked into the mouth of a SmartClip and wired and/or wirelessly paired with a Smart Clip, the Smart Clip and attached and paired/networked accessory device operate as a single device and system essentially expanding the functionality of the SmartClip to include the functionality of the attached accessory device or devices.

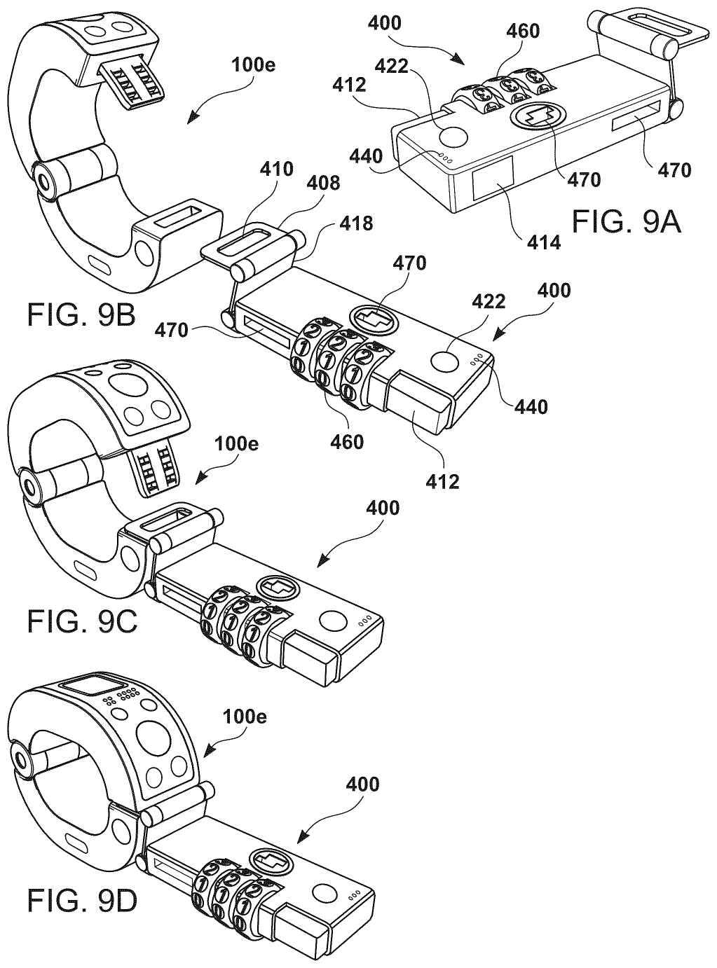

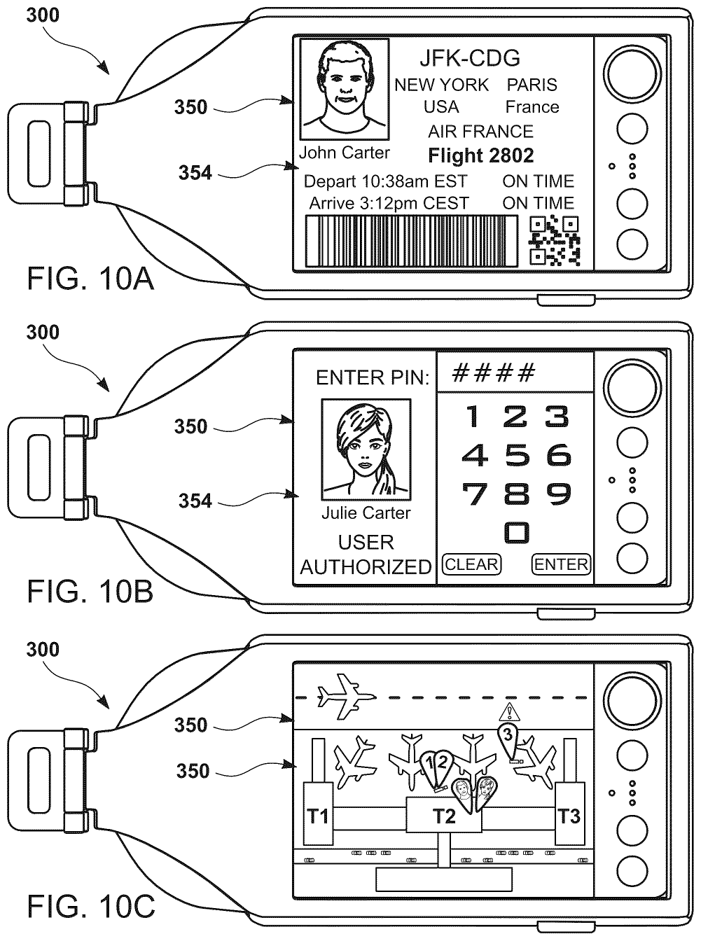

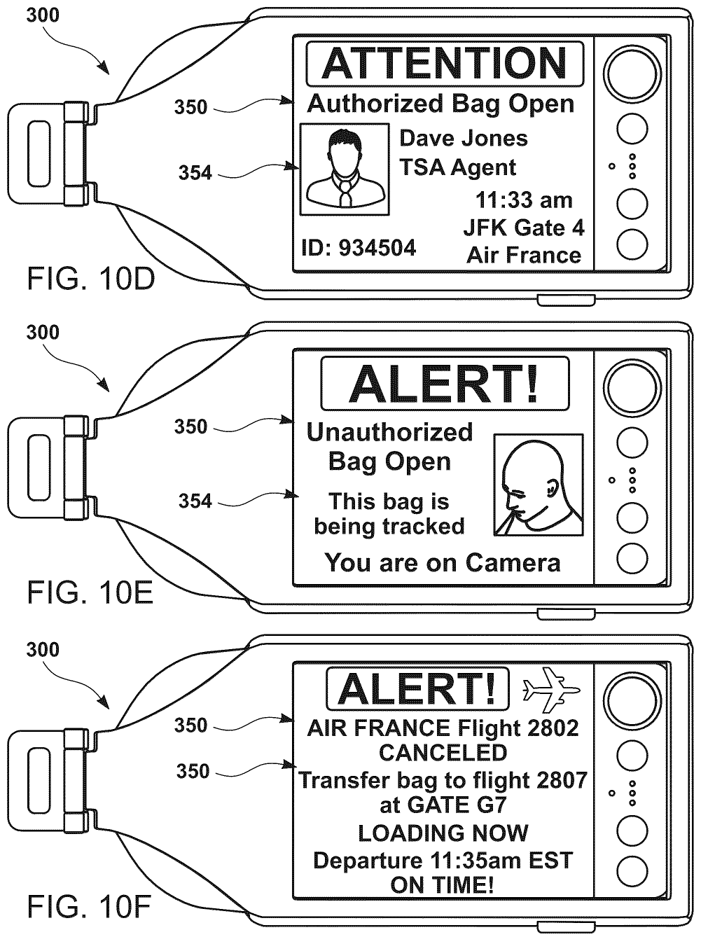

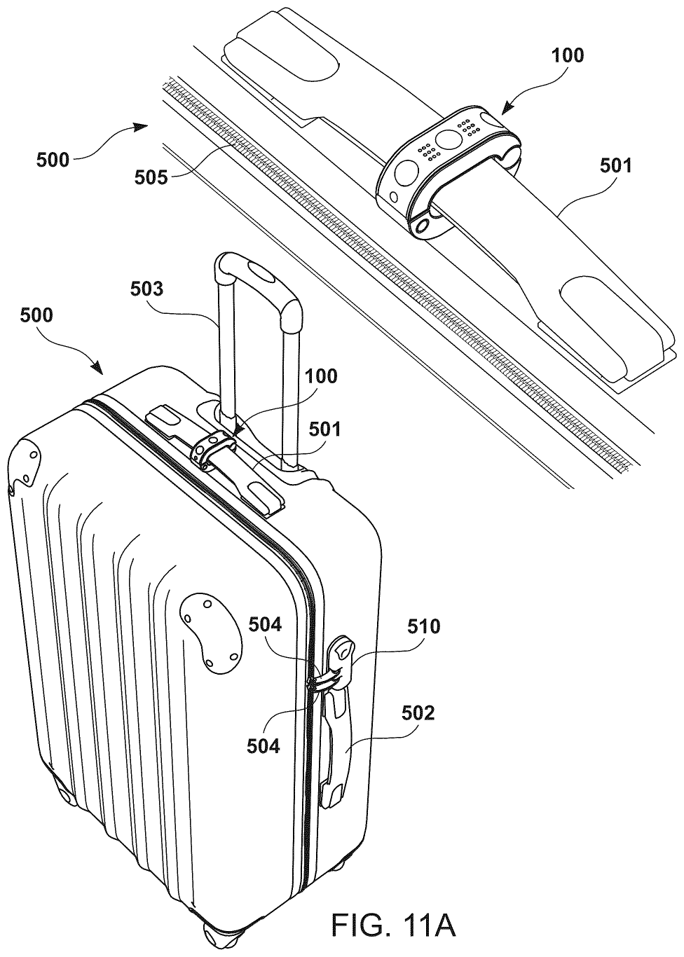

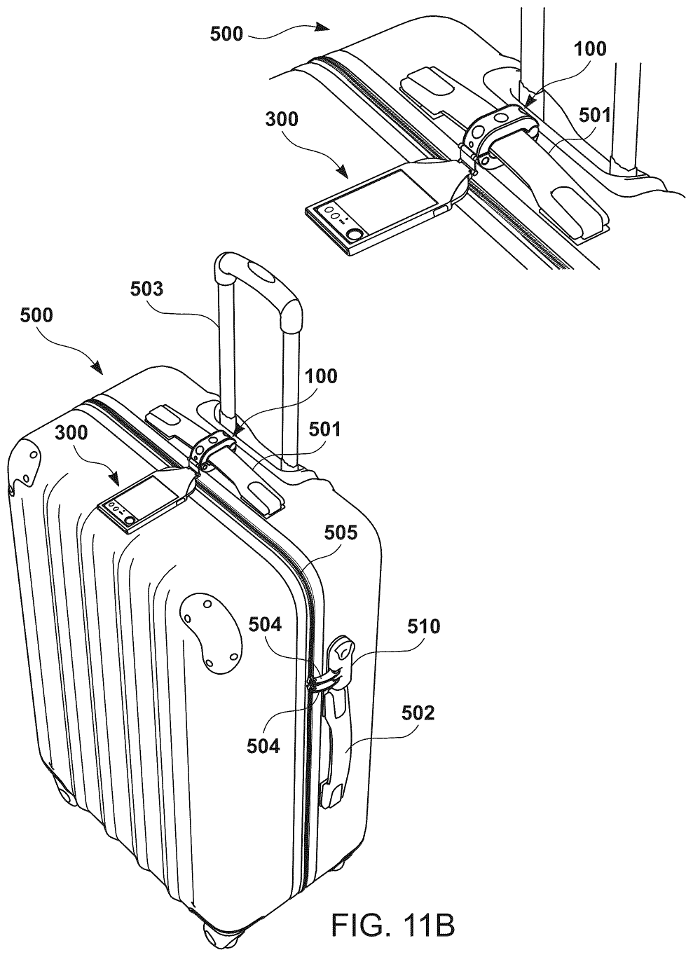

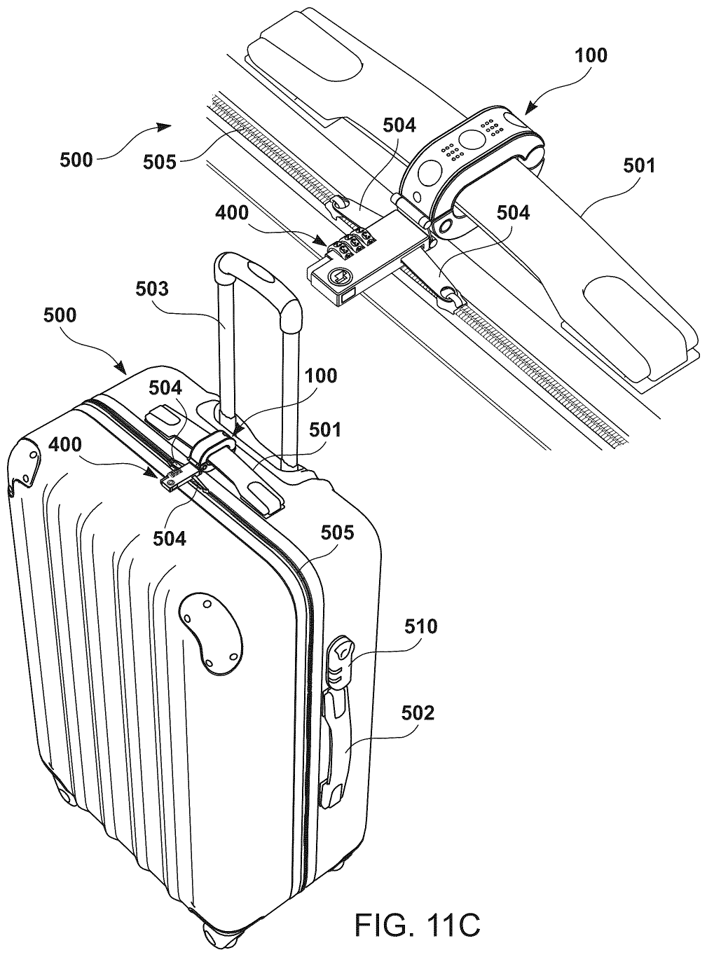

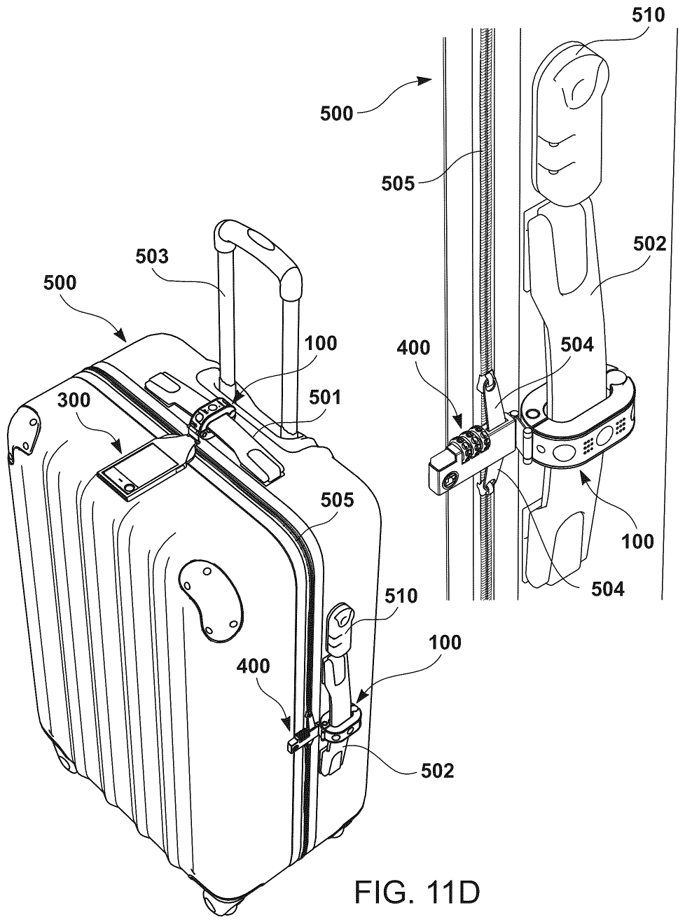

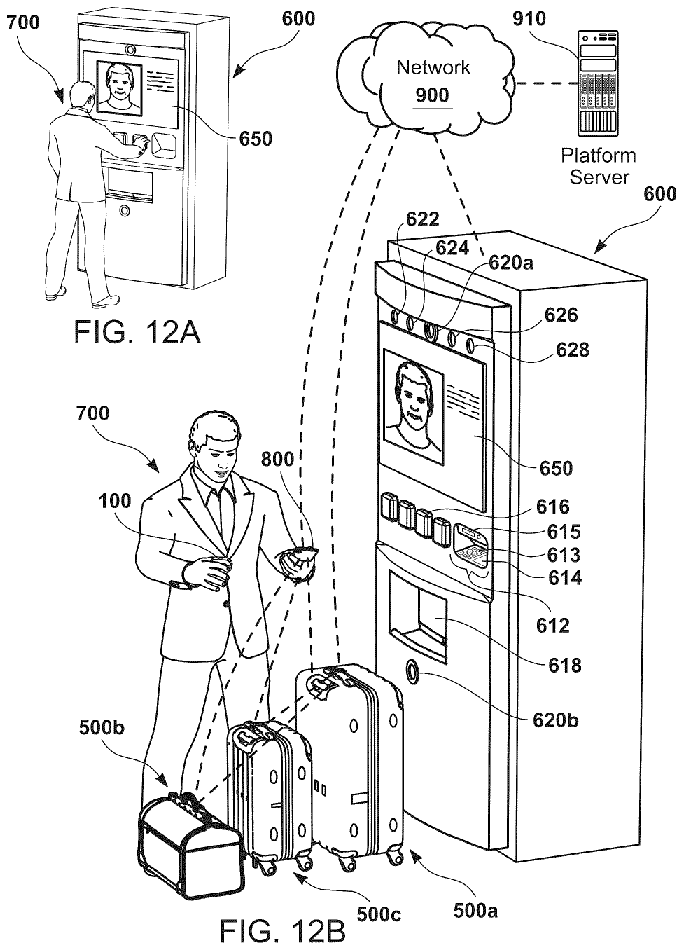

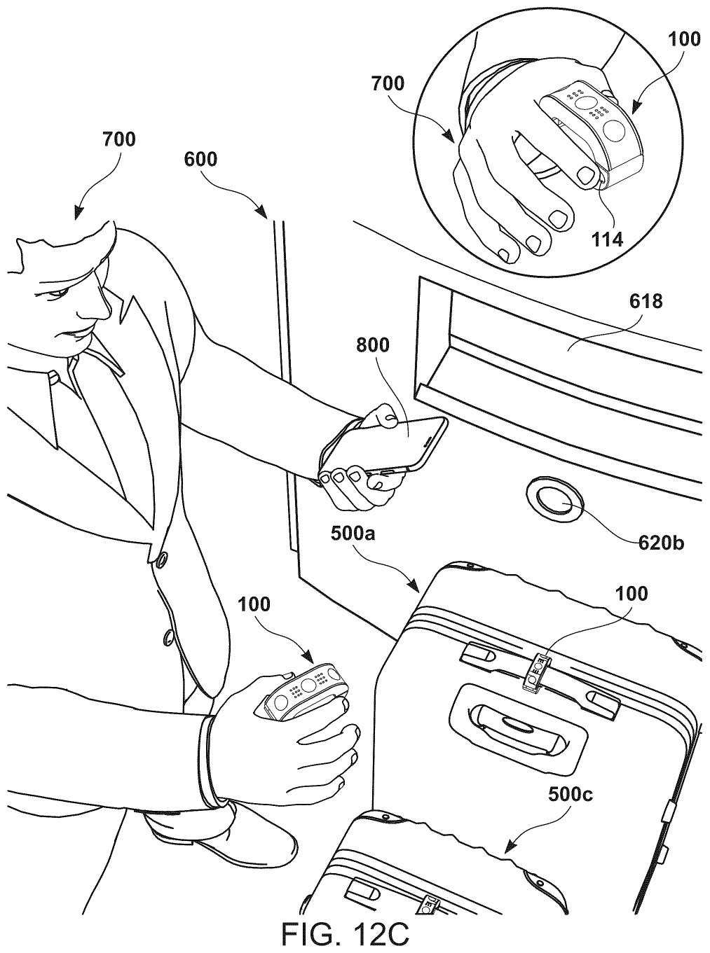

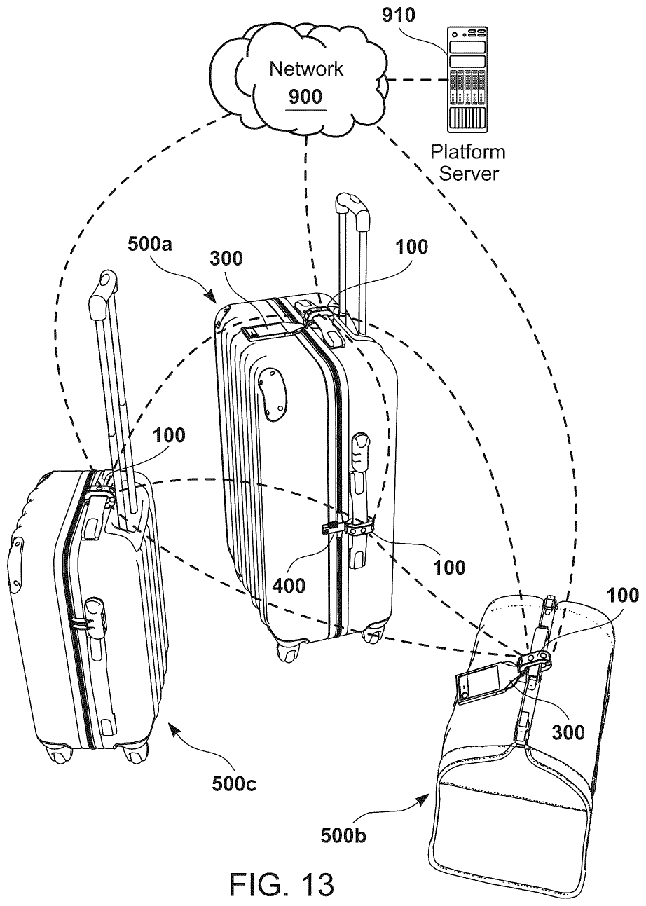

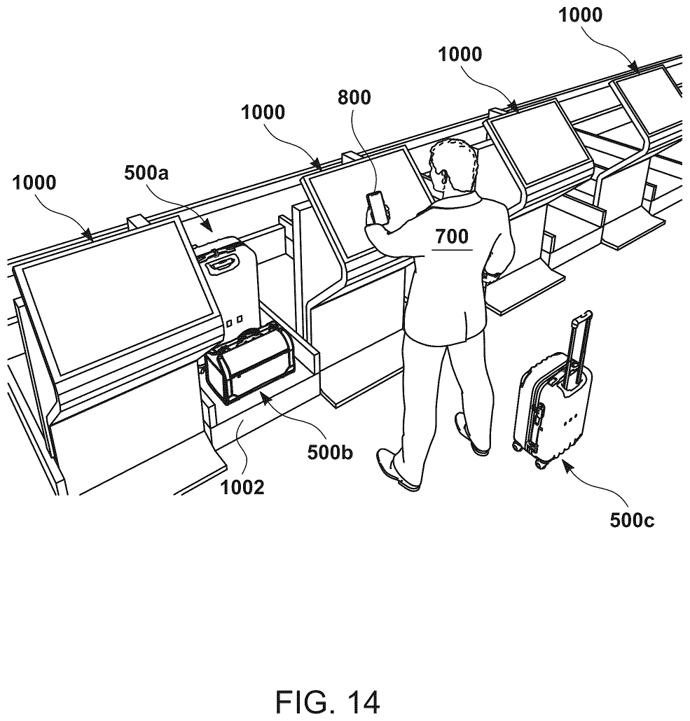

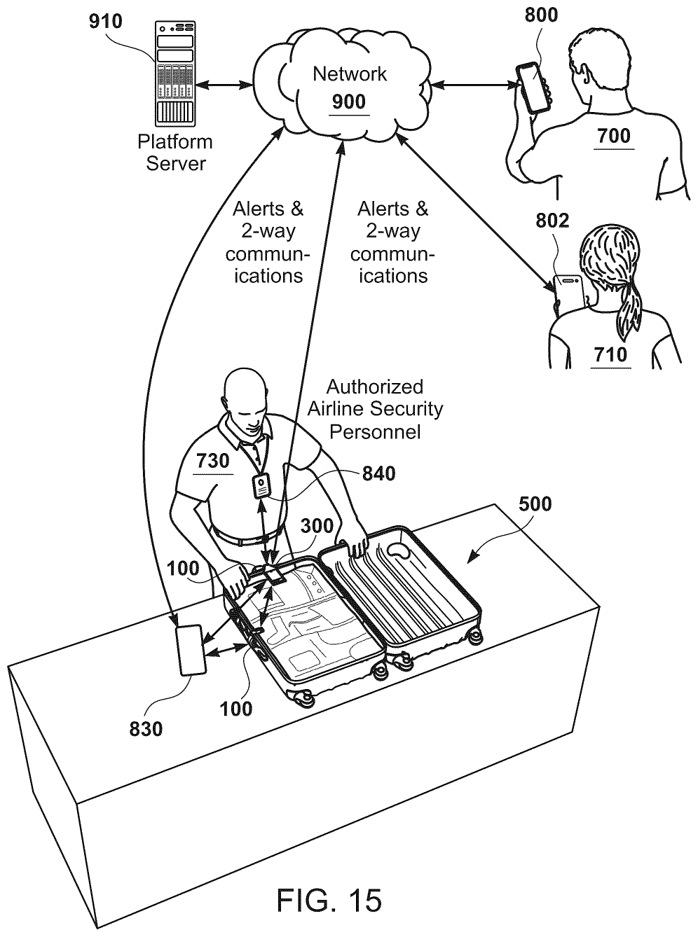

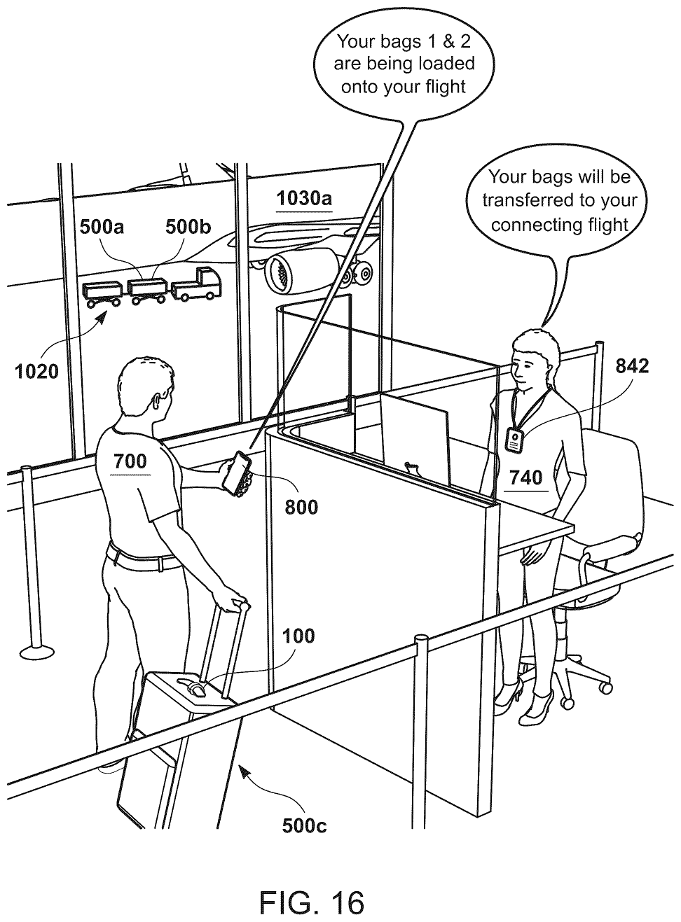

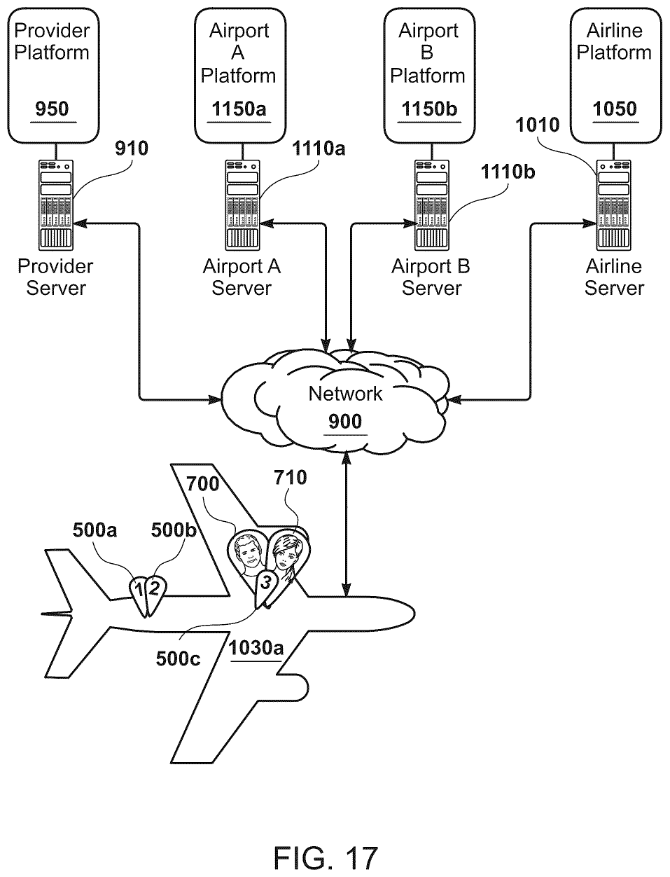

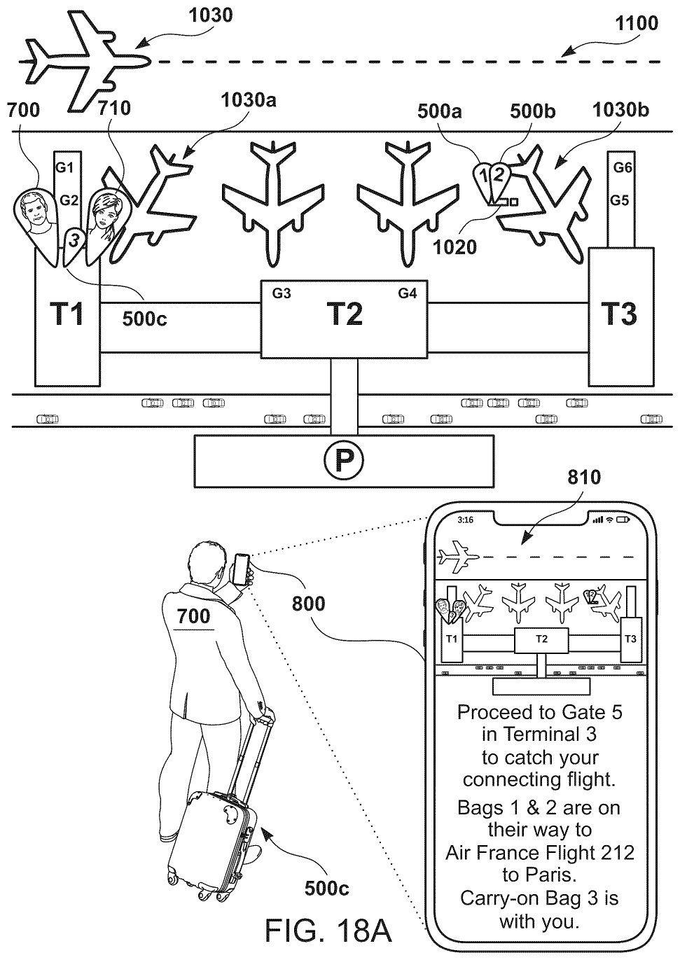

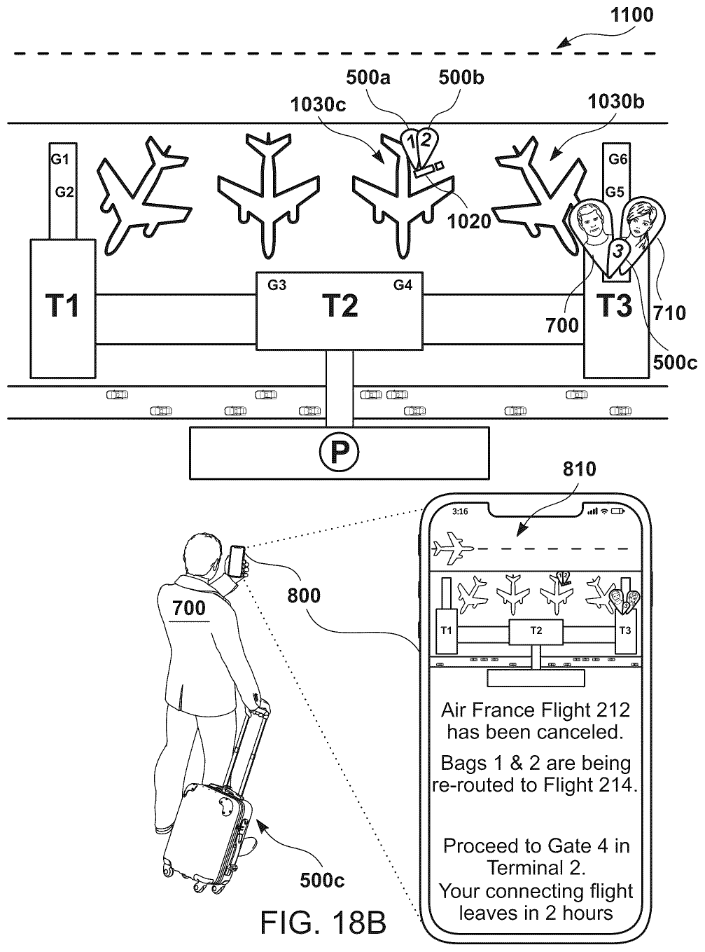

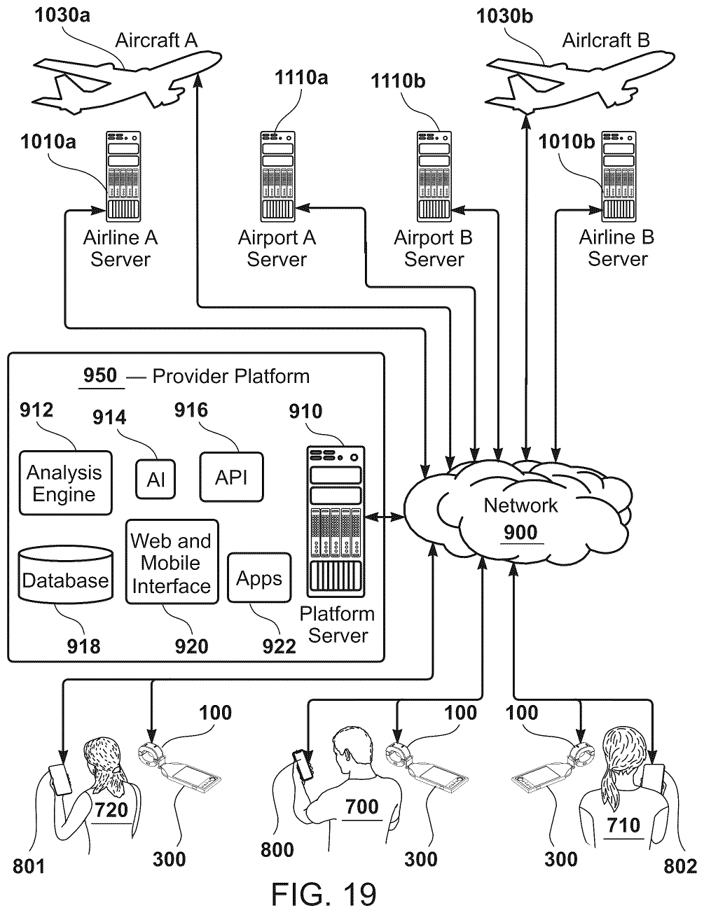

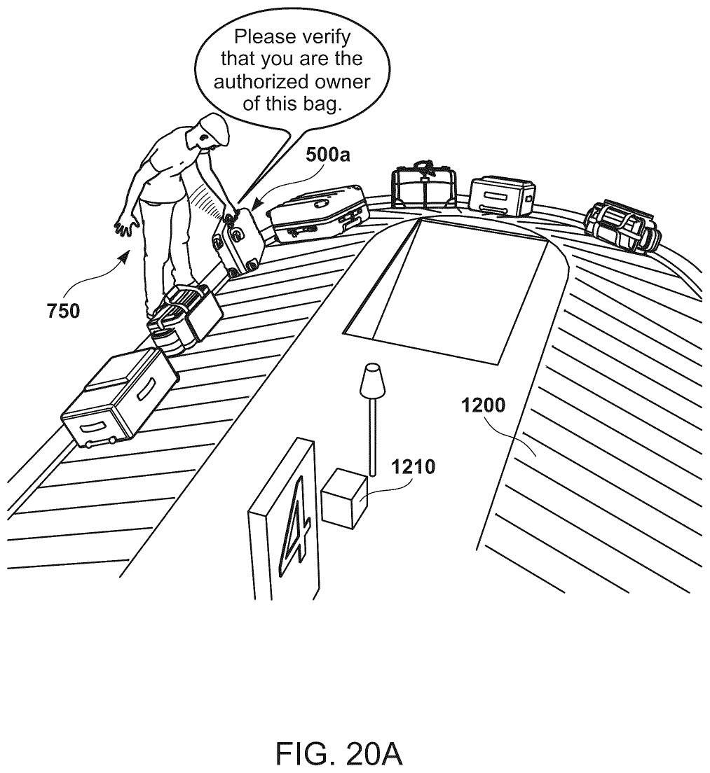

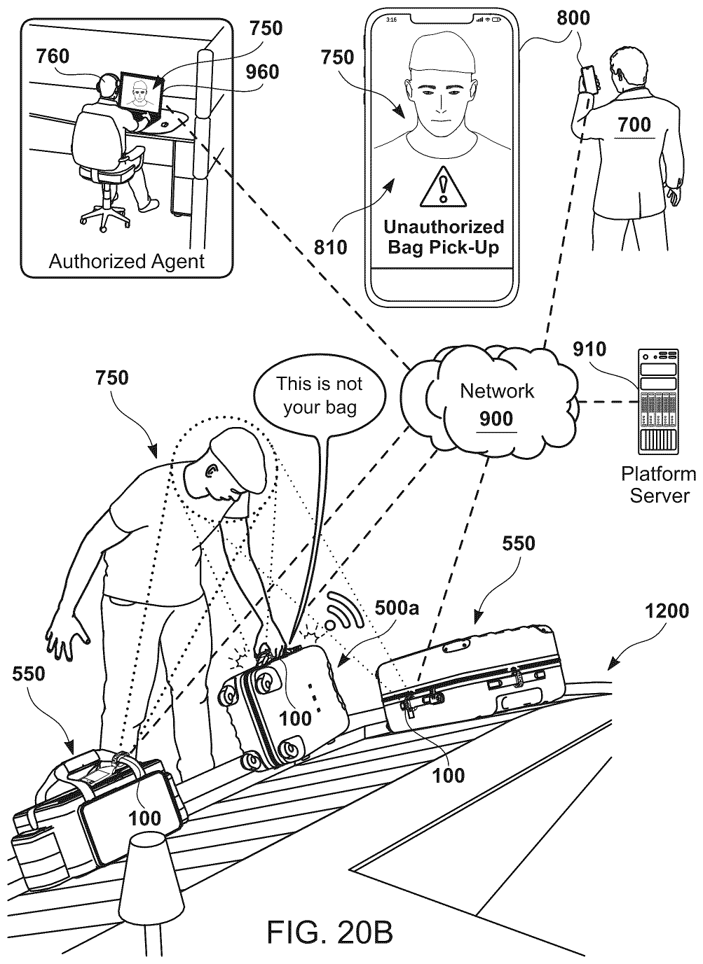

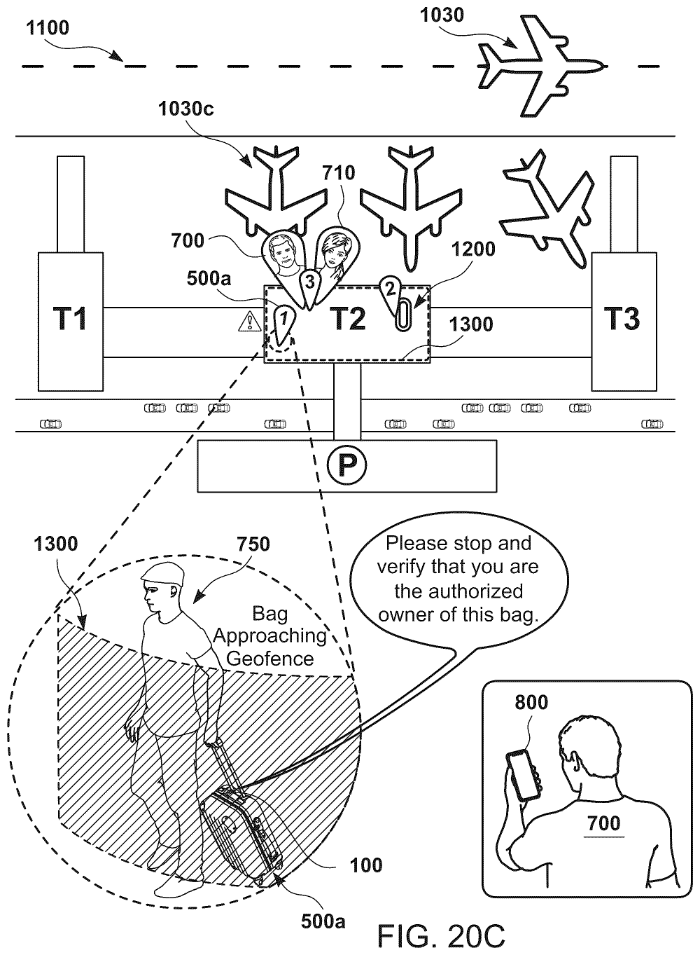

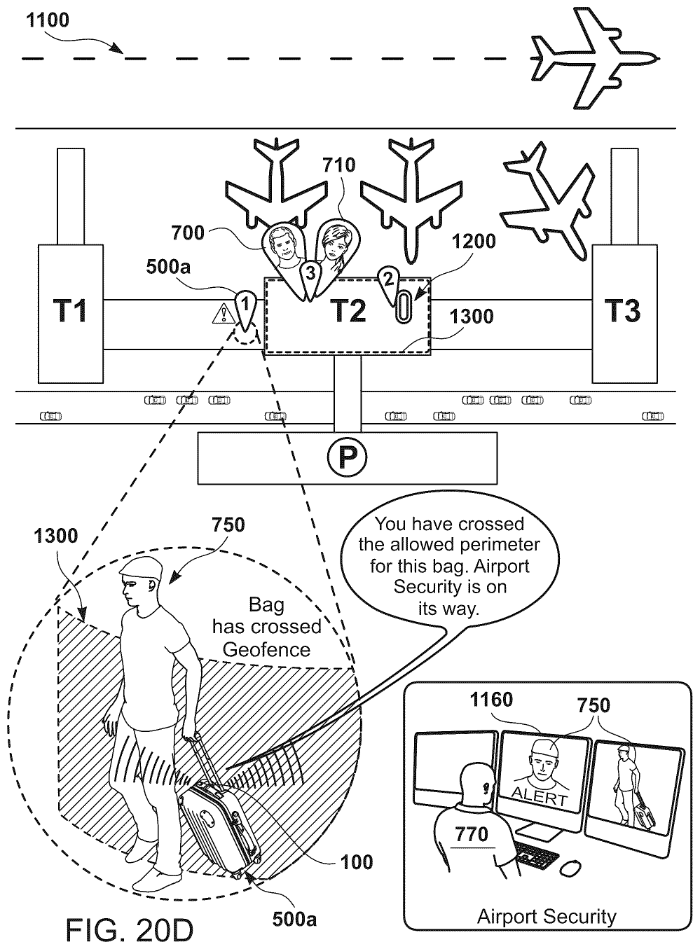

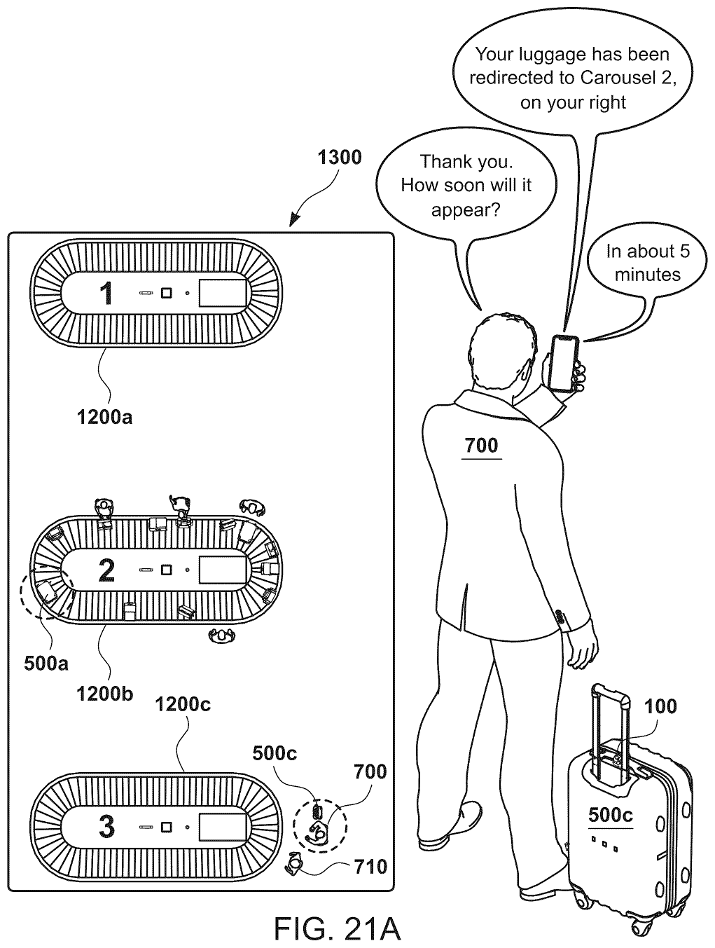

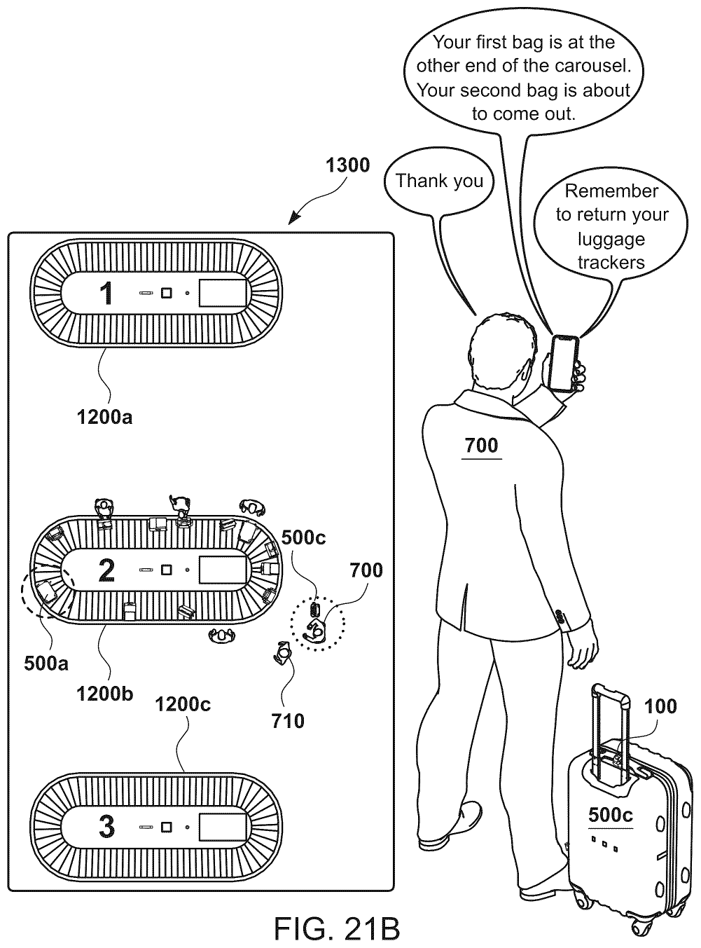

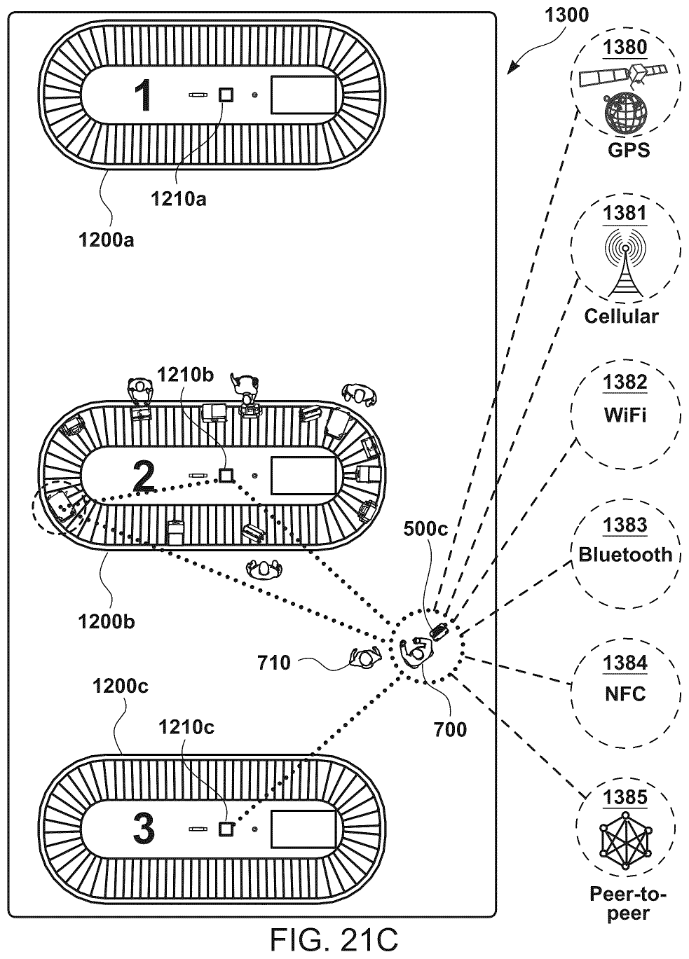

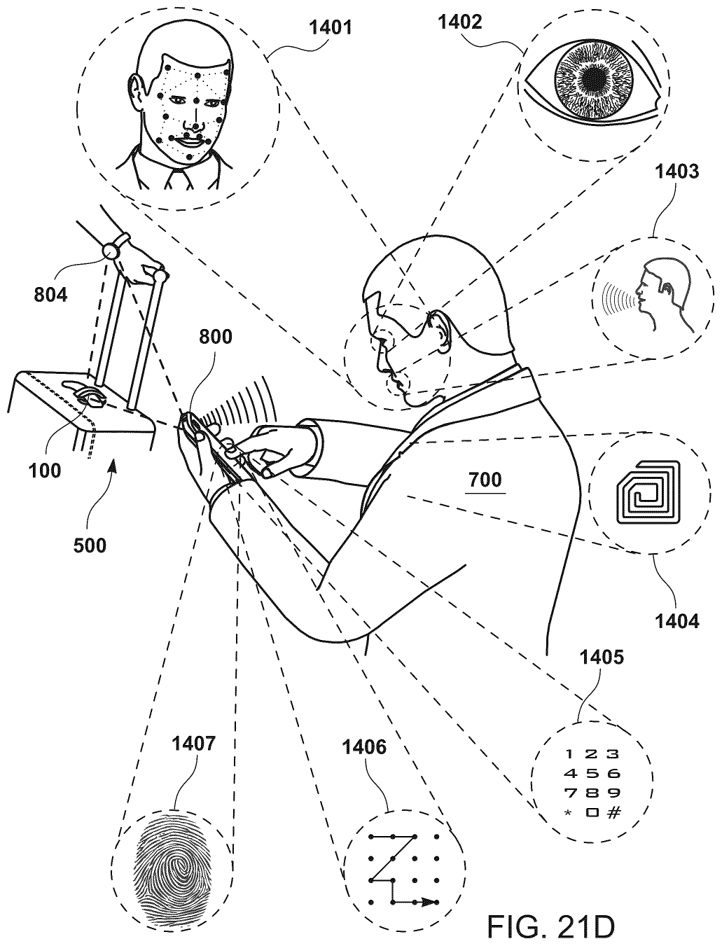

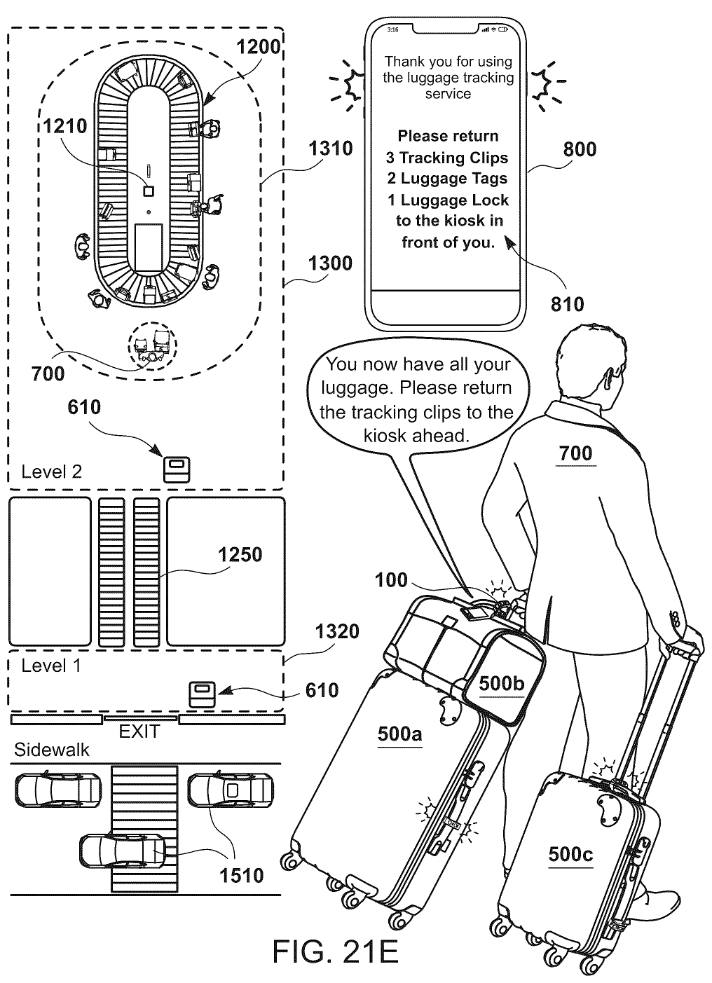

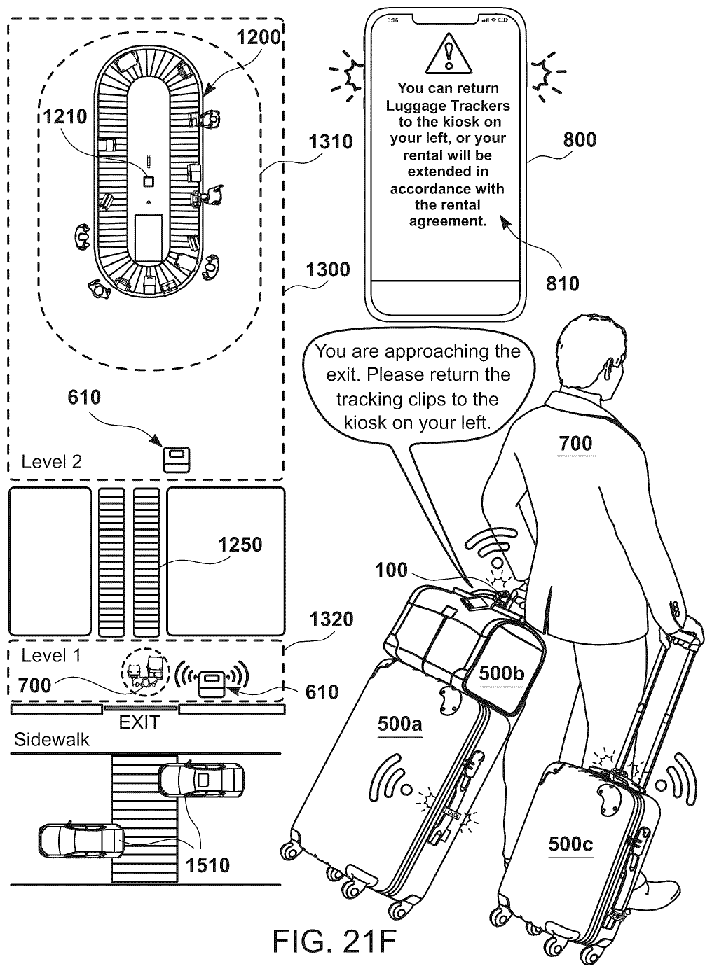

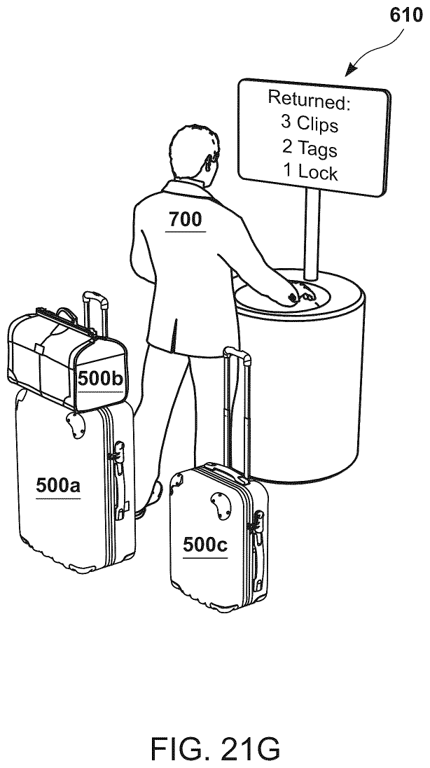

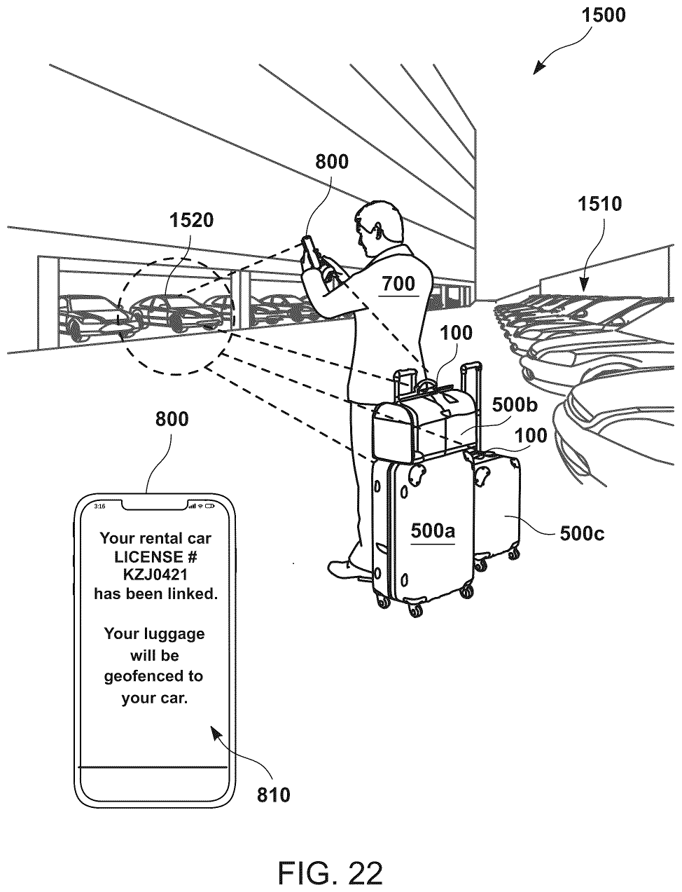

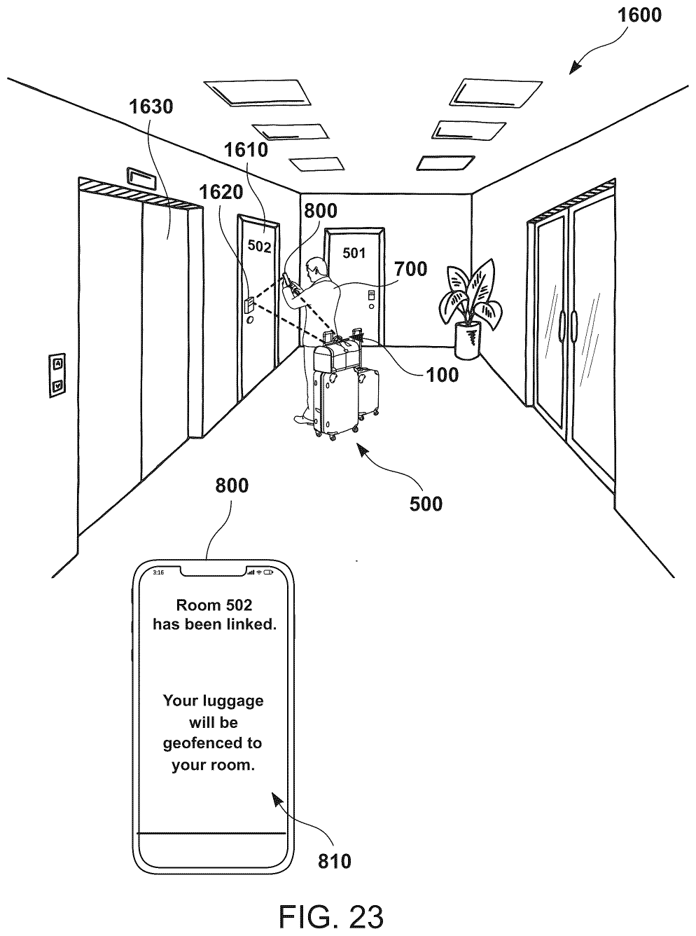

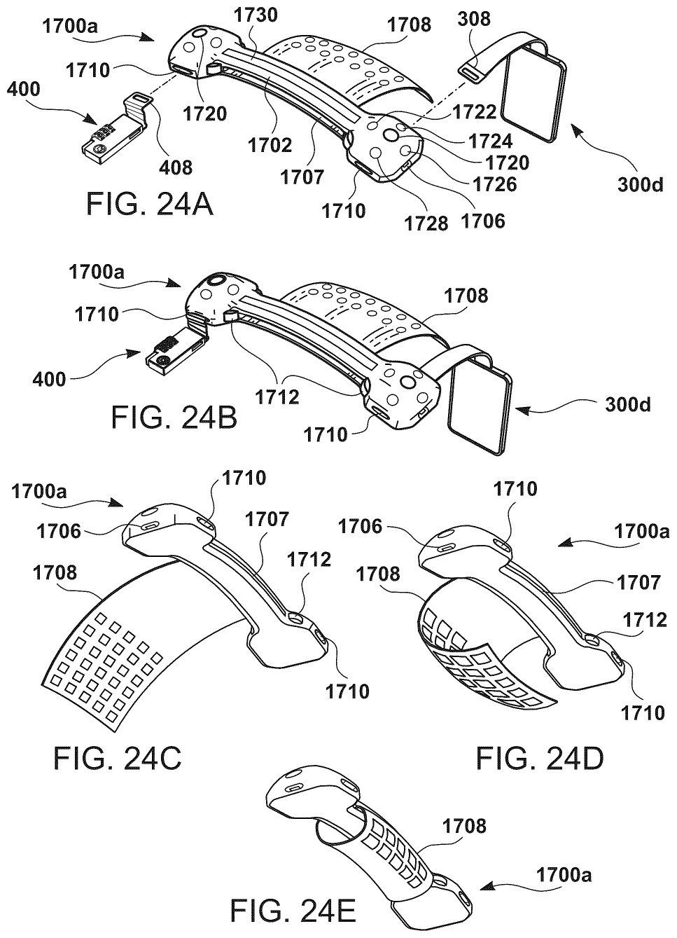

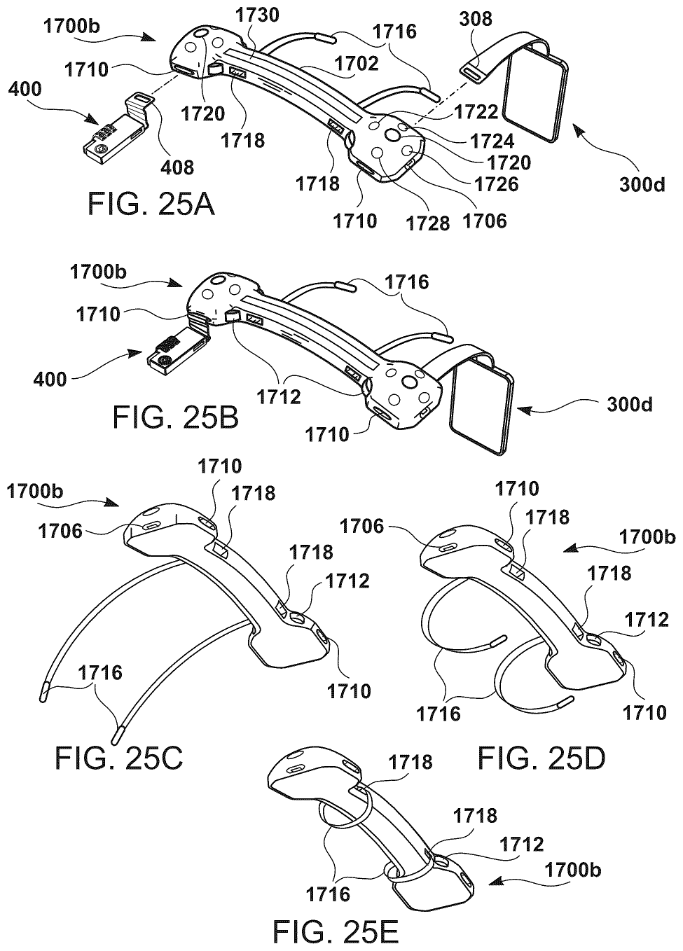

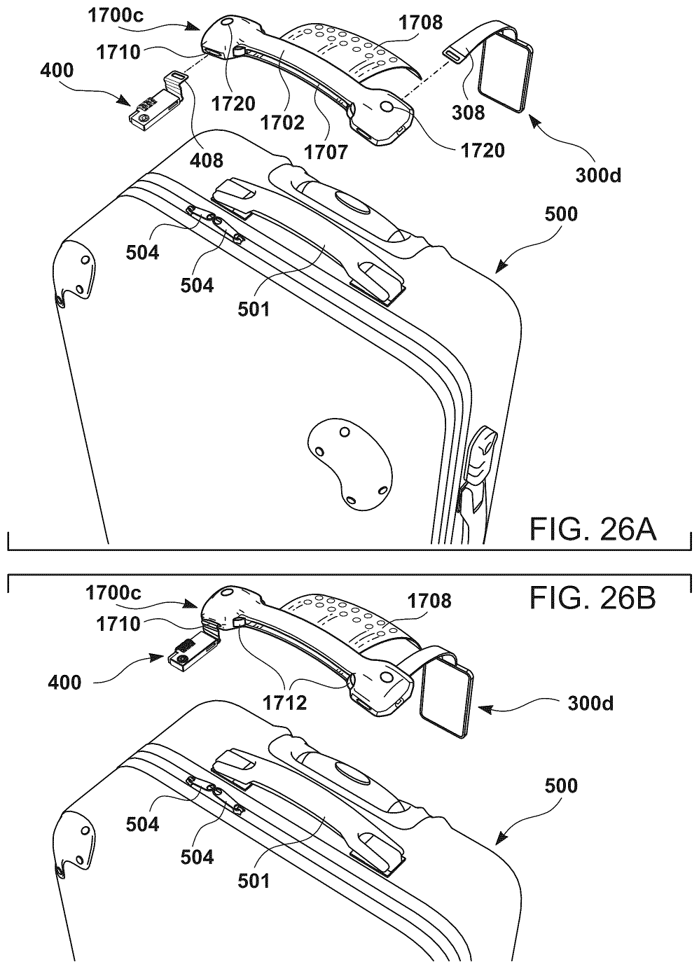

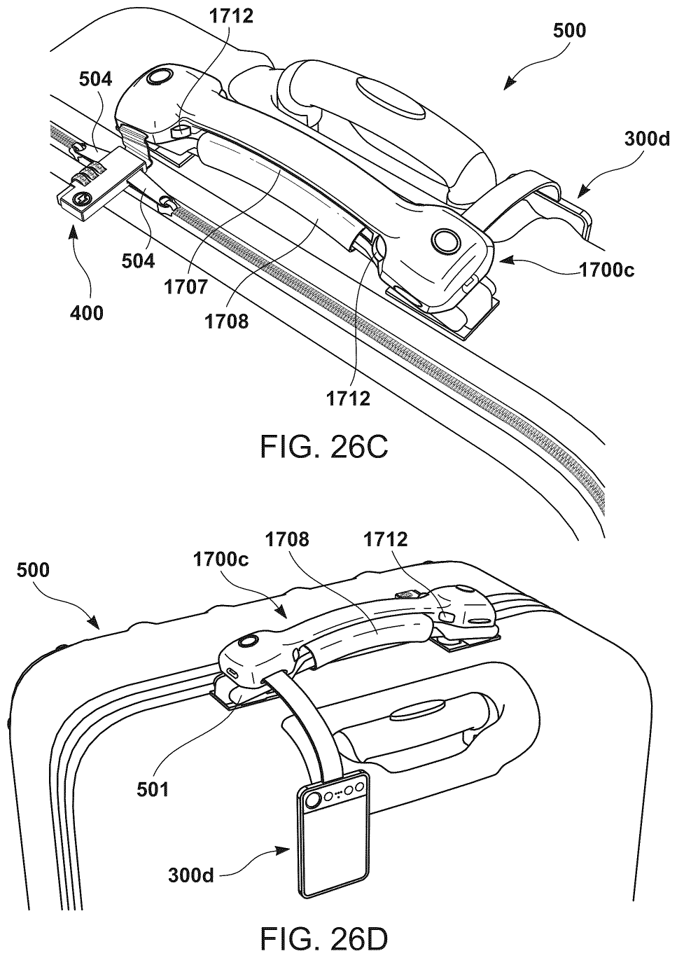

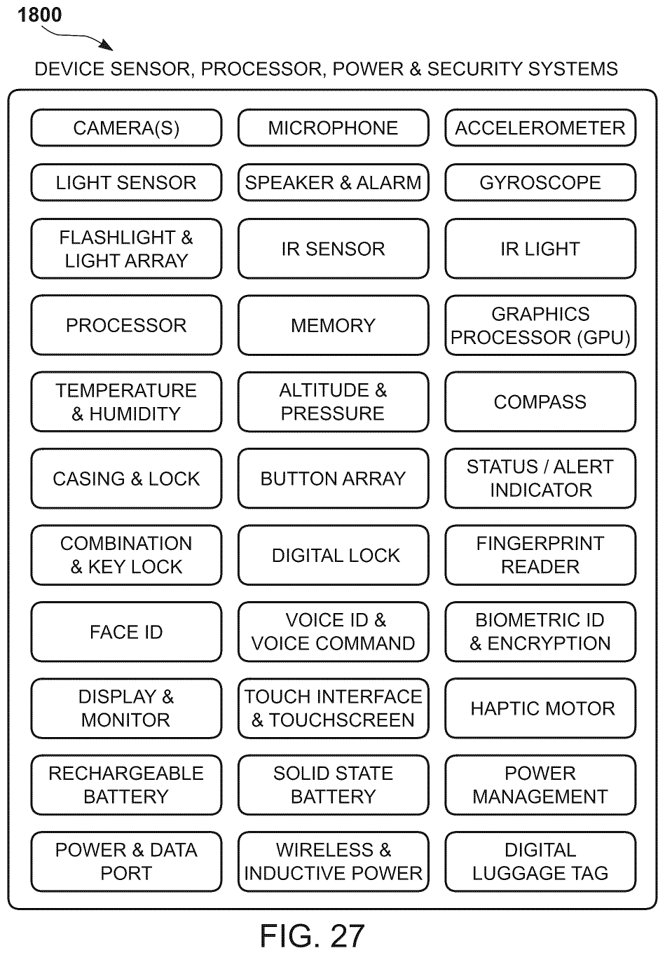

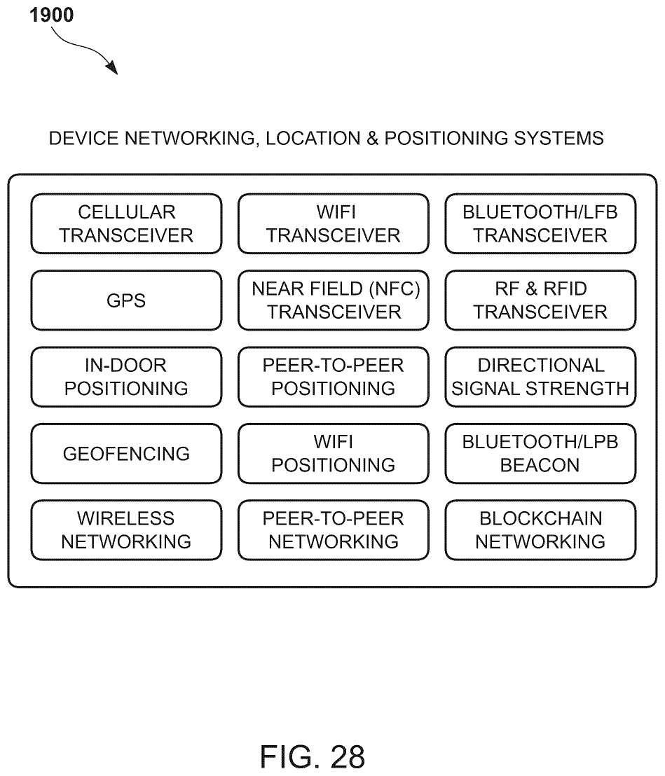

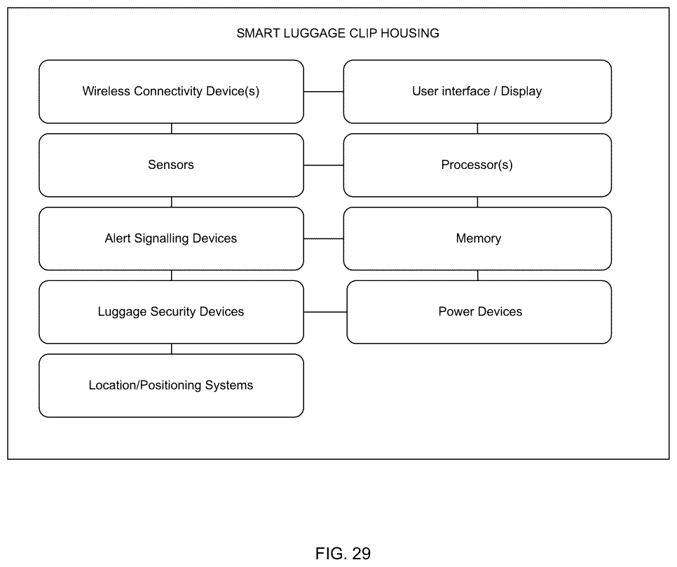

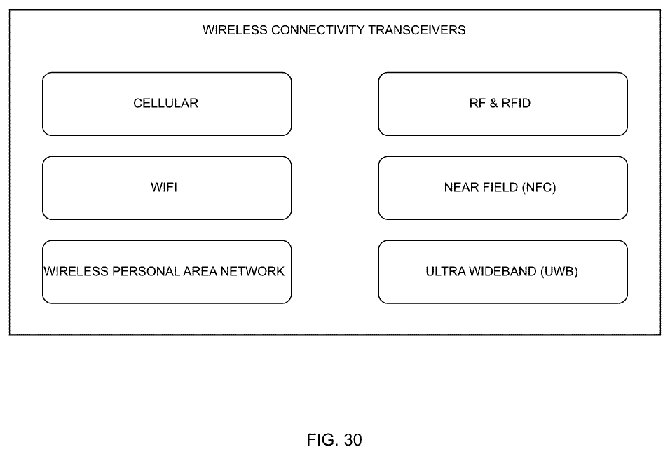

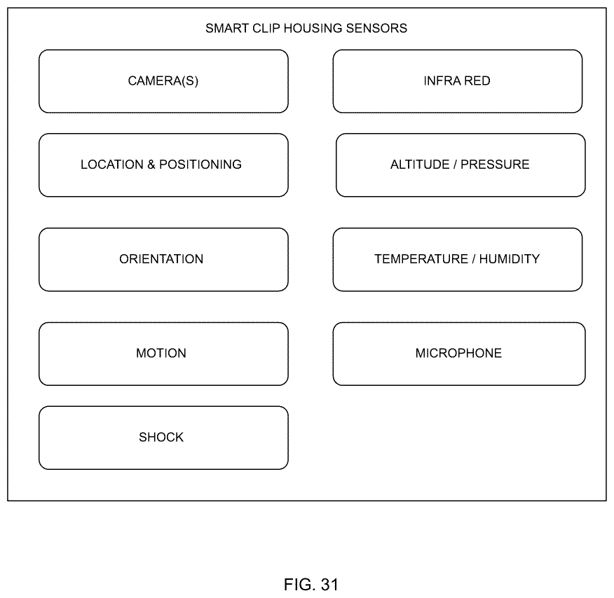

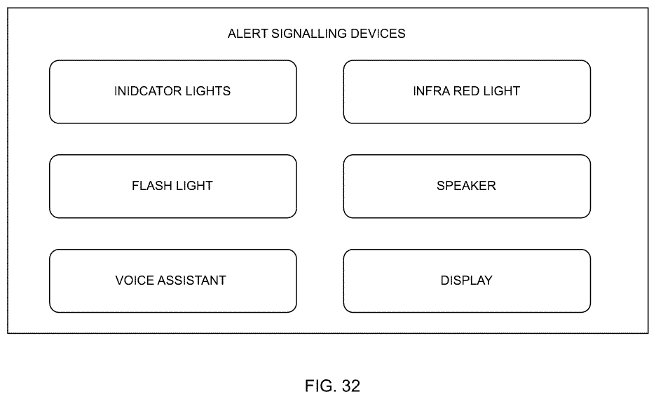

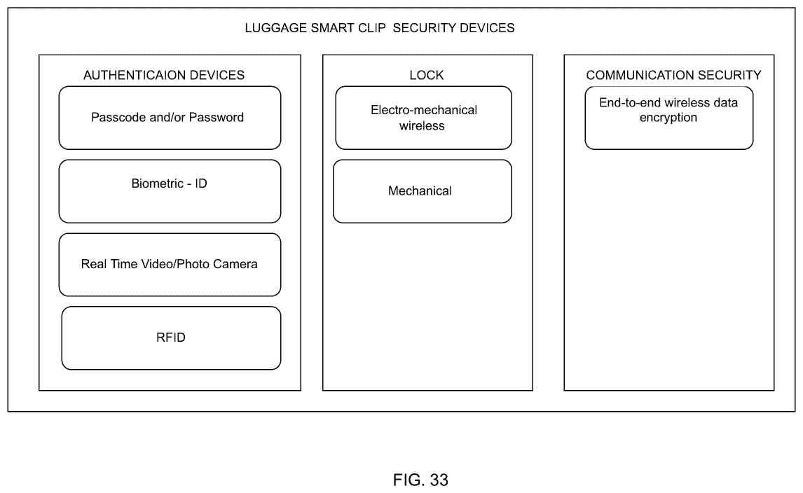

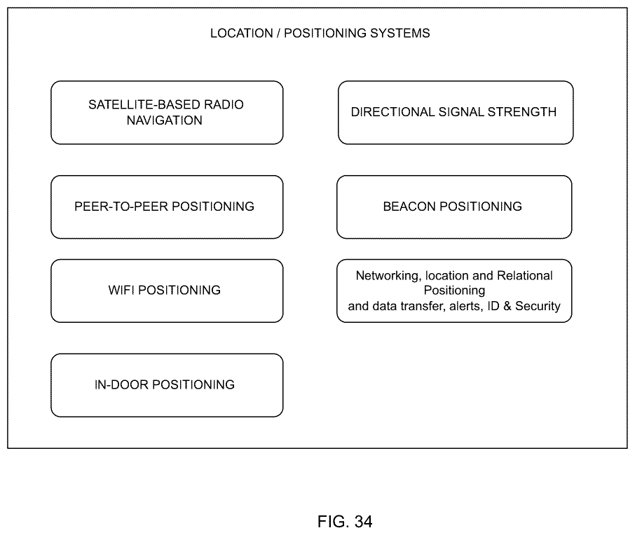

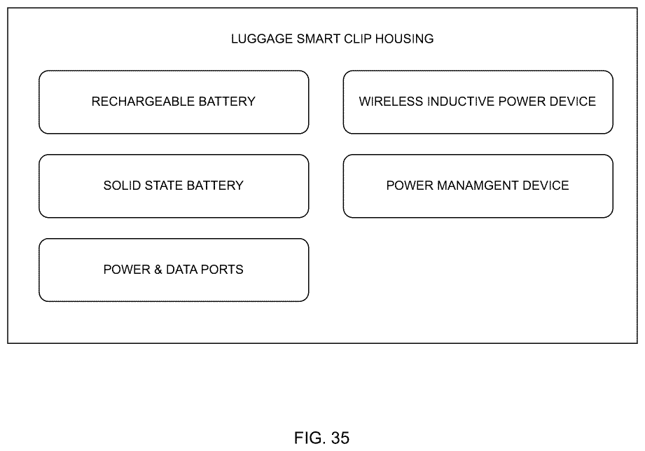

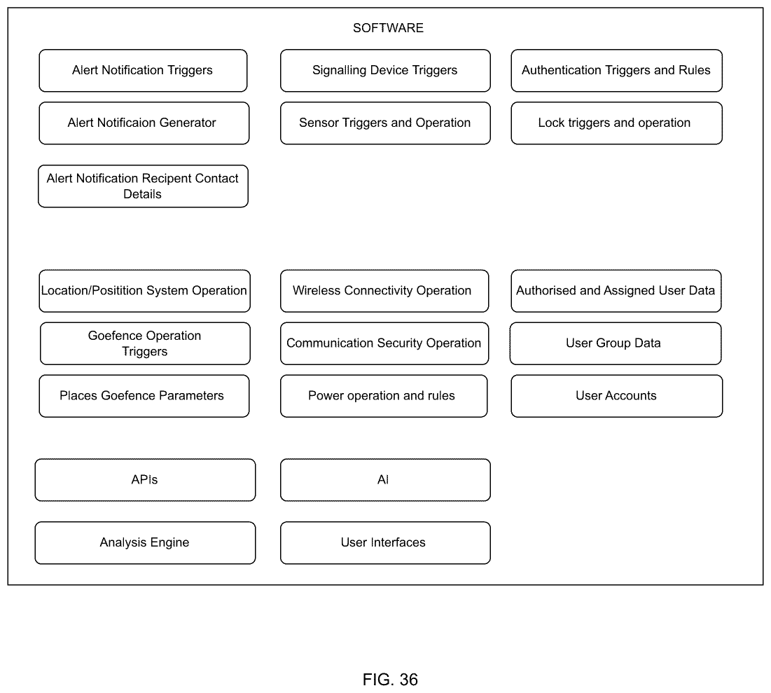

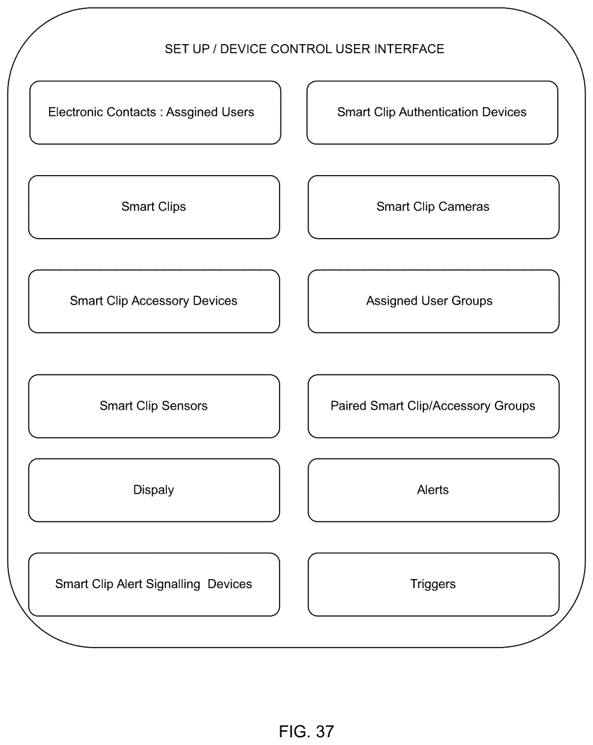

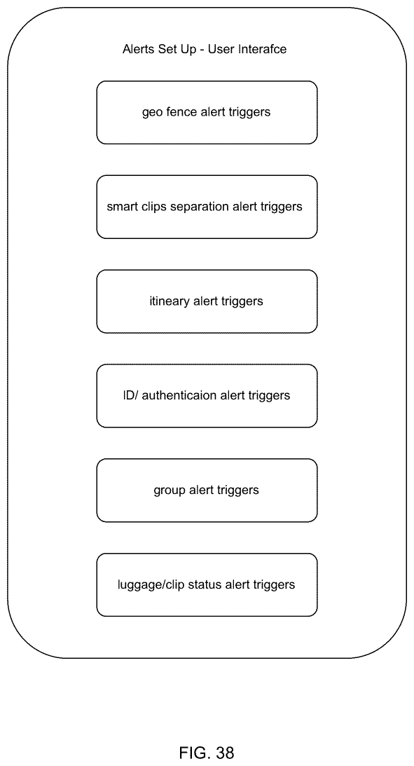

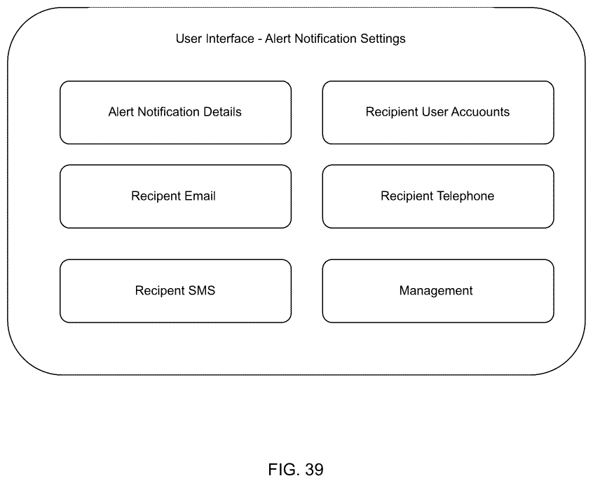

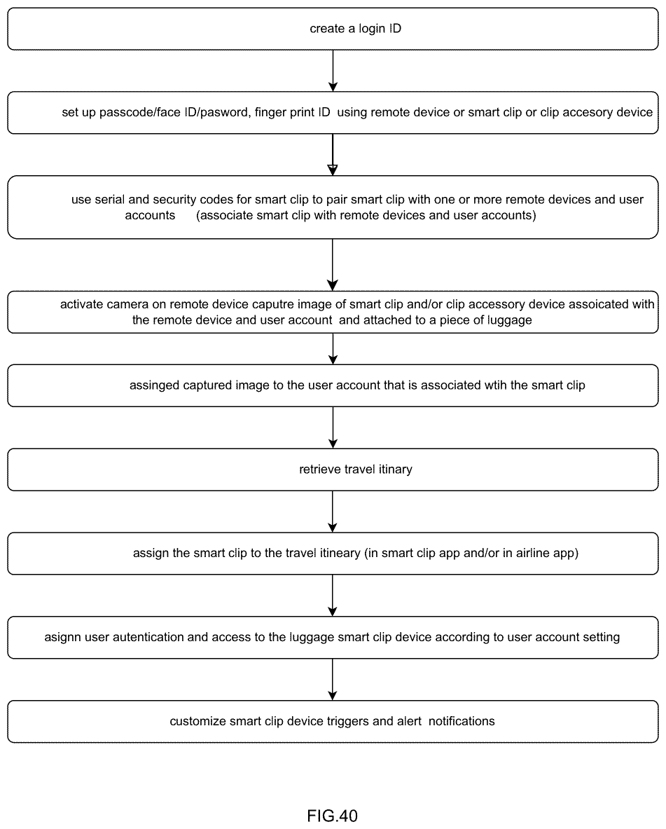

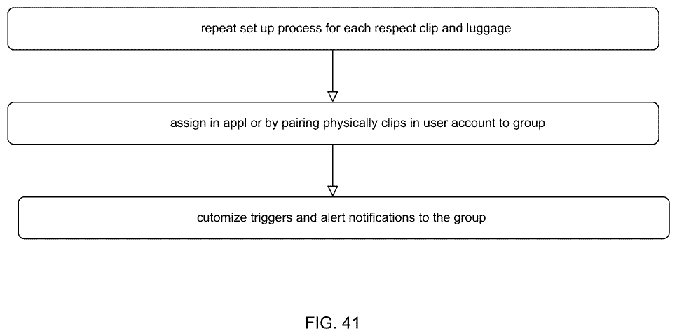

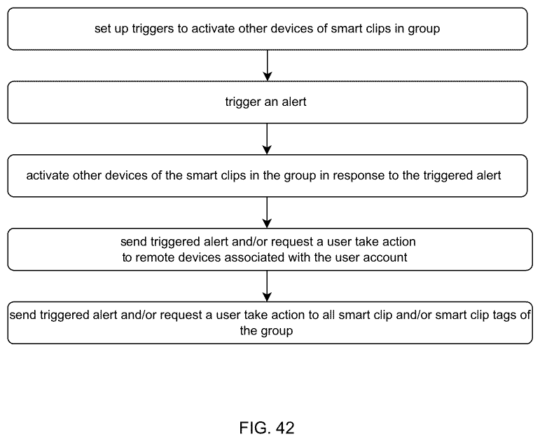

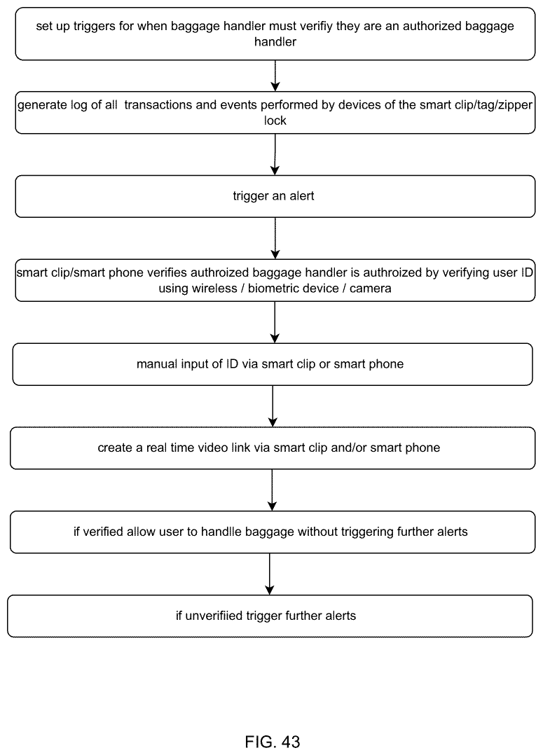

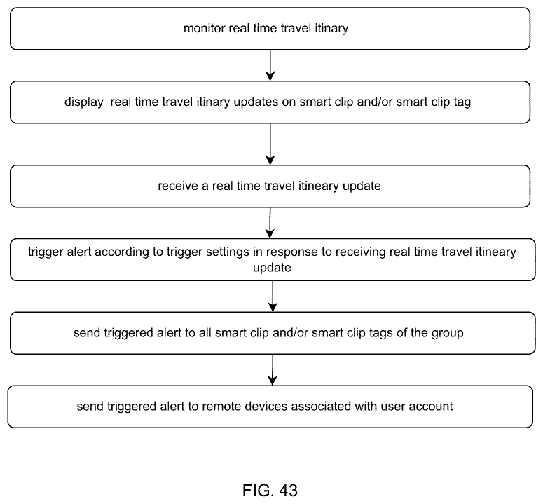

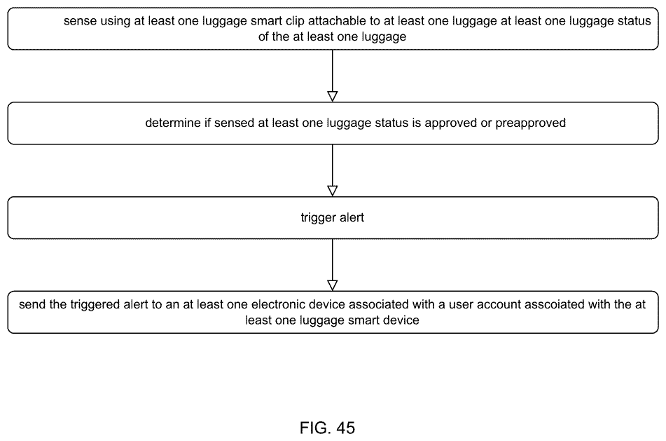

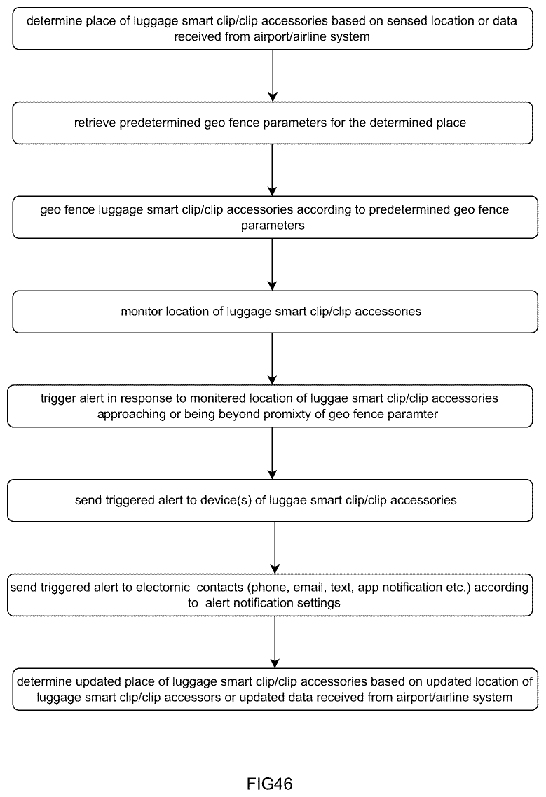

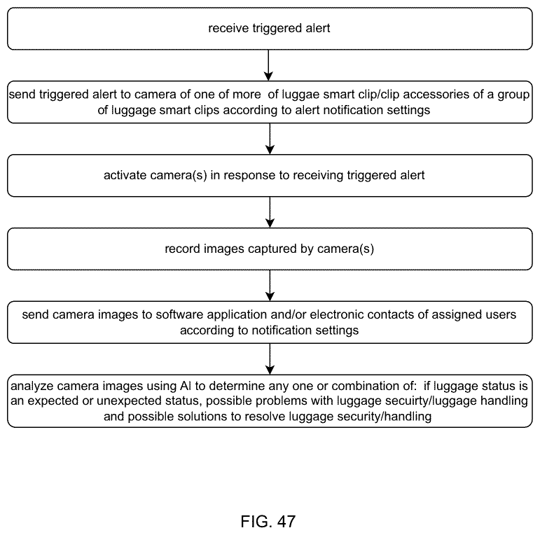

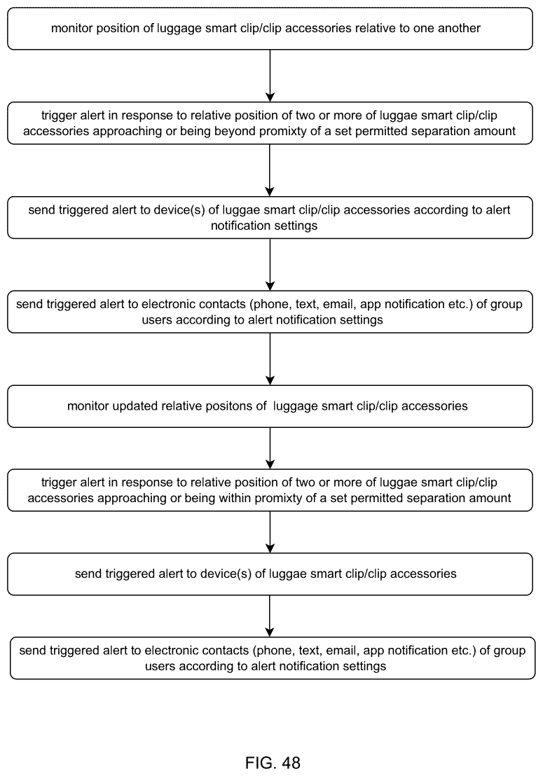

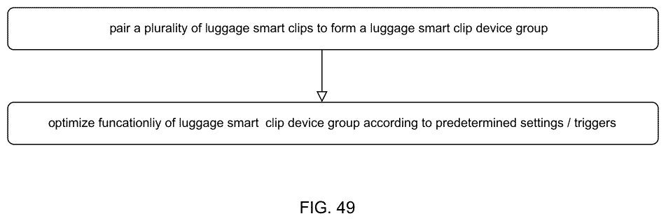

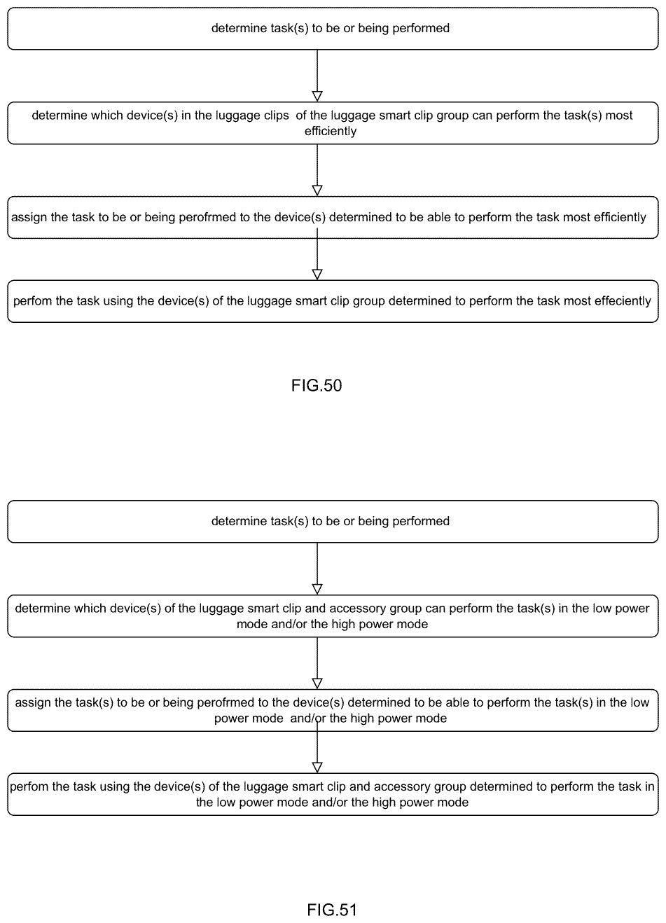

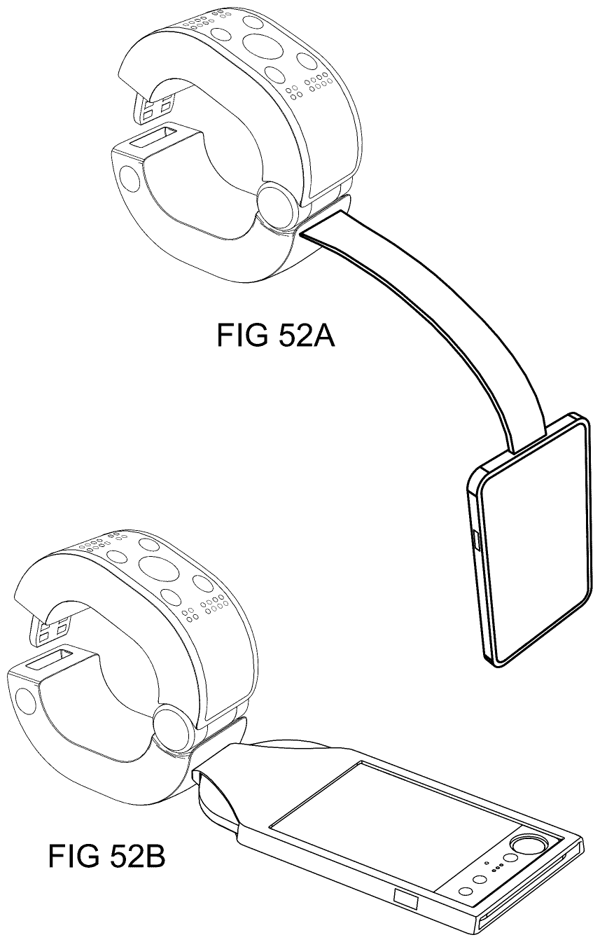

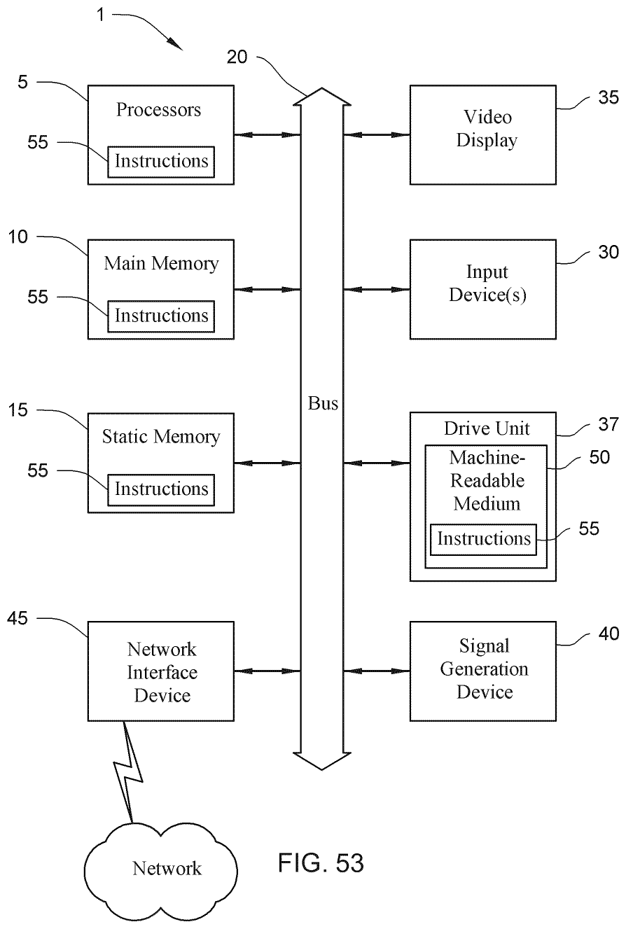

Two or more Smart Clips and their attached/paired accessory devices may also be wirelessly grouped, either when they are attached to one bag or when attached to multiple bags. For example, one Smart Clip may be paired with a Smart Luggage Tag accessory device and a second Smart Clip may be paired with a Smart Luggage Lock accessory device on the same bag with the first Smart Clip and Smart Tag attached to one luggage handle and the second Smart Clip and Smart Luggage Lock attached to another luggage handle. These clips may be grouped to operate as a single system and are alerted if a sensor is triggered in the other SmartClip and accessory device and a single mobile alert is sent to the assigned user's mobile device. FIG. 9 is the smart luggage lock accessory device FIG. 11D and FIG. 13

A Device Group is often created when two or more bags belong to the same person, family, team or other group of people all traveling to the same location or locations. In this case the Smart Clips and paired accessory devices on each bag belonging to the group of people, may be wirelessly grouped, networked and geofenced together, so that if any one bag is moved more than assigned distance (example 50, 100 or 200 feet) from the other bags, all assigned users of all of the bags are notified or just the user assigned to the bag that is detached is notified and the manager assigned to the Group is notified depending on how alerts are preprogrammed by the manager of the group. In the event that one of the bags is detached from the device group, the manager may pre-program a set of scenarios for event response for example, a basic white light flashing alert on the detached bag is 50 feet from the rest of the device group, a red light flashing when the bag is 100 feet and an audio alarm if it is more than 250 feet.

If an alarm is triggered by one Smart Clip in a device group, the device group manager may also pre-program the alarms to be triggered in all of the Smart Clips in the device group or only the Smart Clips in the device group nearest to the Smart Clip with the triggered alarm (within in a 10 or 20-foot radius of the Smart Clip with the triggered alarm).

NOTE: In other embodiments of the Smart Clip that have cameras and other imaging sensors, an alert set off by one Smart Clip in a device group may trigger some or all of the other grouped devices within a defined radius, to turn on their cameras and record for backup video and documentation of an alarm event).

The processing device associated with the smart clip or tag etc. can be preprogrammed by a user or airline etc. or by real time updates. 1. Smart clips can be grouped together based on luggage of family, users traveling together or other criteria. 2. Perform tasks on entire group such as arming or rearming smart clips/tags or devices thereon during baggage checkin and baggage claim or different plane changes. Performing tasks on entire group rather than individually (assuming group remains in group conditions/criteria)—geofencing and travel itinerary updates and/or handling alerts are just some examples of what can be performed on the entire group.

An alert and/or alarm response may also be location, time and event specific for example an airline may generate device groups for all Smart Clips on all bags on a flight and may turn off the audio alarm feature during loading and unloading of bags to prevent alarms going off when bags that are part of a device group are in different stages and locations in the loading and unloading process and the alarm feature may then be automatically re-armed when a bag is located in a mapped and geofenced baggage claim area to prevent unauthorized handling, access and theft of bags during pickup.

A Smart Clip may be assigned to more than one device group. For example, if a bag is scheduled to travel on two or more flights with one or more transfers during a single journey, device groups may be generated for all bags on each flight and the Smart Clip attached to the bag will be assigned to device groups for each flight on its journey. Device groups may be time, location and event specific for example a flight device group may only be turned on within one or two hours of a flight and bags that are on another flight in progress and part of another device group will not officially join the second flight device group until the plane has landed in the same airport and is within a geofenced area of the second flight device group.

If a flight is delayed, cancelled or the gate and location is moved, all Smart Clips in the flight device group of the altered flight will be updated with new geofencing and new flight time, location, security and other parameters for the new flight device group and all authorized users assigned to the Smart Clips in the altered flight device group will receive mobile alerts on their mobile app and/or SMS text messages and/or emails if requested. This process may be employed for a group of smart clips and/or smart tags or a single smart clip.

If a Smart Clip assigned to two or more flight device groups misses a connection flight, then in addition to sending mobile alerts to the flight device group manager (the airline) and the assigned user(s) (owner(s) of the bag), an on-bag alerts may be triggered such as a visual light alert in the form of a flashing red or other color light. Note different color and flashing signals may be pre-programmed for different types of alerts to visually identify to airline employees and baggage handlers the type of event for rapid response. An audio alert may also be sent out to all Smart Clips that are part of an altered flight group so that when a bag is picked up by a baggage handler, the Smart Clip automatically plays the audio alert with instructions on how the bag should be handled and where the bag should be delivered.

In addition to Smart Clip visual and audio alerts. A Smart Luggage Tag accessory device attached to the Smart Clip on the bag may provide a more detailed alert and instructions on the Smart Tag display regarding the missed connection and real-time information on the new flight or handling instructions regarding where the luggage should be moved to deliver the luggage to the correct destination.

For the basic embodiment of the Smart Clip all real-time alerts and updates are sent to the Smart Clip via Bluetooth within an airport, airplane or other networked area.

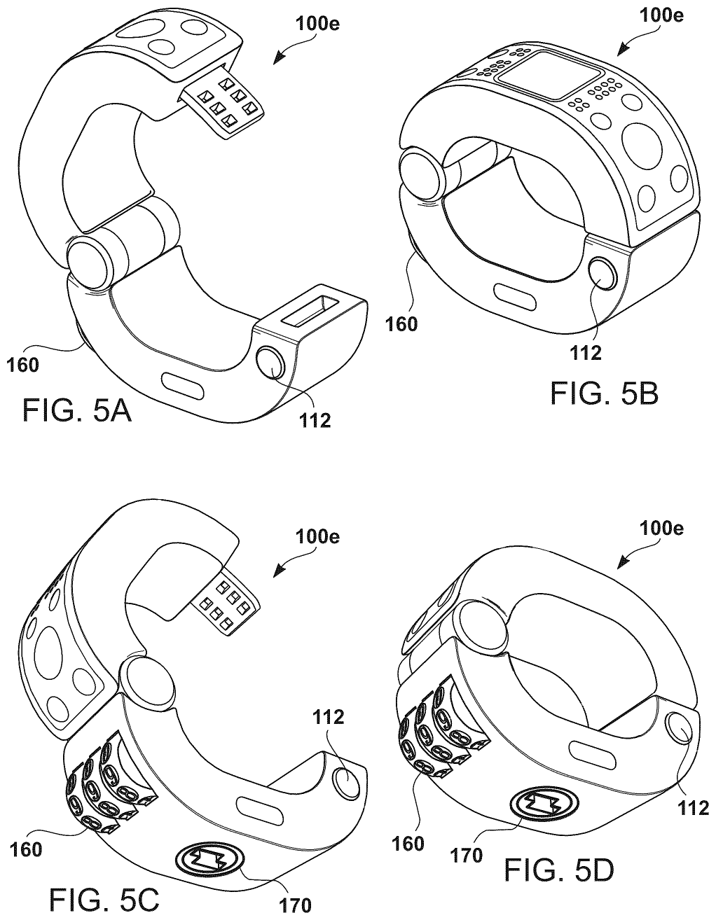

In some embodiments (FIGS. 5a, 5b and 5c) a basic Smart Clip may be paired with a more advanced networked accessory device in this case a Wi-Fi and/or cellular enabled Smart Luggage Tag with embedded camera. In this scenario, once attached and paired with the Wi-Fi enabled Smart Tag, the basic Smart Clip will use the Wi-Fi or cellular network of the attached Smart Tag to receive real-time alerts and uplink to the Internet to upload real-time alerts to the Luggage tracking, monitoring, management and security cloud platform which then updates the mobile apps on all authorized users and receive real-time instructions and controls regarding alarm on/off triggers and other direct communications and controls between the Smart Clip manager and/or authorized users.

Different alerts may be correlated with different colors and the processing device of the smart clip or system may be programmed to selectively trigger color lights of the smart clip according to the different alerts.

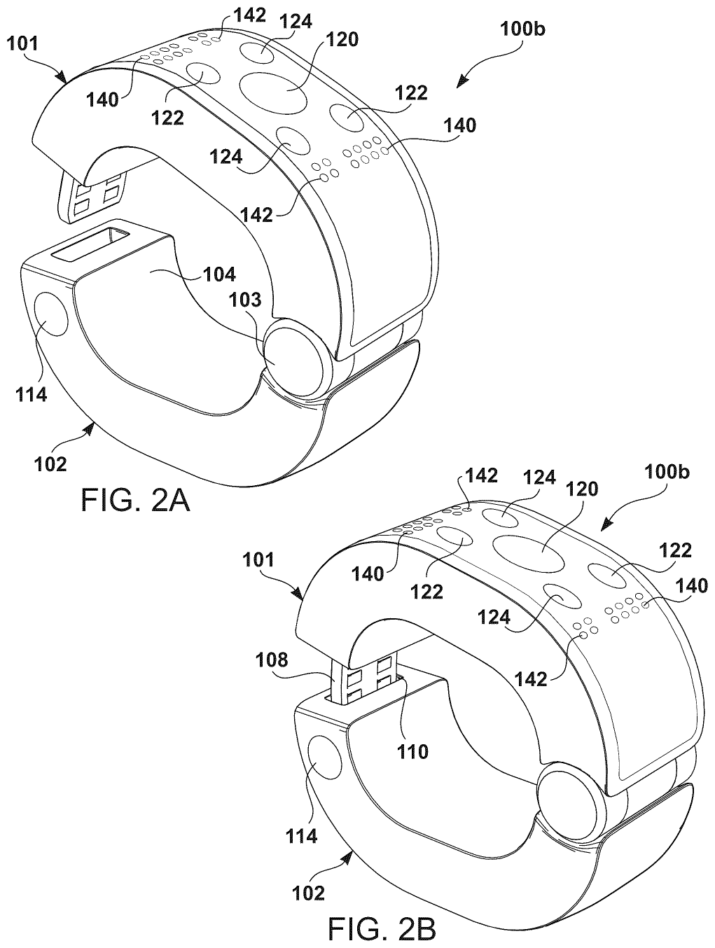

### Smartclip Embodiment 2—Page 2 (FIGS. 2A, 2B) (100b)

The second Smart Clip embodiment has 5 methods of wireless networking, location and device identification
A) Wi-Fi
B) Bluetooth and/or Low-Power Bluetooth (LPB)
C) NFC (Near-field Communication)
D) UWB (Ultra-wideband)
E) RFID (Radio-frequency Identification) (Active and Passive)

### Sensors

Camera (Day and Night Vision)
Motion/Orientation/Shock (Accelerometer)
Gyroscope
Magnetometer/Compass
Altitude/Pressure
Temperature & Humidity
Lights (IR, Flash light and Multi-Color LED lights)
Microphone (Two-way communications and audio-video recording/streaming)
Speakers (Alarm & Audio Alerts)

### Power

Batteries (Rechargeable and/or Solid state Replaceable
Inductive Power Charging
USB/Micro USB or other wired data networking and power charging port

### Security

Electro-mechanical wireless Locking System
On-Device Fingerprint Reader
Passcode and/or Password and/or Fingerprint and/or Face ID (via a connected device)
End-to-end wireless data encryption
Light & Audio Alarm and Alerts

### Networking, Location Tracking & Positioning

Embodiment 2 of the Smart Clip may be tracked and network using one or more of the following wireless protocols, methods and systems.

Wi-Fi Peer to Peer, Wi-Fi hot spot and Wi-Fi Internet Uplink Bluetooth/Low-Power Bluetooth (LPB)—(low power indoor & outdoor Peer to Peer Networking, location and Relational Positioning and data transfer, alerts, ID & Security. NFC-Near Field Communication for rapid device pairing, Identification & User Verification UWB-Ultra-wideband-Ultra low energy-time of flight location positioning) RFID (Active & Passive Radio-frequency Identification)

Smart Clip Embodiment 2, like embodiment 1 will select the most power effective method for tracking and networking at all times unless Wi-Fi or Bluetooth are needed to perform a task, wirelessly pair and/or peer-to-peer network with one or more devices, upload and/or download real-time data and alerts to and from the Internet and/or wirelessly communicate text message and stream real-time video and other sensor data over a Wi-Fi Internet uplink to a secure cloud platform and/or direct P2P wirelessly to one or more mobile app enabled phones, tablets, PC's or other authorized users computing and networking devices.

Smart Clip Embodiment 2 is also able to use Wi-Fi directional signal strength positioning to accurately identify its position using one or more fixed location Wi-Fi routers in airport, hotel or outdoors to accurately identify its location and relational position. This method in combination with Bluetooth P2P and Ultra-wideband networking and positioning and RFID identification to provide multiple methods of location and relational positioning both indoors and outdoors.

The primary differences between Embodiment 2 and Embodiment 1 are the ability for real-time Internet data and communications, real-time audio-video streaming and the ability for users to remotely operate and control the SmartClip when-ever a Wi-Fi connection is available. When Wi-Fi is unavailable, the Smart Clip Embodiment 2 will operate based on pre-programmed parameters as specified for Embodiment 1.

### Power & Power Management

Similar to Smart Clip Embodiment 1, Smart Clip embodiment 2 has two batteries-a rechargeable battery and

### Security & Locking System

Electro-mechanical Lock—Digital Locking System
Fingerprint Reader—Smart Clip Embodiment 2 incorporates a fingerprint scanner into the body of the device capable of digitizing, encrypting and securely storing multiple users fingerprint IDs for rapid locking and unlocking of the device and user identification. The Reader may be programmed by the manager of the Smart Clip to store a user fingerprint for a designated amount of time, for example if the manager of a Smart Clip is an airline, cruise line or other travel agency that may lease the smart clip to one or more travellers and users, the SmartClip may be programmed to store the fingerprint for a specified amount of time such as the term of the lease and then fingerprint and key assigned to the finger print are cancelled and deleted via the mobile app or cloud platform automatically following the end of the lease so that the user no-longer has access to the device and it may be assigned to a new user.

### Sensors & Functionality

Embodiment 2 introduces a video camera, IR lights and a microphone for day and low light visibility, real-time audio-video streaming and two-way audio communications via Wi-Fi. Embodiment 2 also introduces Temperature and Humidity sensors for food, medicine and animal travel monitoring.

### Grouping & Geofencing

Embodiment 2 introduces Wi-Fi which enables the Smart Clip to be updated in real-time regarding travel itinerary changes such as flight delays and cancelations, gate changes and changes to pre-programmed geofenced data regarding airport, flight and travel location data. For example, if a transfer flight is missed or cancelled, when the initial flight arrives at the airport a Smart Clip that already has pre-programmed information on the connecting flight number, gate number and location will automatically be updated either via Wi-Fi on the plane or in the airport. And an updated geofence will be generated based on the new flight and gate information. Also, if the Smart Luggage Tag accessory device is attached and paired with Embodiment 2 Smart Tag then the updated flight itinerary will be displayed on the smart luggage tag accessory device with real-time information on where the luggage needs to be delivered updated gate, boarding time and other handling instructions.

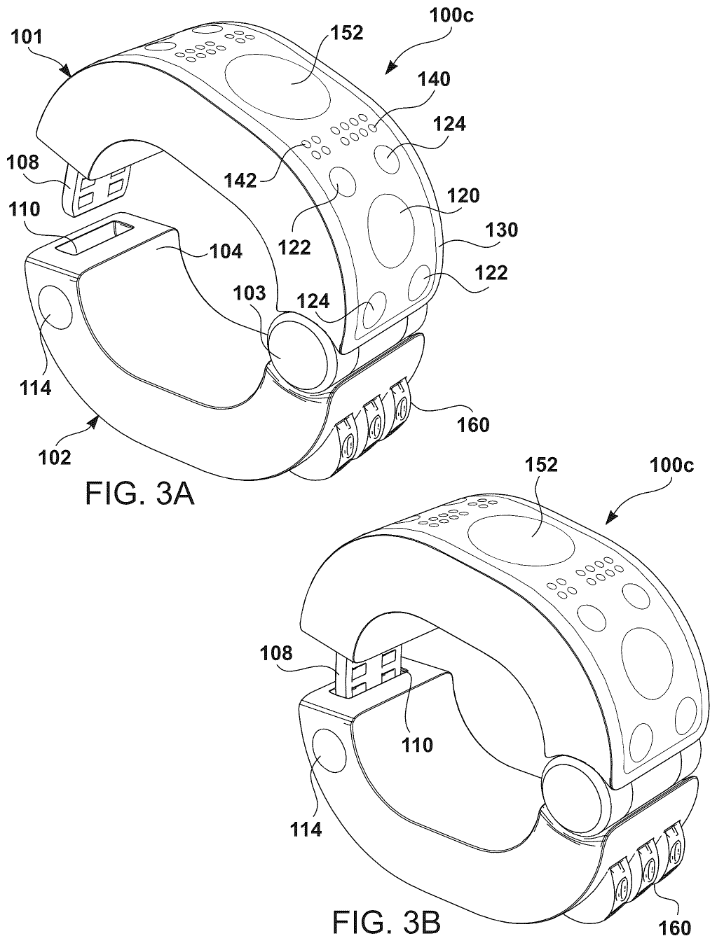

### Smartclip Embodiment 3—Page 3 (FIGS. 3a & 3b) (100c)

The third embodiment has 7 methods of wireless networking, location and device identification
A) Cellular (3G or 4G and/or 5G Broadband Wide Area Networking)
B) Wi-Fi
C) Bluetooth/LPB
D) NFC (Near-Field Communications)
E) UWB (Ultra-wideband)
F) RFID (Radio-frequency Identification)
G) GPS (Global Positioning

### Sensors

Multi Lens Camera (Day and Night Vision)
Motion/Orientation/Shock (Accelerometer)
Gyroscope
Magnetometer/Compass
Altitude/Pressure
Temperature & Humidity
Lights (IR lights, Flash light and Multi-Color LED lights)
Microphone (Two-way communications and audio-video recording/streaming)
Speakers (Alarm & Audio Alerts)

### Power

Batteries (Rechargeable and/or Solid state Replaceable
Inductive Power Charging
USB/Micro USB or other wired data networking and power charging port

### Security

Electro-mechanical wireless Locking System
On-Device Fingerprint Reader
Combination Lock & TSA Key
Passcode and/or Password and/or Fingerprint and/or Face ID (via a connected device)
End-to-end wireless data encryption
Light & Audio Alarm and Alerts

### Networking, Location Tracking & Positioning

Smart Clip embodiment 3 introduces cellular wide area networking and GPS tracking for continuous real-time voice, data, audio-video streaming, and Internet access, SMS text alerts and ultra-accurate indoor and outdoor location tracking with GPS satellite positioning.

Embodiment 3 of the Smart Clip may be tracked using one or more of the following wireless tracking protocols, methods and systems.
Cellular (4G & 5G Broadband Wireless Wide Area Networking & Cell Tower Positioning)
Wi-Fi—Wi-Fi Peer to Peer, Wi-Fi hot spot and Wi-Fi Internet Uplink
Bluetooth/Low-Power Bluetooth (LPB)—(low power indoor & outdoor Peer to Peer Networking, location and Relational Positioning and data transfer, alerts, ID & Security.
NFC—Near Field Communication for rapid device pairing, Identification & User Verification
UWB—Ultra-wideband-Ultra low energy-time of flight location positioning)
RFID (Active & Passive Radio-frequency Identification)
GPS (Global Positioning System) outdoor location tracking and satellite positioning

Due to strict regulations regarding using cell phones on flights. Smart Clip embodiment 3 uses its ultra-precise location tracking and Wi-Fi and Bluetooth verification to identify when the bag and smart clip has been loaded on the plane and may also shut off within a geofenced area of the plane. Smart Clip embodiment 3 may also use Wi-Fi only on designated Wi-Fi enabled flights and will otherwise go into low-power mode with only GPS and other sensors monitoring while in flight, The Smart Clip may also use it's altitude and pressure sensor as an emergency backup in case the location data does not shut off the cellular networking and put the device in airplane mode then when the device identifies that it is in flight via the altitude and pressure sensors it will automatically switch to airplane mode

### Power & Power Management

The Smart Clip Embodiment 3 incorporates both a rechargeable battery and a solid-state replaceable battery. The rechargeable battery is assigned to all cellular, Wi-Fi and Bluetooth wireless networking and higher power consumption applications and the solid-state battery is assigned to all ultra-low power networking and location tracking. In case of complete rechargeable battery failure, the solid-sate battery may be used to unlock the device.

### Security & Locking System

In addition to the Electro-mechanical wireless locking system and a finger print reader The Smart Clip embodiment 3 introduces a combination mechanical locking system and TSA key lock in case a fully mechanical locking system is required by airlines and airports. The Electronic Locking system may be shut off entirely or may be used in combination with the Combination Lock as a secondary security layer. Similar to standard luggage locks, the TSA key lock may be used to bypass the combination lock if an authorized airline or other security agent requires that the Smart Clip device be unlocked and/or removed from the luggage.

When the Smart Clip embodiment 3 is opened via the combination lock or TSA key and the electronic lock is turned off, the camera is automatically turned on and a real-time alert and live audio-video feed is sent to an authorized user who may then link to communicate in real-time with the Smart Clip to identify the person who opened the lock. The authorized owner may then set off the alarm if the person who opened the Smart Clip is not an authorized agent.

Alternatively, the Smart Clip embodiment 3 may require an authorized user or manager to wirelessly unlock the electronic lock via a mobile app enabled phone, tablet, PC or other networked device following user identification with password or biometric verification on the mobile app. The electronic lock may be required as an additional layer of security to the combination or key lock. And it may be necessary to unlock both the combination or key lock and the electronic lock independently in order to fully unlock the Smart Clip device to prevent an unauthorized person from using a TSA key to bypass the combination lock and unlock the Smart Clip embodiment 3 device. In the event that the mechanical lock is unlocked via the combination lock or TSA key, a mobile alert is sent out to one or more users via the mobile app and Cloud Platform. When one of the authorized users received the alert on their mobile app enabled phone, tablet, PC or other computing, networking and/or Internet connected device, they will receive real-time video from the Smart Clip camera to view the person attempting to unlock the Smart Clip device. The authorized user may then communicate via two-way cellular or Wi-Fi enabled voice communications with the Smart Clip and request that the person identify themselves and verify that they are an authorized airline or other security agent. The authorized user may then choose to wirelessly unlock the digital lock on the Smart Clip remotely via their mobile app enabled phone or other authorized device or they may choose to turn on the alarm and contact airline, airport, hotel or other security personnel.

### Sensors & Functionality

The Smart Clip embodiment 3 introduces a multi-lens array camera capable of dual camera feeds or a single ultra-wide-angle image or video feed to expand the quality and field of view of the Smart Clip. Smart Clip embodiment 3 also incorporates a large flash light for illuminating the area in front of the cameras for increased visibility and security.

### Grouping & Geofencing

The Smart Clip embodiment 3 introduces cellular broadband wide area networking and GPS which enables the Smart Clip to connect wirelessly to the Internet at all times and wirelessly send images, stream audio-video, send SMS text messages and or have two-way or multi-feed voice and data communications over a cellular network. Enabling direct peer-to-peer wireless communications over a Wide Area network without the need of a Wi-Fi hot spot. The Smart Clip may be pre-programmed to select Wi-Fi over Cellular communications for Internet uplink and for voice, audio-video and other data communications when-ever available to cut down on cost and/or to improve battery life and optimize power.

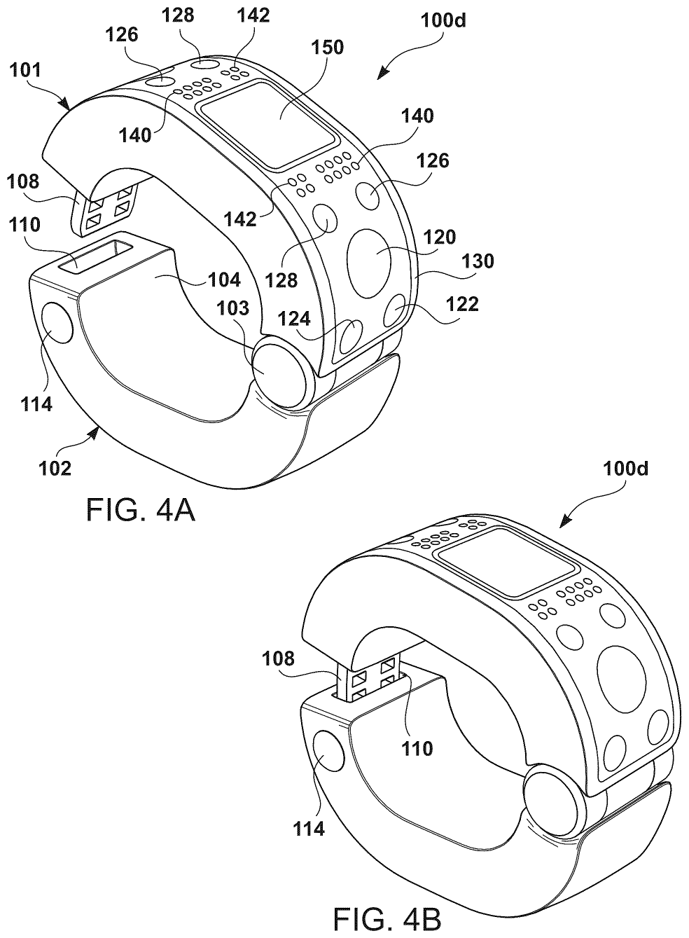

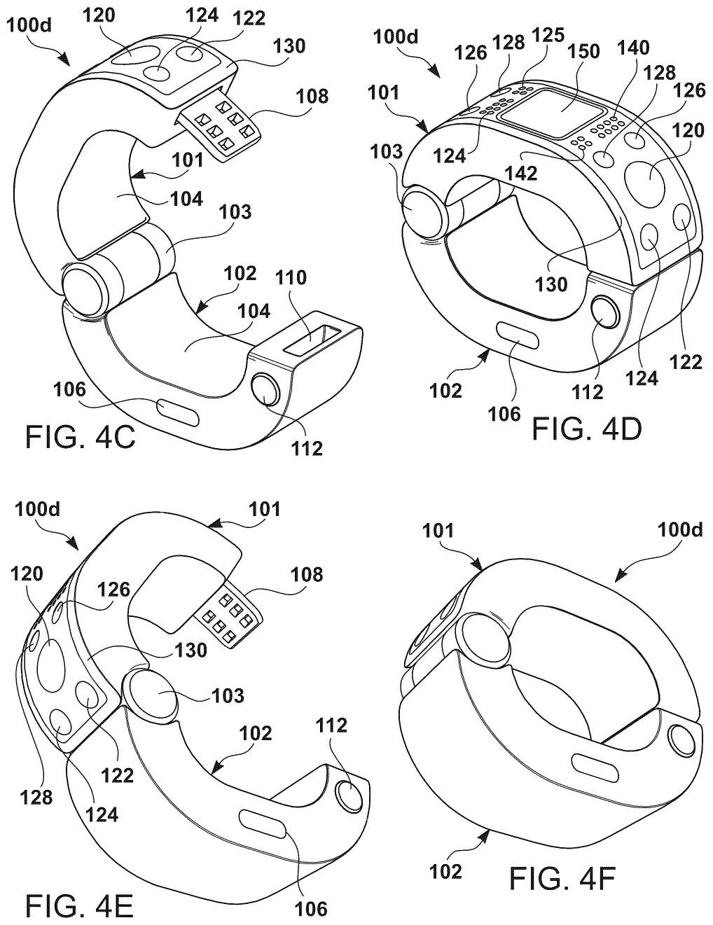

### Smartclip Embodiment 4—Pages 4 & 5—FIGS. 4A, 4B, 4C, 4D, 4E & 4F) (100d)

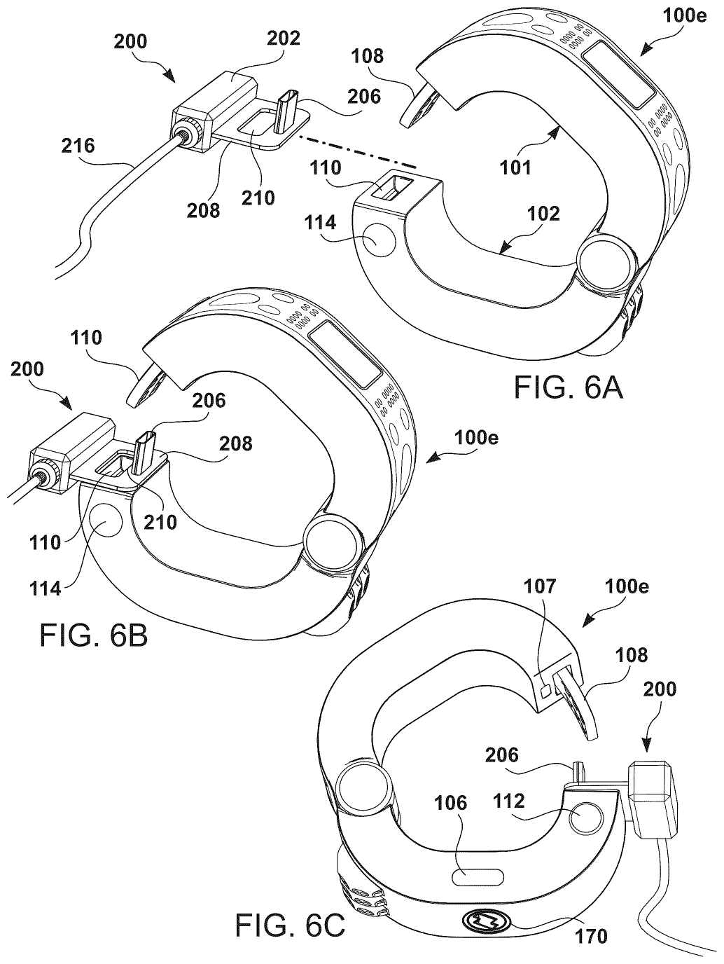

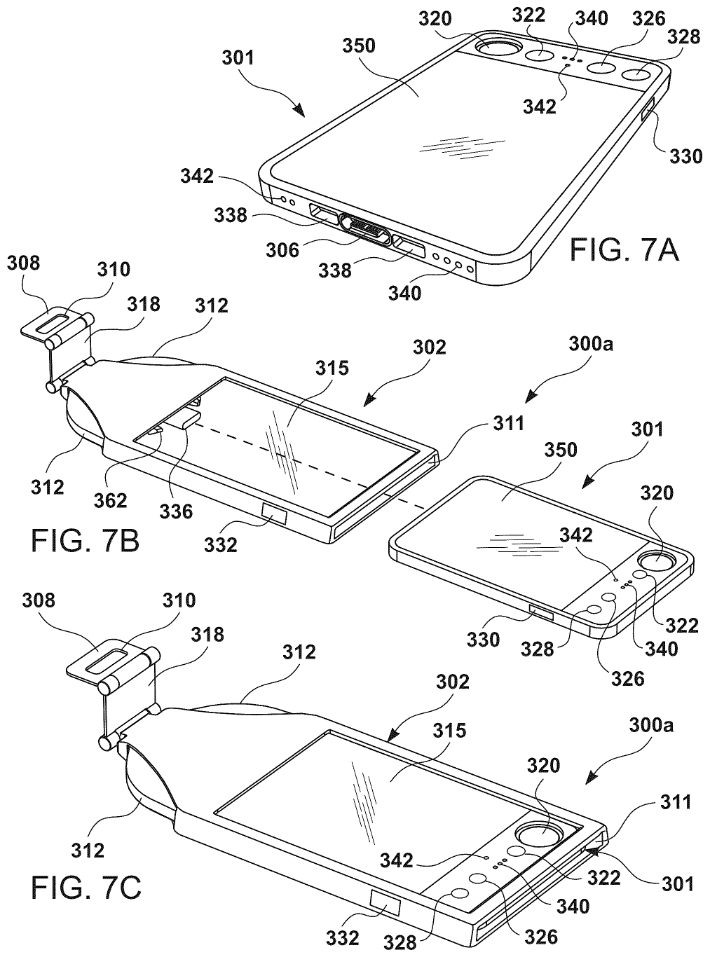

### Smartclip Embodiment 5—Pages 6 & 7—FIGS. 5A, 5B, 5C, 5D, 6A, 6B & 6C) (100e)

SmartClip embodiments 4 & 5 are identical except embodiment 5 incorporates a combination lock and TSA key lock and Embodiment 4 has a non-touchscreen display the

### SmartClip Embodiments 4 & 5 Methods of Networking, Location and Device Identification

A) Cellular (3G or 4G and/or 5G Broadband Wide Area Networking)
B) Wi-Fi
C) Bluetooth/LPB
D) NFC (Near-Field Communications)
E) UWB (Ultra-wideband)
F) RFID (Radio-frequency Identification)
G) GPS (Global Positioning

### Sensors

Camera (Day and Night Vision)
Motion/Orientation/Shock (Accelerometer)
Gyroscope
Magnetometer/Compass
Altitude/Pressure
Temperature & Humidity
Lights (IR lights, Flash light and Multi-Color LED lights)
IR Projector & IR Camera
Microphone (Two-way communications and audio-video recording/streaming)
Speakers (Alarm & Audio Alerts)
Screen Display (LCD, OLED or other)

### Power

Batteries (Rechargeable and/or Solid state Replaceable
Inductive Power Charging
USB/Micro USB or other wired data networking and power charging port
Micro Power and Data Port in locking system enabling direct wired data and power connectivity between the Smart Clip and Accessory Devices

### Security

Electro-mechanical wireless Locking System
On-Device Fingerprint Reader
On-Device Face Identification
Combination Lock & TSA Key (Embodiment 5 Only)
Passcode and/or Password and/or Fingerprint and/or Face ID (via a connected device)
End-to-end wireless data encryption
Light & Audio Alarm and Alerts

### Security & Locking System

In addition to the Electro-mechanical wireless locking system and a finger print reader The Smart Clip embodiments 4 and 5 introduce on-device Face Identification which enables the device to verify a user using it's IR projection and Imaging system. This system may also be used by airlines to identify all personnel who process, pick-up or handle a bag and/or perform security and/or open a bag throughout its journey to confirm they are an authorized agent performing an authorized task. This system may be used as the primary digital security unlocking system or in Embodiment 5, in addition to a combination lock and/or TSA key lock.

### Sensors & Functionality

The Smart Clip embodiments 4 and 5 introduces an IR projector and IR camera for face identification, a touchscreen LCD or OLED display for real-time on-device graphic user interface, travel itinerary display, luggage handling, security and sensor alerts and device controls and an additional micro USB port in the locking system to enabled wired power and data connectivity between the Smart Clip and paired/connected/locked accessory devices such as the Smart Luggage Tag and Alert System Device and the Smart Luggage Zipper Locking Device.

### Grouping & Geofencing

The Smart Clip embodiment 4 & 5 incorporate an additional data and power port such as a micro-USB port into the locking system enabling accessory devices to have a wired data and power connection with the SmartClip providing a more power efficient method of transferring data and power and connecting the SmartClip with accessory devices then using wireless data or inductive power transfer.

### Alternatives:

The above advantages are exemplary, and these or other advantages may be achieved by the invention. Further, the skilled person will appreciate that not all advantages stated above are necessarily achieved by embodiments described herein.

In the foregoing specification, the invention has been described with reference to specific examples of embodiments of the invention. It will be evident, however, that various modifications and changes may be made therein without departing from the broader spirit and scope of the invention as set forth in the appended claims. It will be understood that anyone or combination of components and functionalities described with reference to one or more embodiments may be adopted in any one of the embodiments of the smart clip, smart tag accessory (which may be a smart tag, smart zip lock or other device designed to fit and lock with the smart clip) or other smart device described herein and/or in the accompanying figures.

Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. In addition, plurality of connections may be replaced with a single connection that transfers multiple signals serially or in a time-multiplexed manner. Likewise, single connections carrying multiple signals may be separated out into various different connections carrying subsets of these signals. Therefore, many options exist for transferring signals.

Those skilled in the art will recognize that the boundaries between logic blocks or software components are merely illustrative and that alternative embodiments may merge logic blocks or software components or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations are merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner. For example, processing in relation to different groups of profiles may be allocated to respective different integrated circuits.

Also for example, the examples, or portions thereof, may implemented as soft or code representations of physical circuitry or of logical representations convertible into physical circuitry, such as in a hardware description language of any appropriate type.

Also, the present technology is not limited to physical devices or units implemented in nonprogrammable hardware but can also be applied in programmable devices or units able to perform the desired device functions by operating in accordance with suitable program code, for example a Field Programmable Gate Array (FPGA). The terms “processing device”, “computing device”, “processor” includes such programmable devices.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as “one, or more than one.” Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are arbitrarily used to distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

As used throughout this application, the word “may” is used in a permissive sense (i.e., meaning having the potential to), rather than the mandatory sense (i.e., meaning must). Similarly, the words “include,” “including,” and “includes” mean “including, but not limited to” the listed item(s).

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.”

Unless specifically stated otherwise as apparent from the foregoing discussions, it is appreciated that throughout the present description of embodiments, discussions utilizing terms such as “collecting,” “selecting”, “creating,” “running,” “replaying,”, “collecting,” “fixing,” “communicating,” “deploying,” “running,” “comparing,” “predicting,” “mapping,” or the like, refer to the actions and processes of an integrated circuit, an ASIC, a memory device, a computer system, or similar electronic computing device. The memory device or similar electronic computing device manipulates and transforms data represented as physical (electronic) quantities within the devices' registers and memories into other data similarly represented as physical quantities within the devices' memories or registers or other such information storage, transmission, or display devices.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus or processing device to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that in some embodiments, one or more blocks may be omitted, where appropriate. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be understood that the described embodiments of the invention are illustrative only and that modifications thereof may occur to those skilled in the art. Accordingly, this invention is not to be regarded as limited to the embodiments disclosed, but is to be limited only as defined by the appended claims herein. It will further be understood that any features described in relation to any particular embodiment may be featured in combinations with other embodiments, for avoidance of doubt.

1. A luggage smart clip comprising
a housing comprising a first clip section having a first distal end and a second clip section having a second distal end; and
a plurality of devices,
wherein the plurality of devices comprises at least one wireless connectivity device, at least one luggage security device and at least one power source; and
wherein said plurality of devices are incorporated in at least one of said first clip section and said second clip section.

2. The luggage smart clip of claim 1, wherein said luggage clip is a luggage handle clip.

3. The luggage smart clip of claim 1, wherein any one or combination of the first clip section and said second clip section is substantially C shaped.

4. The luggage smart clip of claim 1, wherein at least one of said first clip section and said second clip section has a substantially rectangular cross section.

5. The luggage smart clip of claim 1, wherein:
wherein said first clip section is configured to be movable relative to said second clip section between an open configuration and a closed configuration;
wherein, in use, in the open configuration, the smart clip is attachable to a piece of luggage, and the first clip section is movable relative to the second clip section to the closed configuration to securely hold the luggage smart clip to the piece of luggage.

6. The luggage smart clip of claim 1, wherein the housing is configured to allow the size of any one or combination of the first clip section and second clip section in the closed configuration to be adjusted.

7. The luggage smart clip of claim 1, wherein said at least one security device comprises a lock.

8-57. (canceled)

58. A luggage tag comprising
a display and optionally configured to operably connect with a luggage smart clip as claimed in claim 1.

59. The luggage tag of claim 58, further comprising a case comprising a frame section and an attachment system, wherein the attachment system is configured to physically connect the luggage tag to a luggage smart clip; wherein the display is mounted or removably mounted in said frame section, and wherein
said attachment system includes a locking section extending from said frame section for locating and locking between the distal end of the first clip section and the distal end of the second clip section of the luggage smart clip.

60. The luggage tag of claim 59,
wherein said attachment system locking section includes at least one swivel connection interconnecting said locking section with said frame section.

61. The luggage tag of claim 59,
wherein said attachment system locking section includes a slot for receiving the tongue of the first clip section of the smart clip when said first clips section is closed together with said second clip section.

62. The luggage tag of claim 59, wherein said frame section includes a slot configured to slidably receive said display.

63. The luggage tag of claim 59, where said attachment system is configured to both physically and electrically connect the luggage tag to the luggage smart clip as claimed in any one of claims.

64-90. (canceled)

91. A luggage smart system comprising:
at least one luggage smart clip;
and least one luggage tag; wherein said
at least one luggage smart clip and said at least one luggage tag are configured to be interconnected, in any one or combination of, wirelessly, electrically and physically;
wherein said at least one luggage smart clip comprises:
a housing comprising a first clip section having a first distal end and a second clip section having a second distal end; and
a plurality of devices,
wherein the plurality of devices comprises at least one wireless connectivity device, at least one luggage security device and at least one power source; and
wherein said plurality of devices are incorporated in at least one of said first clip section and said second clip section; and
wherein said at least one luggage tag comprises a display.

92. The system of claim 91 wherein said at least one smart clip and said at least one luggage tag are integrated with one another or configured to physically pair with one another.

93. The system of claim 91, wherein said at least one smart clip and said at least one luggage tag are configured to wireless pair with one another.

94. The system of claim 91, wherein said at least one smart clip and said at least one luggage tag are configured to electrically pair with one another.

95. The system of claim 94, wherein said tag attachment system includes data and/or power connections operably connected to said display and/or at one of the plurality of devices of the luggage tag, said tag attachment system data and/or power connections being configured to electrically connect with corresponding data and/or power connections on said smart clip housing when said tag attachment system is attached to said smart clip housing, said corresponding data and/or power connections on said smart clip housing being operably connected to at least one of said plurality of devices of said smart clip.

96. The system of claim 95, wherein said tag attachment system includes a tag locking section extending from a body of said attachment system, wherein said tag locking section includes a slot, wherein when said first clip section and said second clip section are in the closed configuration, said tag locking is sandwiched between the distal end of said first clip section and the distal end of said second clip section and the tongue of the tongue and port system protrudes through said tag locking slot.

97. The system of claim 96, data and/or power connections are included in said tag locking section,
wherein corresponding data and/or power connections on said smart clip housing are included in the distal end of said first clip section and/or said second clip section; and
wherein when said tag locking is sandwiched between the distal end of said first clip section and the distal end of said second clip section and the tongue of the tongue and port system protrudes through said tag locking slot, said tag locking section data and/or power connections are in electrical contact with corresponding data and/or power connections on the distal end of said first clip section and/or the distal end of said second clip section.

98.-172. (canceled)
